(19) United States
(12) Patent Application Publication
(10) Pub. No.: US 2005/0262088 A1
(43) Pub. Date: Nov. 24, 2005

(54) Organ procurement system and method

(76) Inventors: Ronnie Solis, Metairie, LA (US); Kelly Ranum, Mandeville, LA (US); Kathy Pizzolato, Metairie, LA (US); Kirby Yarbrough, Reston, VA (US); Maulik Shah, Sterling, VA (US); Lance Weitzel, Leesburg, VA (US); Kevin Barker, Bristow, VA (US)

Correspondence Address: WARNER J DELAUNE JR;ADAMS AND REESE LLP, 450 LAUREL STREET, SUITE 1900, BATON ROUGE, LA, 70801, US

(21) Appl. No.: 10/678,039

(22) Filed: Oct. 1, 2003

(51) Int. Cl. G06F 7/00

(52) U.S. Cl. 707/10

(57) ABSTRACT

An organ and tissue procurement system is provided, comprising an interface server for storing and delivering user interface information accessible to authorized users over a wide area network; a database server, in communication with the interface server, for storing and delivering data related to donors and recipients of human organs and tissue; and software, in communication with the interface server and the database server, for enabling access to the data and the user interface information by the authorized users, wherein the software includes: (a) security measures for determining whether one or more of the authorized users may modify the data; and (b) an import feature for receiving donor information from at least one external database and adding the donor information to the data. In a preferred embodiment, the external database is managed by an office of motor vehicles or an organ donation organization. Also in a preferred embodiment, the data further includes information relating to transplant hospitals, eyebanks, and tissue banks.

### BACKGROUND OF THE INVENTION

I. Field of the Invention

The present invention relates to a system that centrally manages the selection, procurement and delivery of human tissues and organs for multiple hospitals and tissue transplant or organ transplant facilities.

II. Description of Related Art

A. The Organ Donation Environment

Based on data available from September 2003, there are 254 transplant centers in the United States. There are 59 Organ Procurement Organizations (“OPOs”) that have been certified by the United States Department of Health and Human Services. These OPO's facilitate the process of organ recovery from the identification of potential donors through the placement of transplanted organs into recipients. The number of organ donors varies with each particular OPO. The demand for organs continues to increase, yet there is a disparity between organ supply and demand. Because of the disparity between the demand and need for organs for transplant as compared to the organs that come available there is a steadily increasing number of waiting list fatalities. See “Organ Transplantation in the United States,” by Walter K. Graham, Executive Director, United Network for Organ Sharing (UNOS). In 2002, for example, there were 6,852 waiting list fatalities; and in 2003 as of September there have been 2,971.

The procurement and donation of organs has increasingly become the subject of legislation and regulation in the United States. There are laws in all states providing for the legally binding nature of instruments relating to organ donation. Many so-called “living wills,” also authorized by many state laws provide for the donation and/or disposition of a patient's organs upon death. The National Organ Transplant Act was passed in 1984 and constitutes enabling legislation for the operation of a national Organ Procurement and Transplantation Network (OPTN) under contract with the Secretary of Health and Human Services. The OPTN currently operates on a membership basis and provides a 24-hour computer system for listing potential recipients, and matches donated organs to those patients in need of organs.

The National Organ Transplant Act (“NOTA”) also created a national system of independent private procurement organizations that are authorized to operate in and serve designated geographical regions. These organizations also promote and manage organ donation and procurement and allocation on a regional basis. Under NOTA, these OPOs are required to have a system for allocating organs to patients equitably and based on established criteria. In order to receive Medicare and Medicaid funds these OPOs are required to belong to the OPTN.

In response to these legal and societal stimuli, the transplant centers of the United States, the histocompatibility laboratories and the OPOs have joined to form a nonprofit organization called the United Network for Organ Sharing (“UNOS”). UNOS develops policy, provides administrative support, and maintains a national waiting list of patients who need transplants, e.g. potential recipients. UNOS also operates a matching program for donors and recipient patients as well as the U.S. Scientific Registry for Transplant Recipients which records and preserves data about recipients to which all OPOs must submit donations made to them.

These various organizations on a state and nationwide level have undoubtedly made significant initial strides in the management and delivery of organs and tissues in this country. However, the logistical problems attending this area of medical endeavor are many and varied. It is nearly difficult under the present art to obtain timely information access any but a small portion of the information about organs and recipients without expending an unacceptable amount of time and effort in manually searching unconnected databases. The UNOS database, for example, is only complete as to recipients. Numerous OPOs maintain separate databases of potential donors who voluntarily agree to be listed in a registry (“donor registry”), but such registries only include potential donors in the local area or state. Additional potential donors are often listed with state Offices of Motor Vehicles (OMV's) which maintain information on licensed drivers who have indicated a willingness to donate organs.

B. The Organ and Tissue Recovery and Transplant Process

A brief description of the processes by which organs and tissue are recovered from donors and transplanted into recipients is helpful in understanding the deficiencies in current methods as well as the benefits of the invention described and claimed herein.

In the case of organs, a hospital will call an OPO when it has identified a patient as a potential donor, meaning that the hospital staff has determined that brain death is imminent for the patient (the “referral”). Basic information is gathered by the OPO and compared to various “rule out” criteria established by the OPO and any affiliated tissue banks. If the organ or tissue is not ruled out, the OPO will send its staff of transplant coordinators to evaluate the situation. If the patient appears to be a candidate for donation, the OPO coordinators will discuss the organ donation option with the patient's family. Since the patient is brain dead, it is up to the family to provide or withhold consent for such a donation, although the patient's intention to donate may have already been expressed either in OMV records or by his or her enrollment in a donor registry. Following family permission, OPO coordinators will undertake an extensive medical evaluation of each organ for viability, e.g., to determine that the organs are healthy and without communicable disease. After determining which organs are viable for transplantation, the coordinators will access the UNOS database to determine the individuals on the waiting list that preliminarily match with the donor. Organ allocation and distribution is based on many different factors including blood type, medical need, weight, size, genetic factors, geographic location and the length of time on the waiting list. After the organs have been placed for potential recipients, the coordinators will schedule surgical teams to recover the organs in the patient's hospital. Depending on the circumstances, the surgical teams may come from other transplant facilities around the country. Notably, matches are often made with recipients located within the state boundaries of the donor, but are also placed with recipients who may be quite distant from the donor.

After acceptance of the organ, the procurement team comprising a transplant surgeon, surgical assistant, and an organ recovery/perfusion coordinator is assembled. Surgical equipment and perfusion and packaging supplies are taken to the donor hospital by expeditious means of transportation to meet the coordinated surgical operating room times agreed upon by multiple transplant teams. The transport times must be kept to a minimum to assure that minimal cold ischemic (no blood flow) times are accrued on each organ. The “ischemic time” is the duration of time commencing at the point the organ is surgically removed from the donor and ending when the organ is transplanted and re-perfused with the blood and oxygen of a recipient. The length of ischemic times can effect the overall function of the organ post-operatively, so close attention is paid to keeping this time as short as possible.

The organs are removed by the transplant surgeons at the donor hospital. The organs are then packed in sterile bags or sterile containers, packed in wet ice, placed in a cooler, and transported to the transplant hospital. The OPO coordinator remains in contact with the transplant hospital during the procurement procedure to inform it of the estimated time of arrival of the organ. The transplant center contacts the recipient as soon as it is notified that the organ is suitable for transplant. At the transplant center, the recipient is admitted to the hospital; lab tests are conducted along with vital signs further education about the transplant process is presented to the recipient; and a surgical consent form is signed. Organs are not removed from the recipient until the procurement team arrives at the transplant hospital with the organ.

Before the transplant can take place the transplant surgeon must reexamine the donor organ. The organs are examined in the operating room to ensure that the anatomy is normal, there is no trauma and the organs are suitable for transplant into a waiting recipient. The patient is anesthesized, an incision is made and the diseased organ is removed and replaced with the healthy new organ. The patient is then sent to the intensive care unit for the postoperative recovery phase. An OPO coordinator will typically provide follow-up information to the donor family and involved hospital staff regarding the outcome of the donations.

In the case of tissue donation, such as with corneas, heart valves, tendons, ligaments, bones, blood vessles and skin (also referred to as “allograft tissue”), the process is similar, although not handled through the UNOS matching sytem. Instead, after removal of the tissue from the donor, the OPO sends the donated tissue to a tissue bank, such as the Musculoskeletal Transplant Foundation (MTF). The tissue bank then processes the tissue and holds it in a frozen state in the tissue bank, often for as long as five years, until it is needed by a prospective recipient. When a request is made for the tissue, the tissue bank distributes the tissue to hospitals and surgeons throughout the region serviced by the OPO.

C. Limitations of UNOS and Current OPO Methods

The UNOS organization maintains a recipient database and permits a matching process to be made between those recipients and possible donors. UNOS does not maintain a comprehensive database of OPO data on donors. Also, UNOS does not track referrals for donation, and it does not access or duplicate transplant center databases. Its attempts to link its recipient database with OPO's and transplant centers have met with limited success. The quantity and variety of information that a comprehensive donor database would have to store are too disparate and expansive for currently available OPO management systems. Commercially available database management system software cannot handle the mass of information contained or the complexity of the linking necessary to connect such databases, at least without substantial customization and risks of non-scalability. Under the current state of the art, an OPO or a nationwide facility like UNOS would have to spend enormous time and expense to create the management system that would be capable of uniting or connecting the databases necessary to perform the logistical functions necessary for wide-ranging, efficient and time-sensitive procurement and delivery of organs and/or tissues, especially on a nationwide scale.

The current electronic system used by about half of all OPO's is the Donor and Recipient Tracking System (DARTS). The remaining OPO's have either used other database systems, such as those based on Microsoft Access, or relied on traditional paper records and management. The DARTS system, however, is primarily a data-collection system, has little interactivity, and is not a relational database management system. Its utility resides primarily in its ability to enter, store, and retrieve data in a format which has become relatively standard among OPO's. For example, the Association for Organ Procurement Organizations (AOPO) has established an 11-page donor form which is used by all OPO's. The AOPO form includes the following information about the donor: (1) donor identification information, (2) consent, (3) admission course, (4) initial physical assessment, (5) medical and social history, (6) laboratory values, (7) intraoperative management, (8) operating room teams and procedures, (9) organ anatomy, (10) tissue anatomy, and (11) recovery. It is believed that other OPO management systems may be in development, although available information about such systems indicates that their feature sets and functionality may still be limited.

As quick and effective as the current methods for organ and tissue recovery may seem to be, there is much room for improvement, particularly in the management of information relating to donors, recipients, hospitals, and certainly the organs and tissue. With the maturation of electronic computer systems and global communication networks such as the Internet, OPO's need computer systems, networks, and software that deliver and receive accurate and complete information as quickly as possible. When this is accomplished, matches between donors and recipients will occur faster; organs and tissue will be better preserved; and the costs of the process will be reduced. It is therefore desired to provide an OPO management system which efficiently manages the referrals, reporting, and resources which impact the success of the organ and tissue recovery process. For the purposes herein, such a management system will be referred to as an “R3 system” for its focus on referrals, reporting, and resources. The R3 system should include the following primary components: (1) a call center, (2) referral, recipient and donor medical record management, (3) a UNOS interface and placement management, (4) donor registry and OMV interface, (5) management modules for system security, staff, hospital, accounting, and development, (6) full quality assurance, including audit trails, and (7) customizable reporting system.

It is also desired to provide a wide-area version of the R3 system that is capable of communicating in real time with any participants in the recovery or transplantation process, including hospitals, other OPO's, transplant centers, as well as the U.S. Scientific Registry for Transplant Recipients. This system would expedite the process of referral, including determinations of eligibility and dispatching field coordinators. It is likewise desirable that all transplant centers be provided with access to a wide-area R3 system over the Internet to enable the exchange of necessary information with OPO coordinators so that the fastest and most reliable delivery can be achieved.

As will be further explained, the R3 systems and methods described herein are intended to promote flexible access for authorized users, rapid exchange of data using standard data formats and communication protocols, and maximum compatibility with existing record management techniques in the organ recovery and transplant process. For example, relevant information entered into the system can be used to automatically populate an AOPO donor form. Furthermore, “on the scene” emergency professionals such as paramedics will be able to gather information directly from family members and enter all necessary data onto any Internet-based computer system at the hospital for immediate communication to the OPO. In doing so, OPO's and other participants in the process will be assured that existing investments in non-proprietary computer systems and Internet-related hardware and software are entirely suited for use with the R3 system.

### SUMMARY OF THE PRESENT INVENTION

Therefore, an organ and tissue procurement system is provided, comprising an interface server for storing and delivering user interface information accessible to authorized users over a wide area network; a database server, in communication with the interface server, for storing and delivering data related to donors and recipients of human organs and tissue; and software, in communication with the interface server and the database server, for enabling access to the data and the user interface information by the authorized users, wherein the software includes: (a) security measures for determining whether one or more of the authorized users may modify the data; and (b) an import feature for receiving donor information from at least one external database and adding the donor information to the data.

In a preferred embodiment, the external database is managed by an office of motor vehicles or an organ donation organization. Also in a preferred embodiment, the data further includes information relating to transplant hospitals, eyebanks, and tissue banks.

In a more preferred embodiment, the software includes functions for prompting a user of the system to ask predetermined threshold questions about the prospective donor to establish whether the prospective donor may donate the tissue or organ. Also, the software includes functions for allowing a user of the system to determine whether the prospective donor has indicated an express intent to donate the tissue or organ.

Preferably, the database is maintained by an organization with which the prospective donor or prospective recipient have a prior relationship, and wherein the relational database management system (RDBMS) communicates with the database over an electronic communication network, such as a wide-area network or through secure connections over the Internet. In one embodiment, the database includes data sets which are precategorized into a plurality of predetermined organ histories.

Also provided is a method for managing a procurement system for tissue or organs, comprising the steps of providing software for communicating with a relational database management system (RDBMS) corresponding to and operating upon a database and configured to create links between select fields of the database; storing medical and social history information about a plurality of prospective donors under conditions that would allow salvage of tissue or organs from the prospective donors (“donor data”); storing medical and social history information about a plurality of prospective recipients (“recipient data”); and accessing the RDBMS to determine whether the donor data is stored in the database, and if so, determining whether any of the donor data corresponds to any of the recipent data sufficient to establish a preliminary match between the donor data and the recipient data.

### BRIEF DESCRIPTION OF THE DRAWINGS

FIG. 1 is an overall schematic view of the primary participants within the organ/tissue recovery and transplant process and which interact with the present invention.

FIG. 2 illustrates the multiple pathways for collecting donor registration, as well as a summary layout of the primary components of a preferred embodiment of the present invention.

FIG. 3 depicts an exemplary import process for importing external data into the database, particularly the OMV records and the donor registry.

FIG. 4A is a flowchart of an overview of the call pathway for a procurement event.

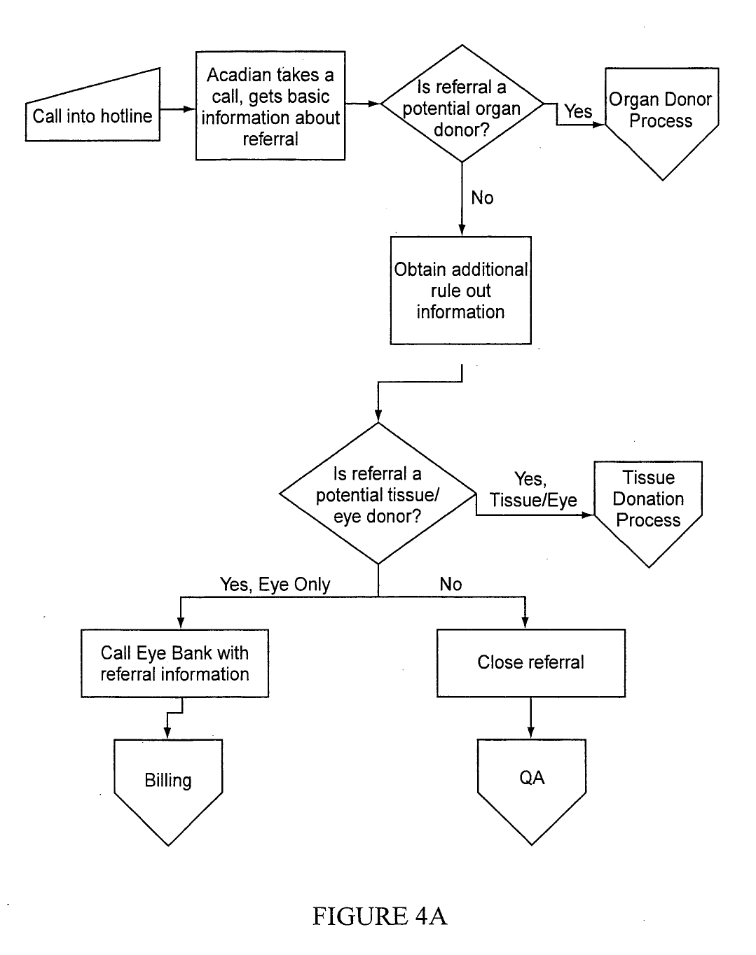

FIG. 4B is a flowchart of a more detailed process by which information relating to a prospective organ donor is managed.

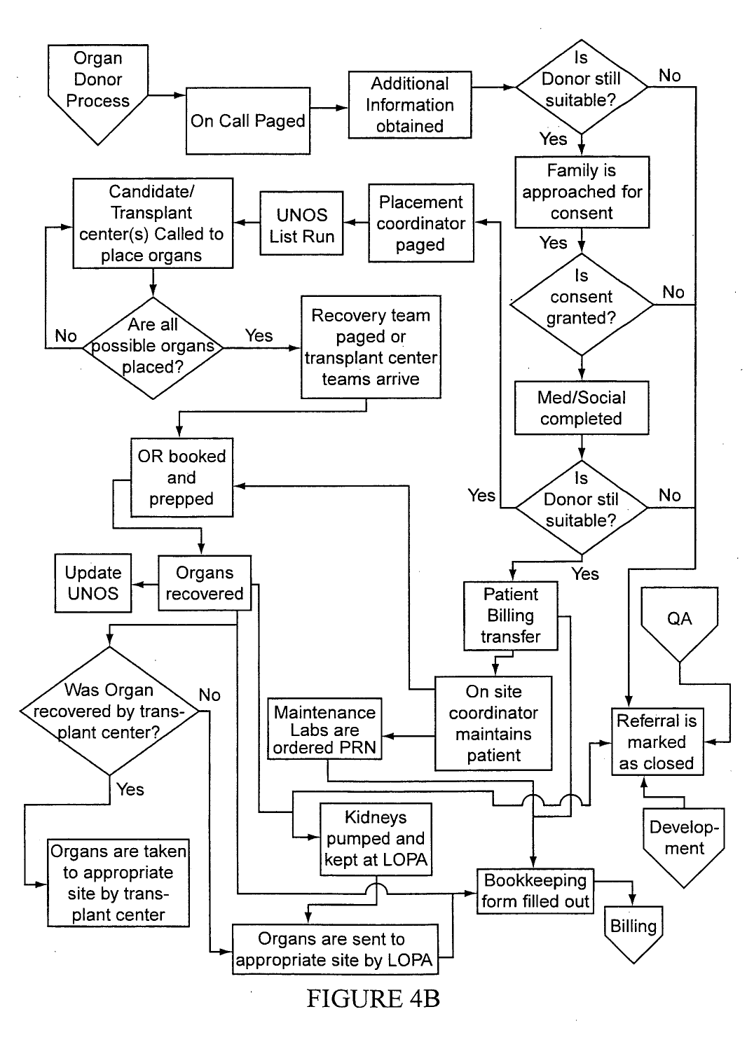

FIG. 4C is a flowchart of a more detailed process by which information relating to a prospective tissue donor is managed.

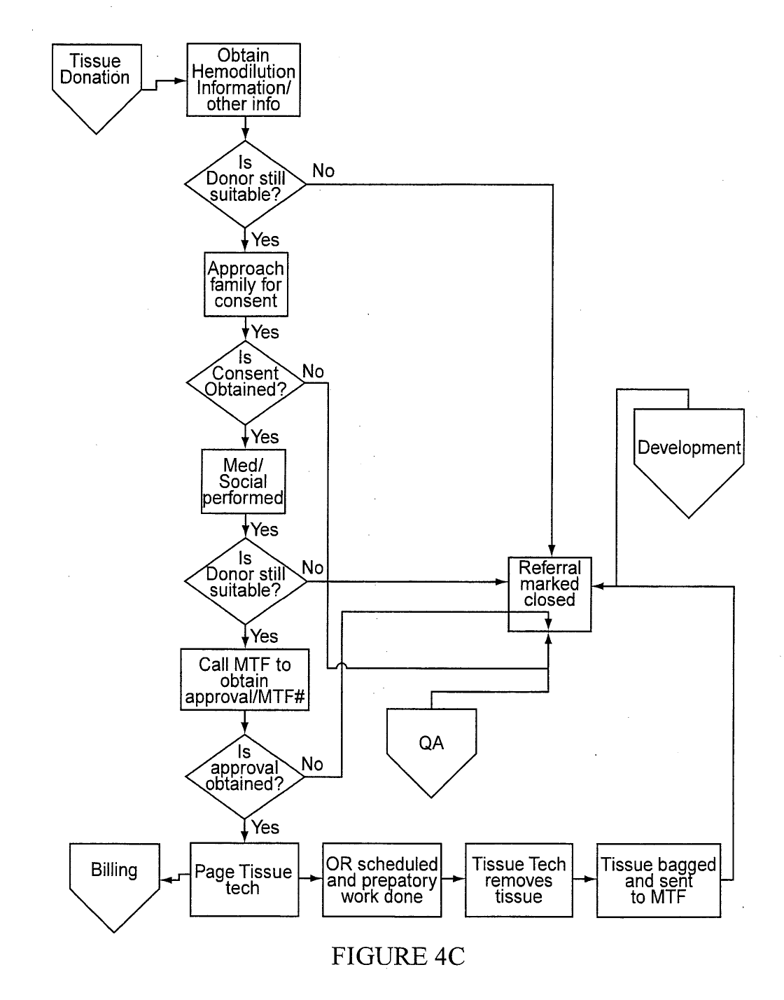

FIG. 4D is a flowchart illustrating a preferred process of managing the quality assurance aspects of the system.

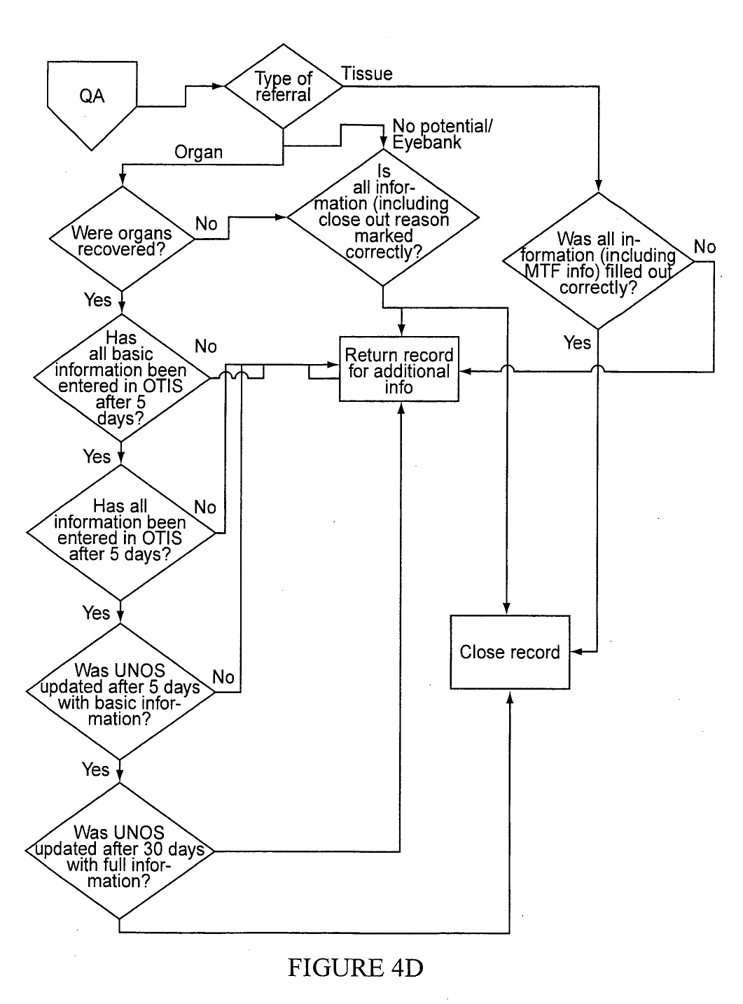

FIG. 4E is a flowchart illustrating development features of the present invention which promote and support the donation process.

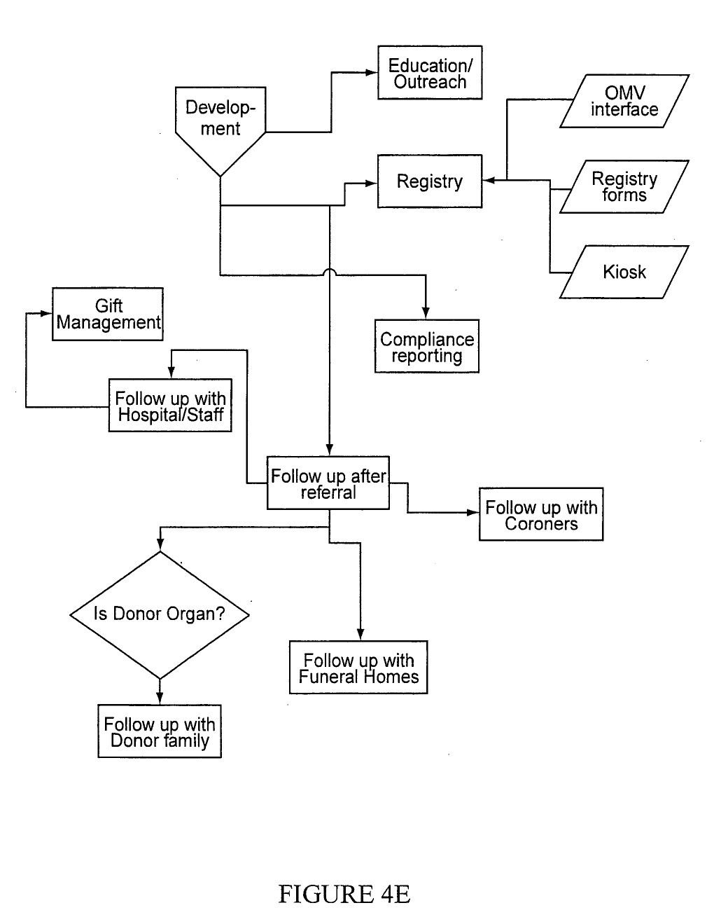

FIG. 4F is a flowchart depicting further processes relating to the billing features of the system once procurement and delivery has been completed.

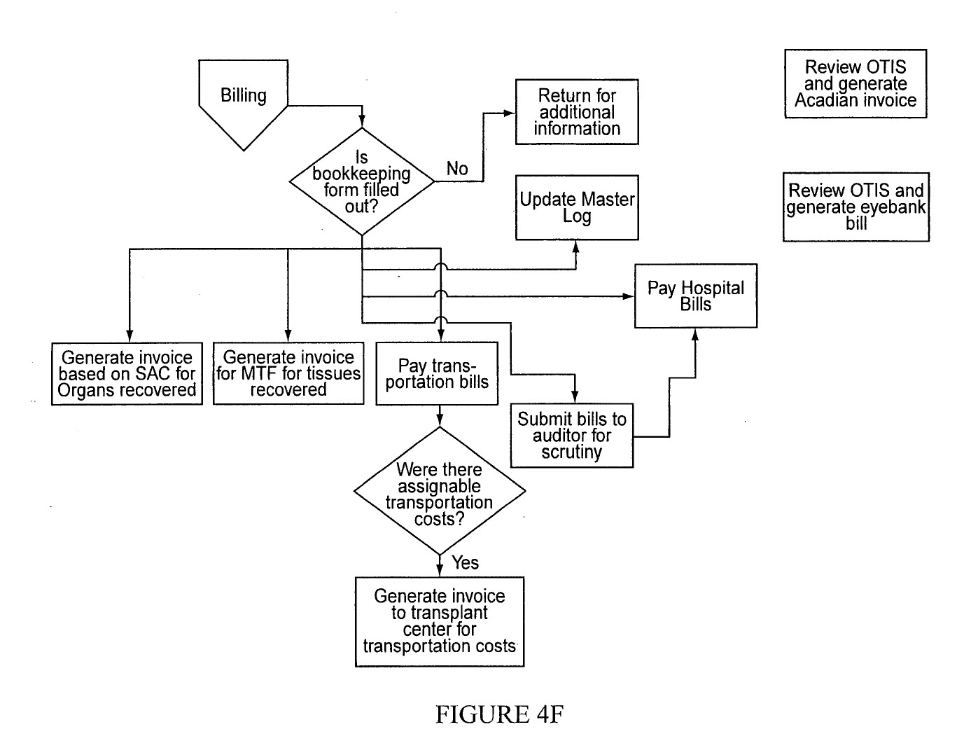

FIG. 5 is an overview of the main user interface components of a preferred embodiment of the system.

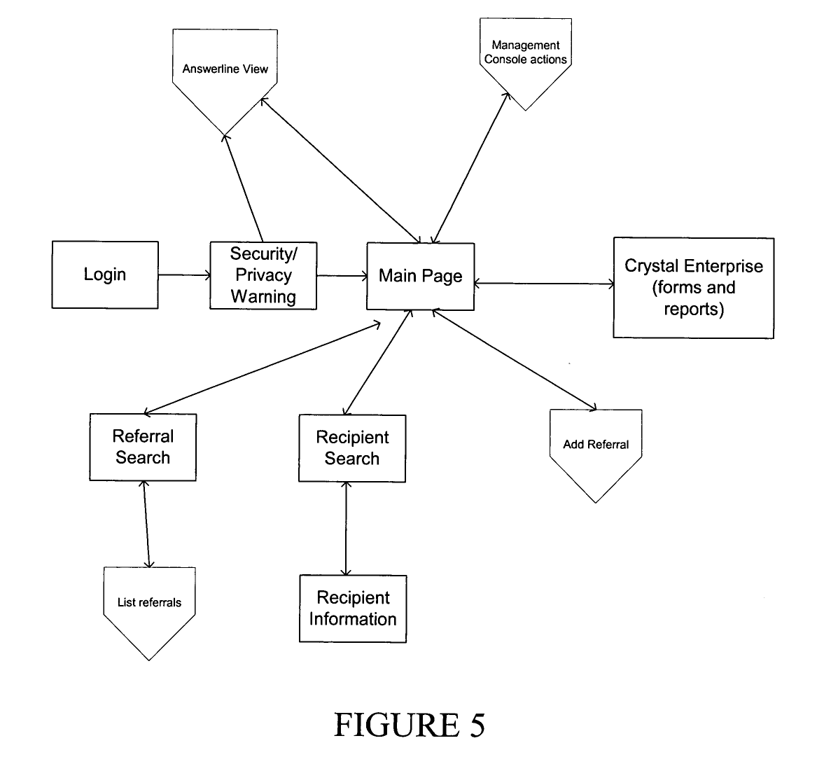

FIG. 6 is a relational diagram depicting the various interface components for managing information received by a call center.

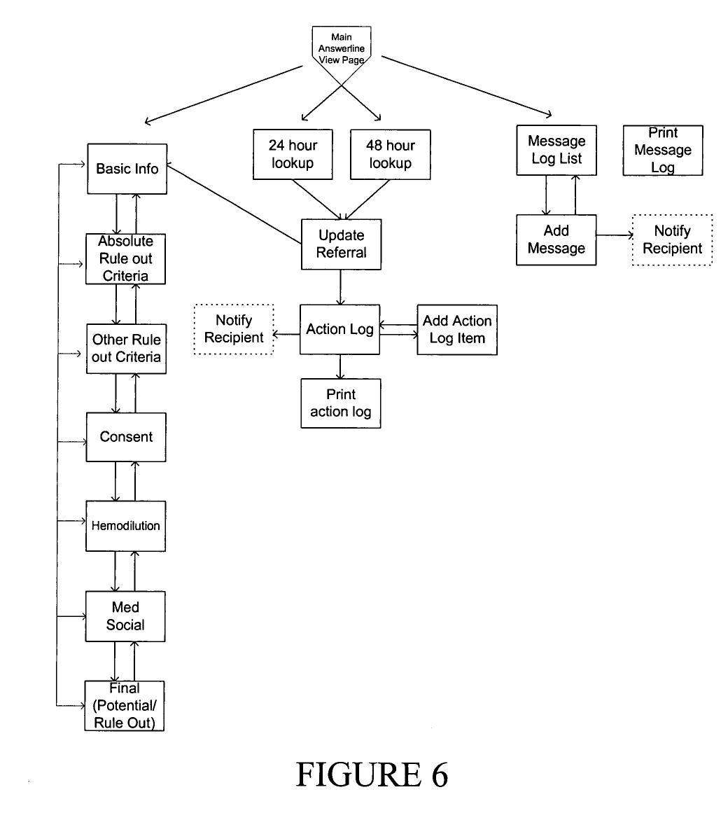

FIG. 7 is a relational diagram depicting the various interface components for managing the maintenance for the system.

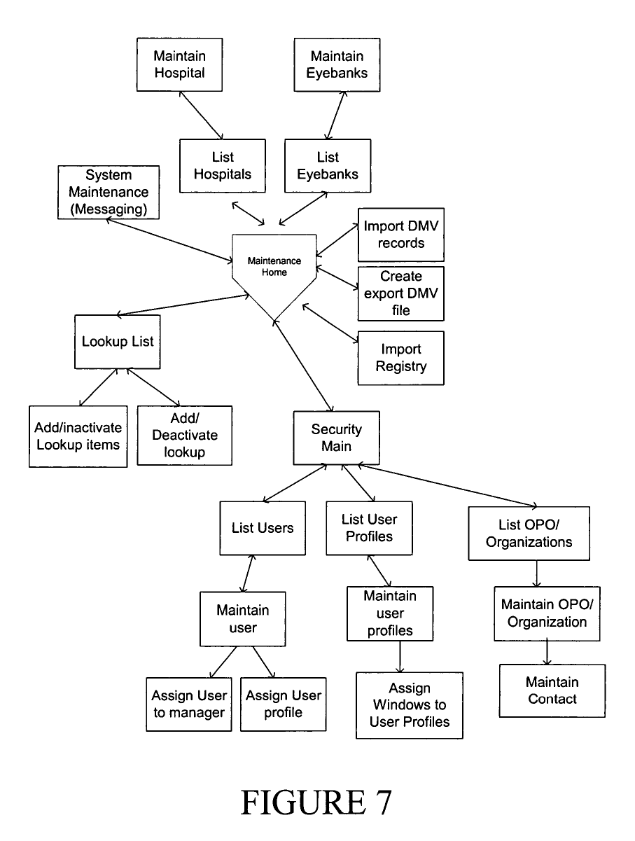

FIG. 8 is relational diagram depicting the various interface components for managing donor or referral information.

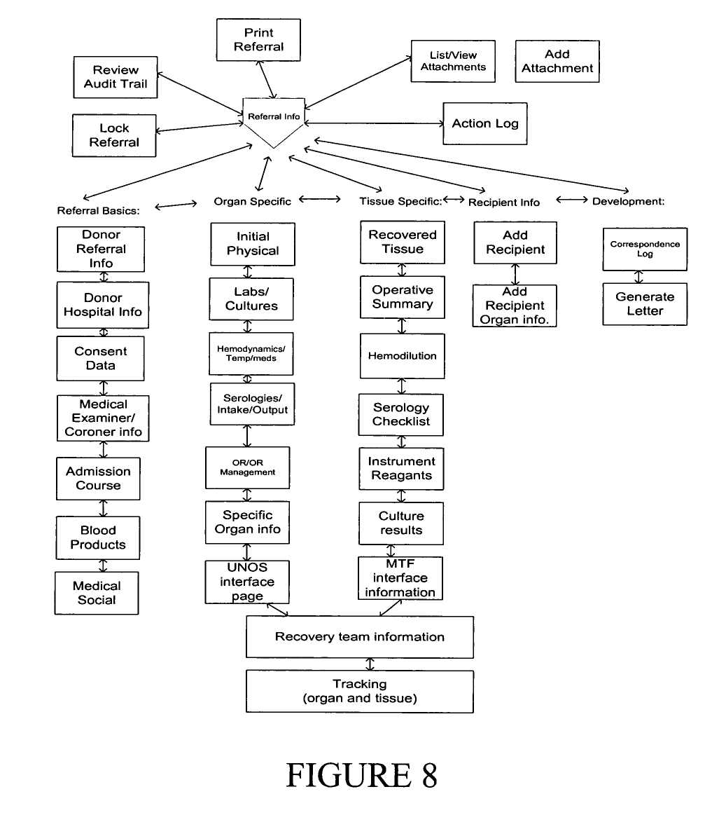

FIG. 9 is an example of a partial logical structure of the databases which comprise the information searchable throughout the system.

FIG. 10 is an example of an initial logon page for a preferred embodiment of the system (“R3 system”).

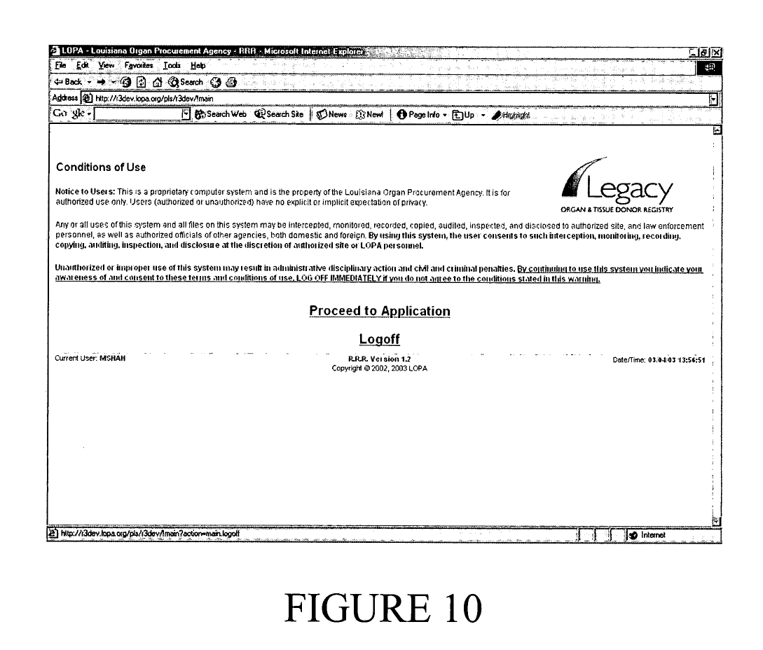

FIG. 11 is a main menu of the R3 system.

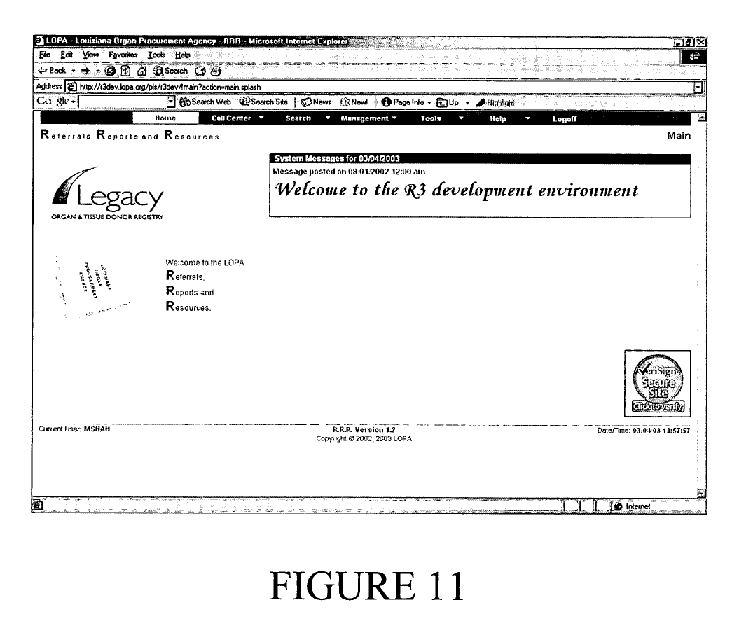

FIG. 12 is a call center menu which contains all of the information and menu options regarding call center operations.

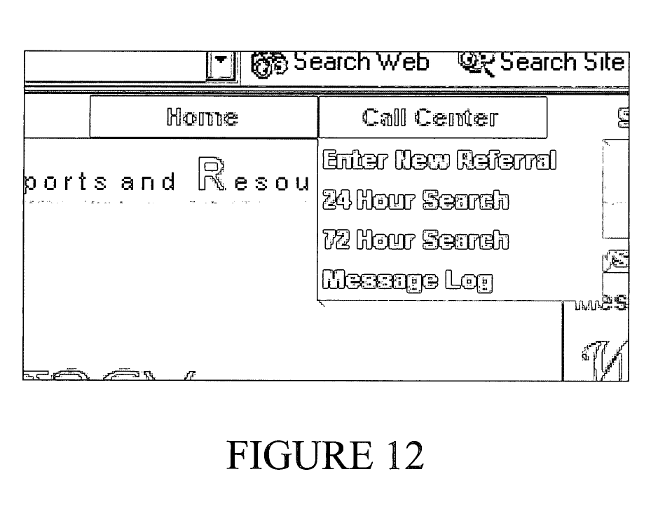

FIG. 13 is a search menu which allows the user to search for referrals directly or for recipients tied to referrals.

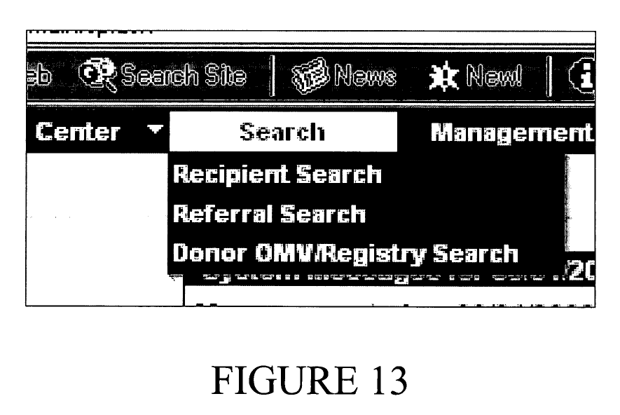

FIG. 14 is a management menu which allows authorized users to add/edit/maintain system parameter and system level information.

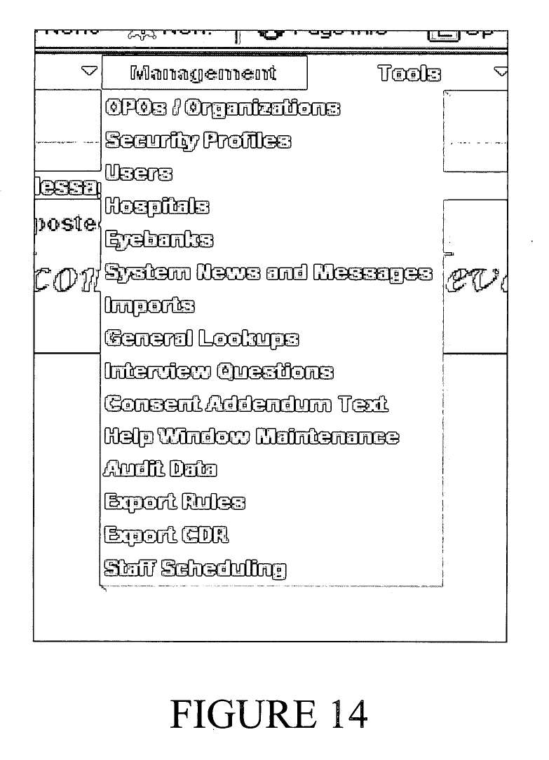

FIG. 15 is a tools menu which allows the user to change a password or run certain predefined or custom reports.

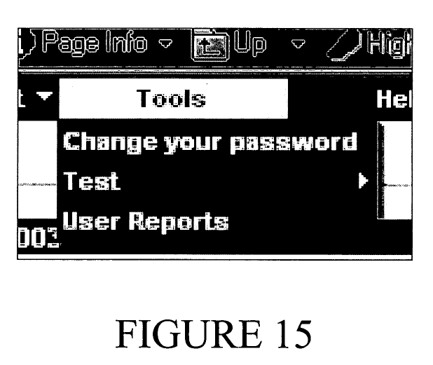

FIG. 16 is a help menu which may be revised and maintained by particular OPO's.

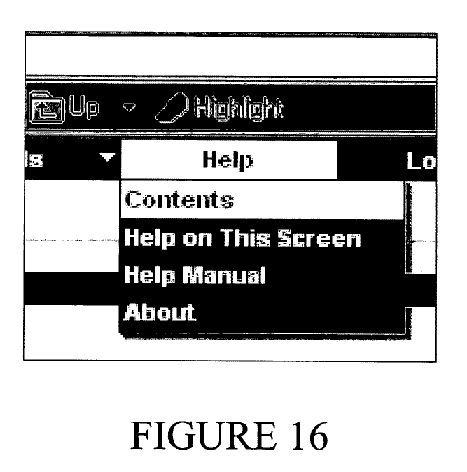

FIG. 17 is an OPO management screen which allows authorized users to enter OPO specific information and add organizations to that OPO.

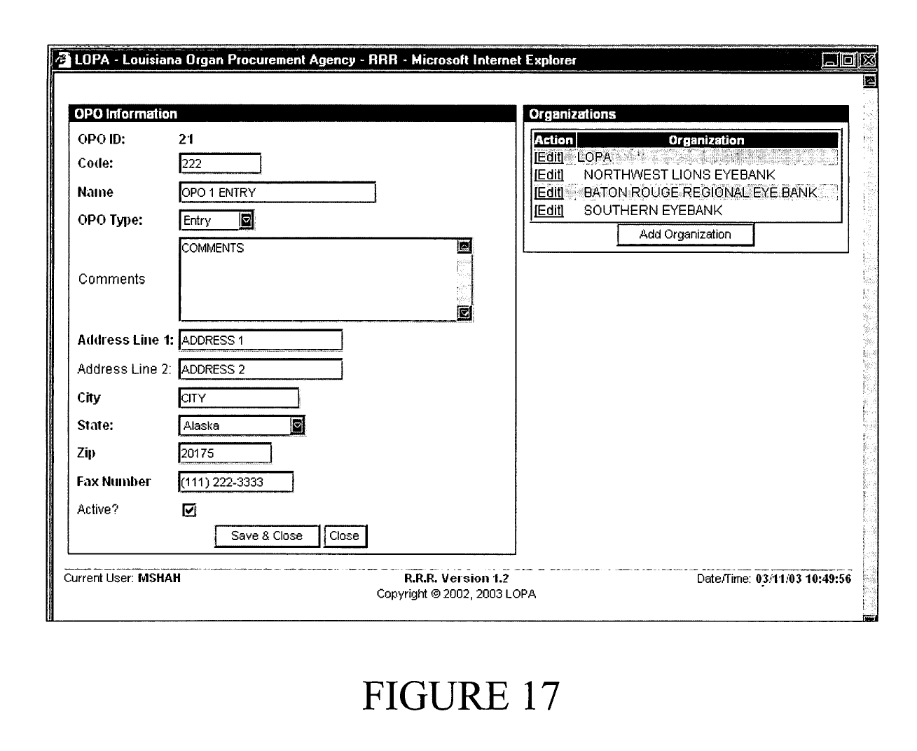

FIG. 18 is an organization screen which allows the user to enter organization information specific to an OPO.

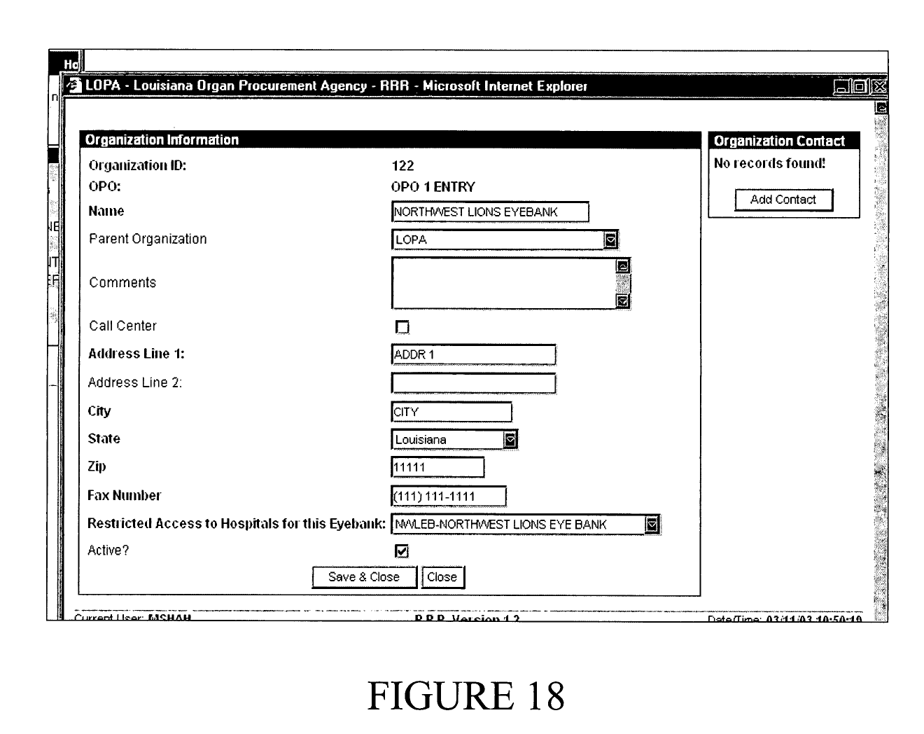

FIG. 19 depicts how the R3 system stores contact information for a variety of information types including organizations.

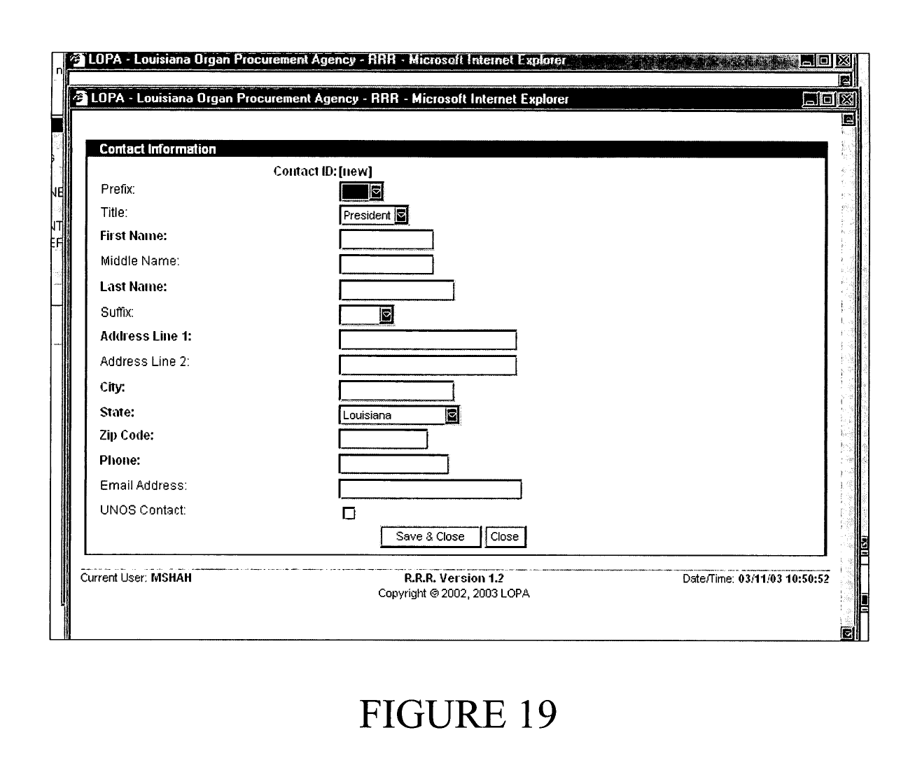

FIG. 20 shows a user management section which allows authorized users to view and maintain information.

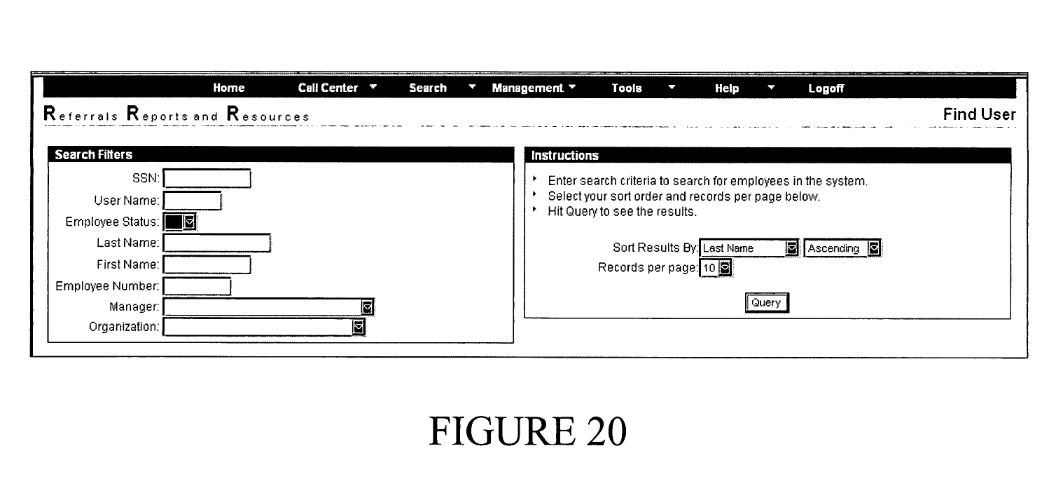

FIG. 21 illustrates a user management screen which allows the tracking of a multitude of different types of information, including address, personal, and system/security information.

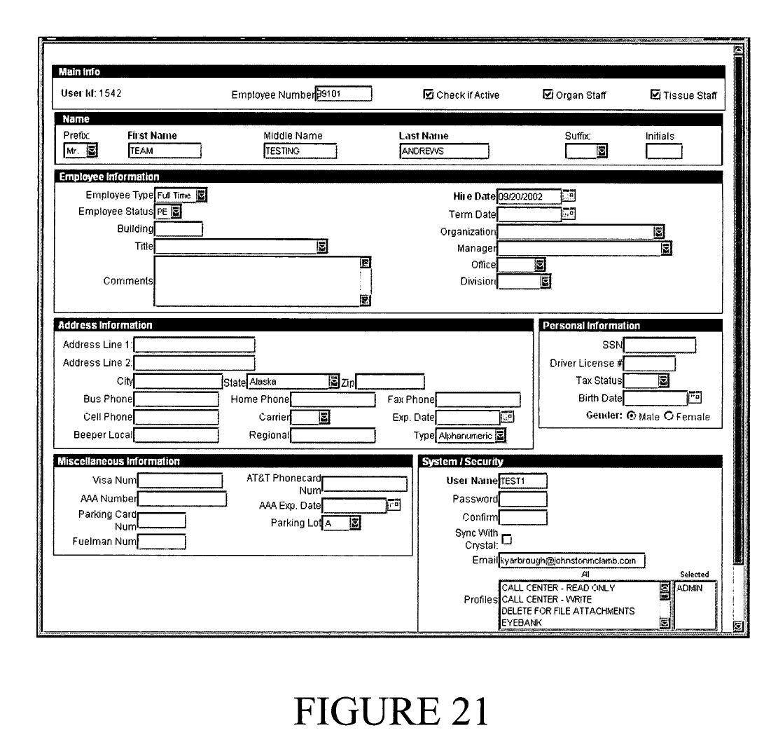

FIG. 22 shows how the system may have different security profiles which allow the OPO to customize its security in many ways.

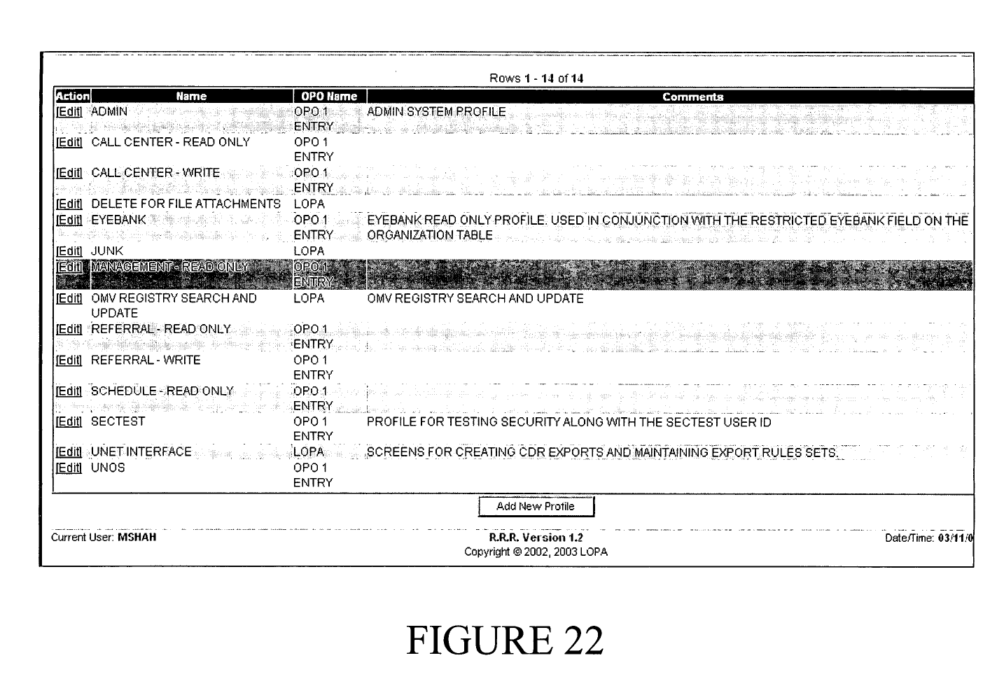

FIG. 23 depicts how a particular profile details what access a person who has that profile has to the system.

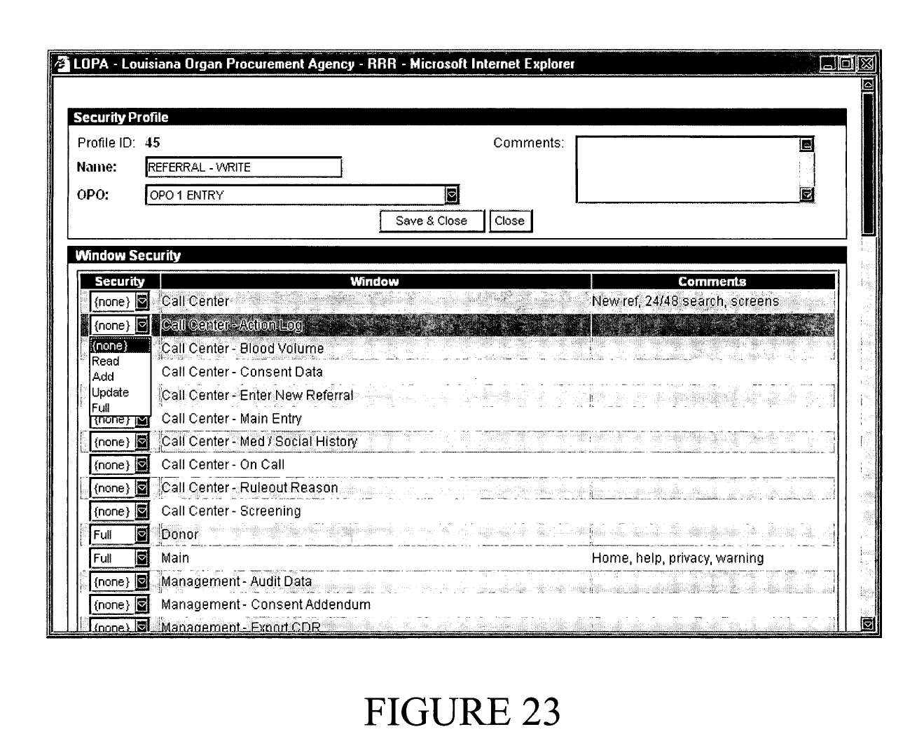

FIG. 24 provides an input screen which stores all relevant hospital information, including hospital services, contract information, and contacts.

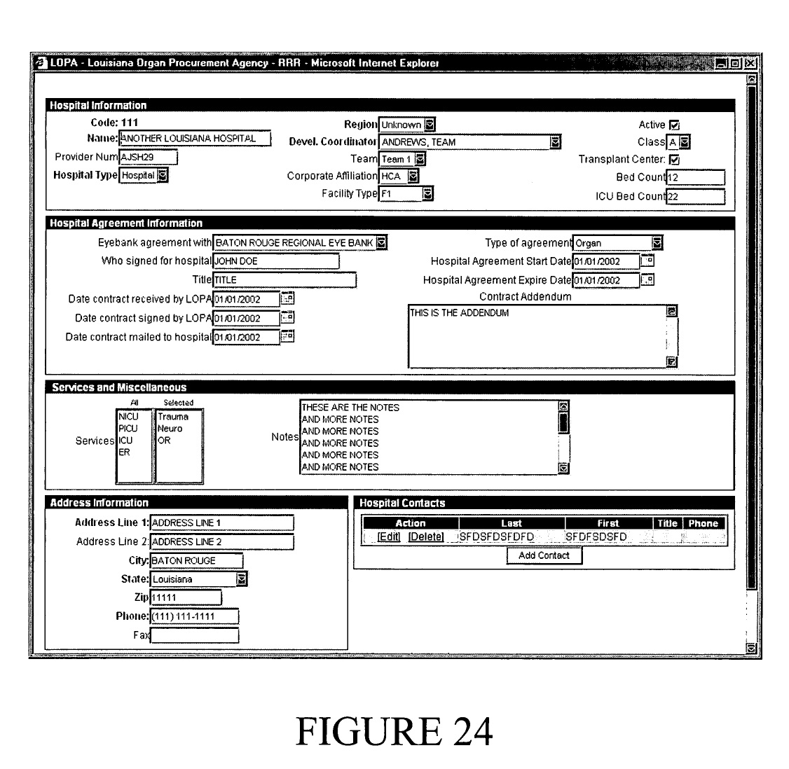

FIG. 25 provides a screen where all relevant eyebank information is stored.

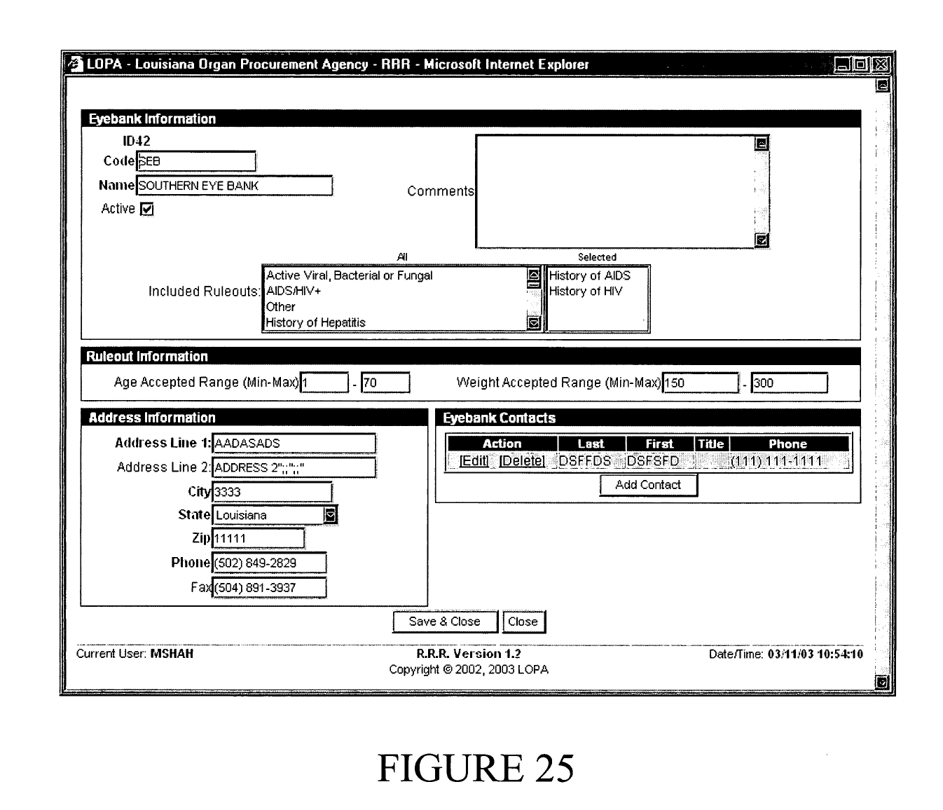

FIG. 26 illustrates rule out criteria that a particular eyebank may use.

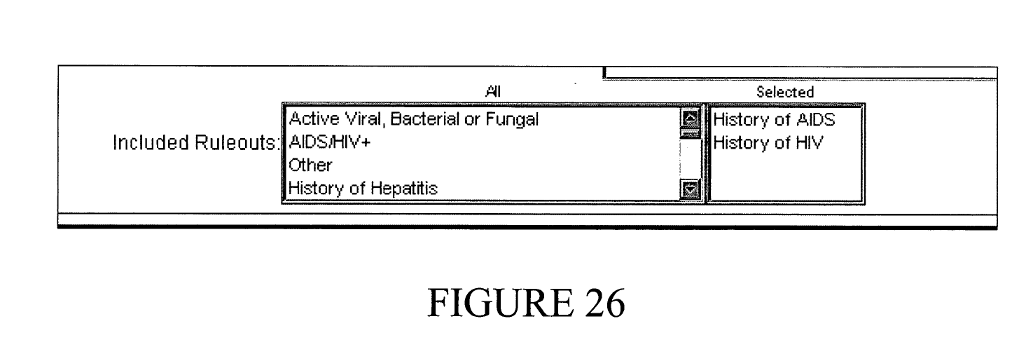

FIG. 27 provides a menu and features where authorized users can enter system messages that appear on the main menu to all users.

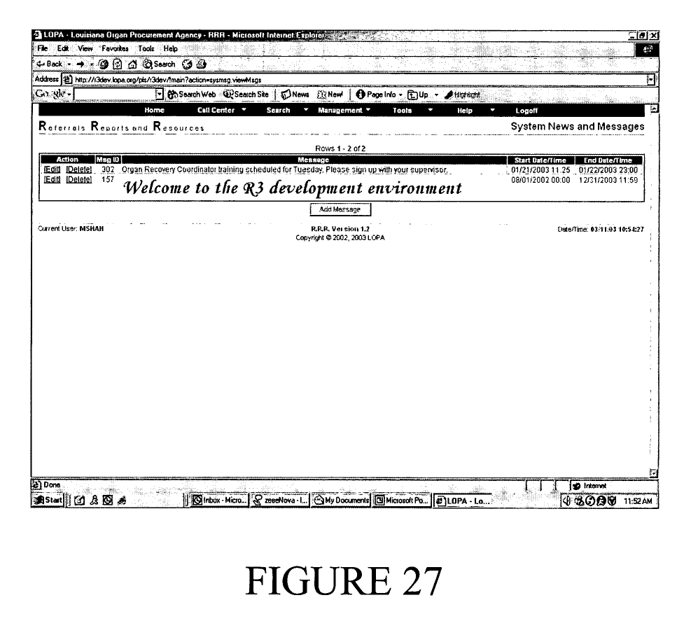

FIG. 28 illustrates how the R3 system supports a two-tier registry, namely, one from the Offices of Motor Vehicles (OMV), and the other from an OPO-specific registry system.

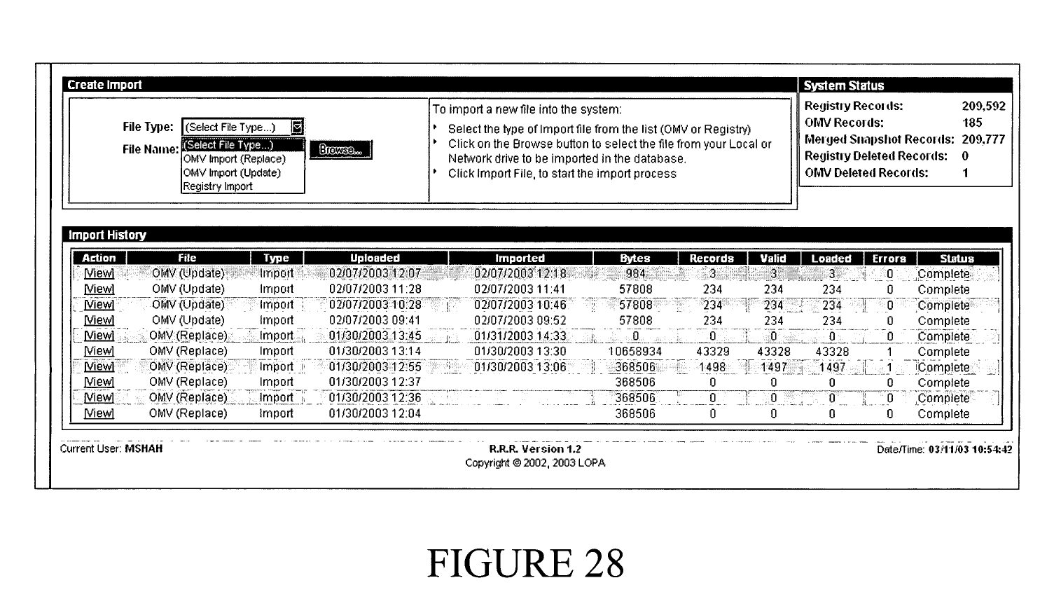

FIG. 29 depicts how system menus and other commands can be customized.

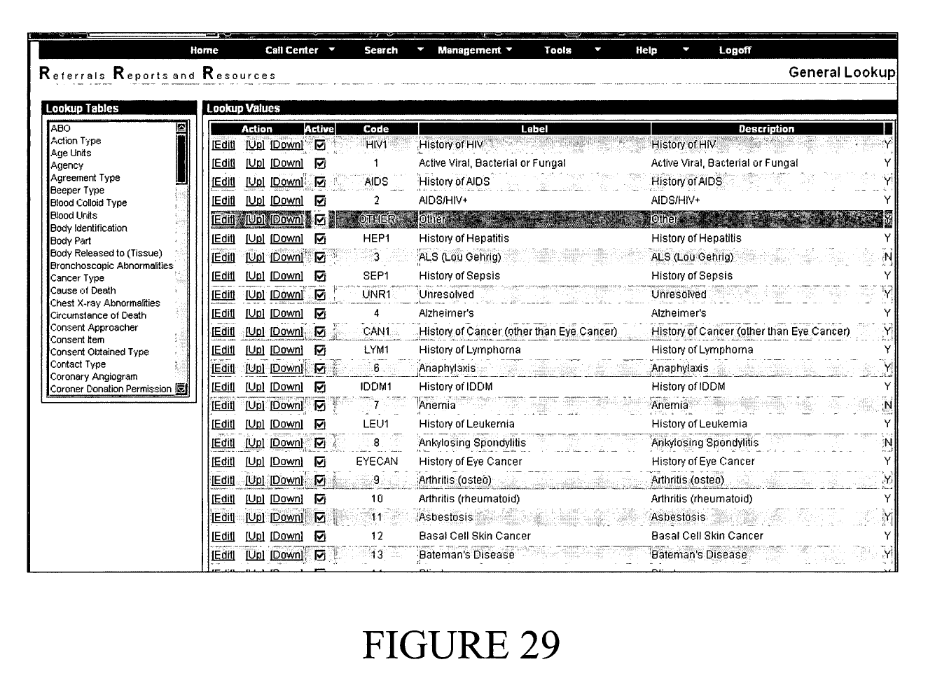

FIG. 30 depicts add/edit screening criteria for tissue rule outs.

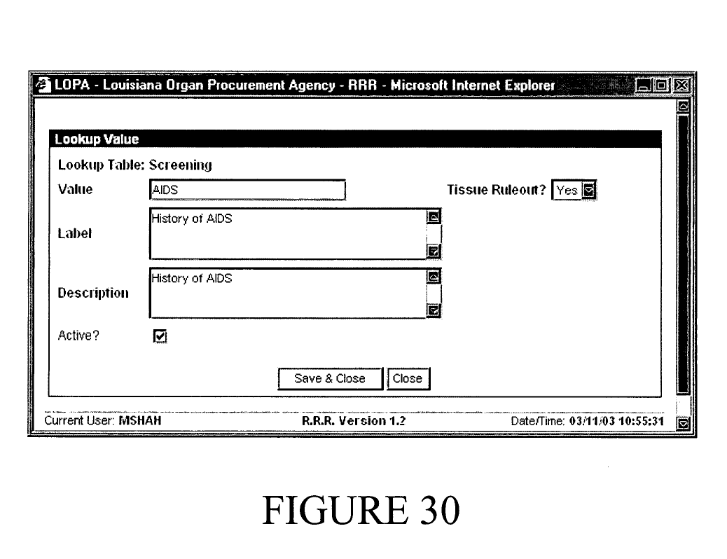

FIG. 31 shows a screen which provides a “consent item” list for customization by each particular OPO.

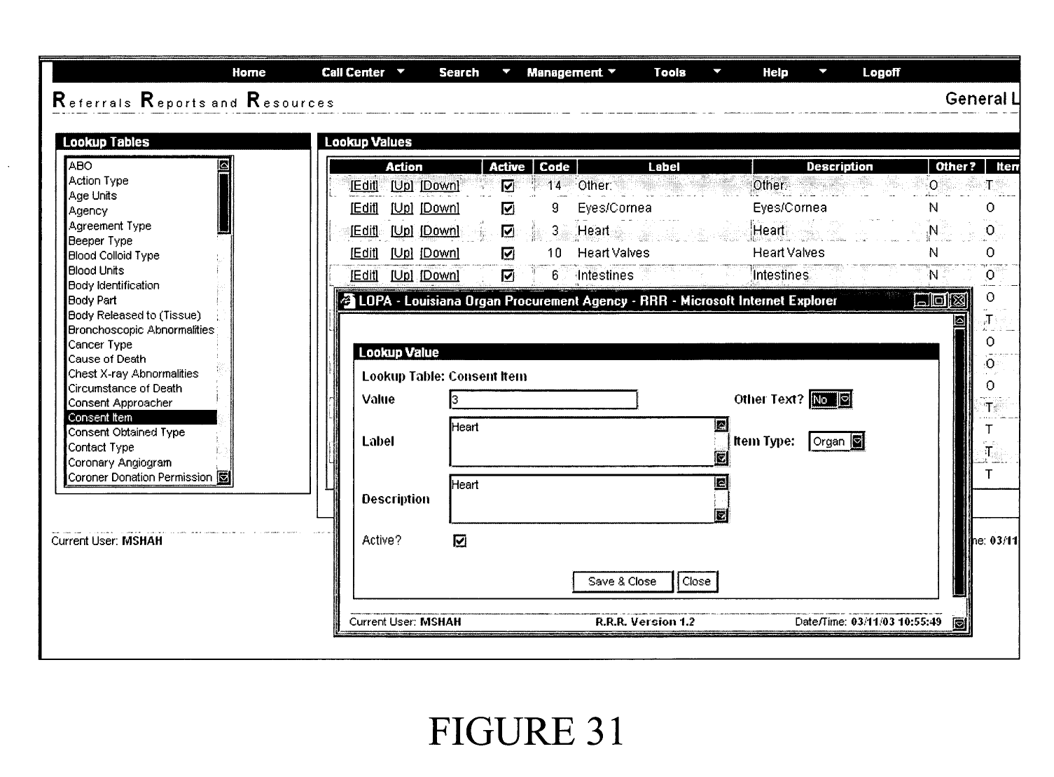

FIG. 32 provides a manner in which users can add/edit/inactivate any lab observation that might need to change in the R3 system.

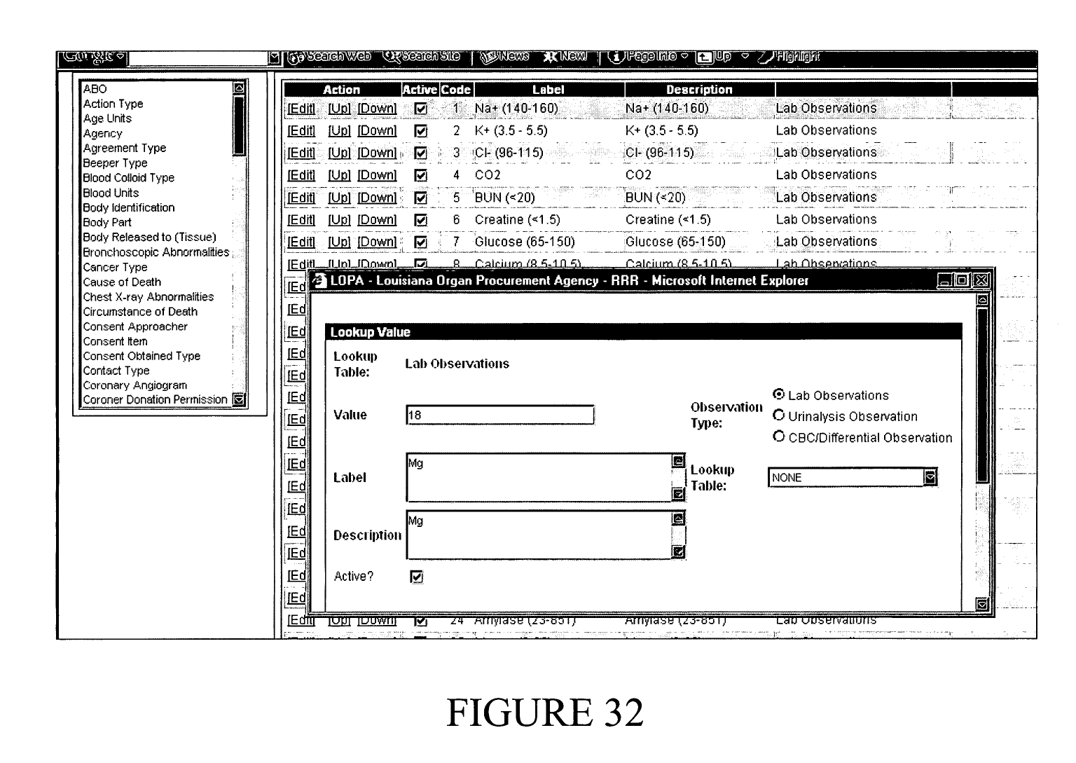

FIG. 33 illustrates the Medical/Social questionnaire which can be edited from the R3 management window.

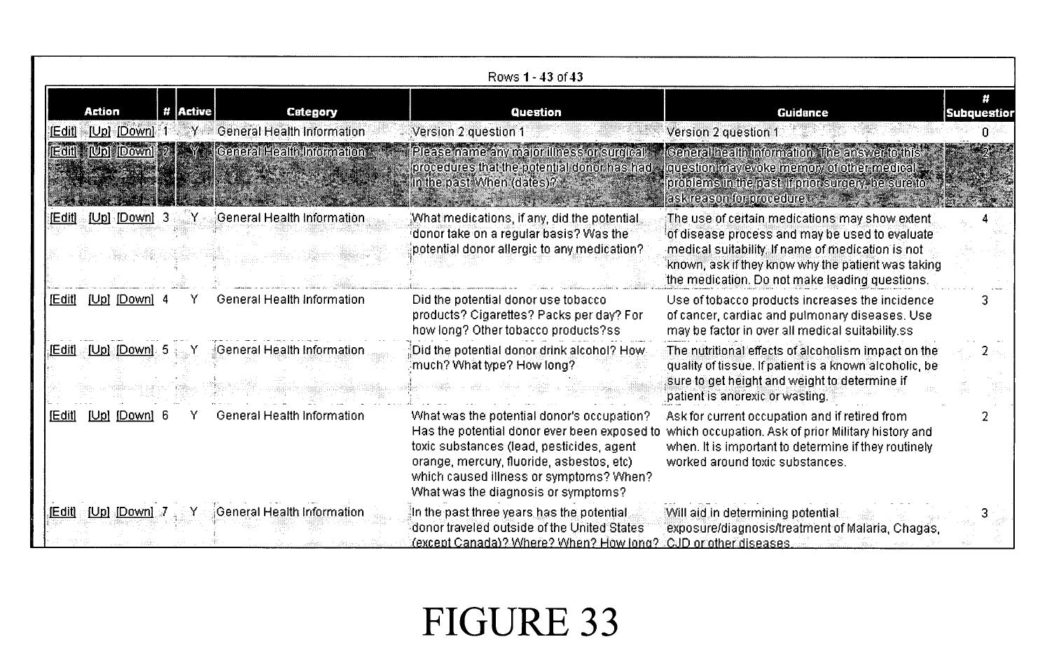

FIG. 34 shows how one can edit the question text, the “guidance” text and the “comment prompt”.

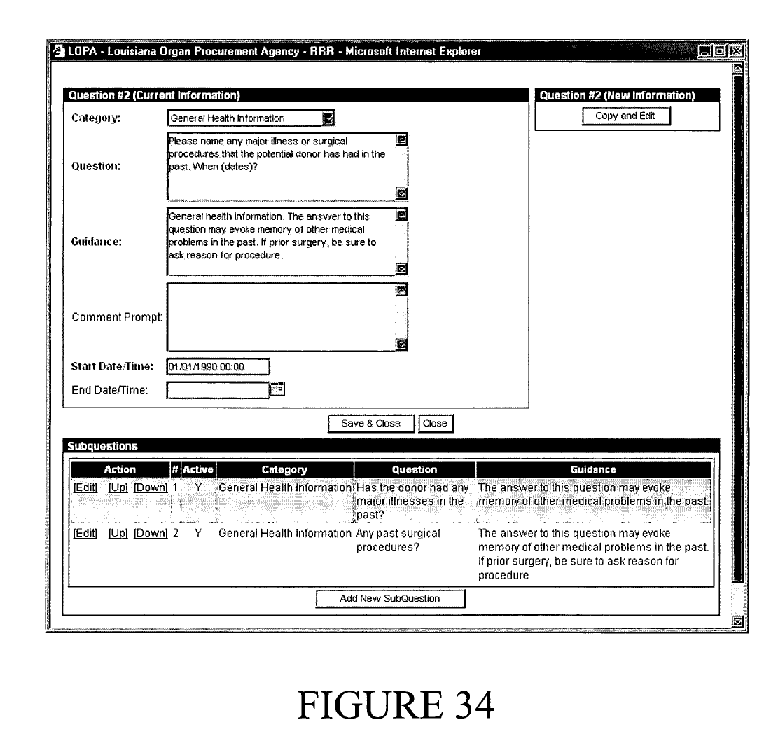

FIG. 35 shows how users are allowed to break questions into “subquestions.”

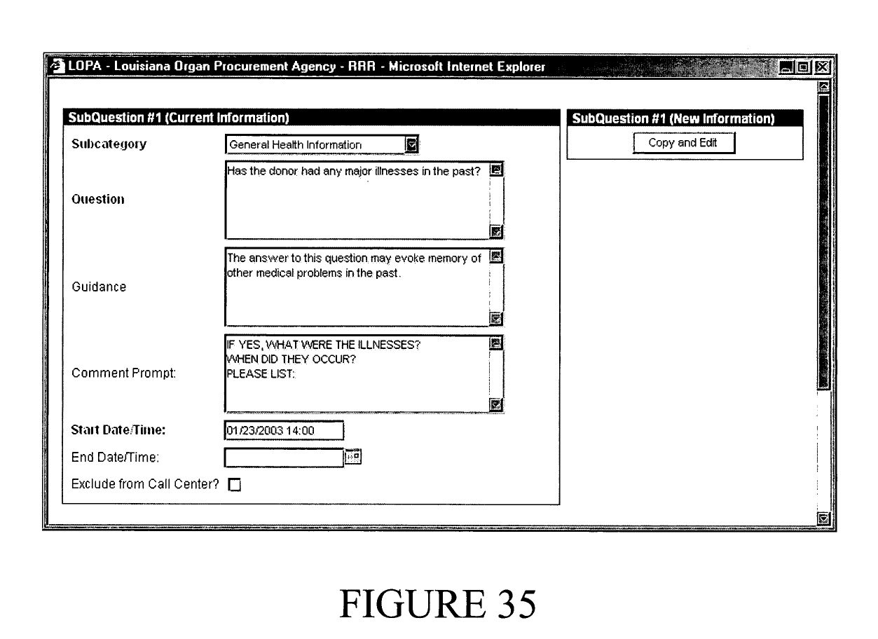

FIG. 36 provides a screen in which a user can also modify the consent addendum via the management functions.

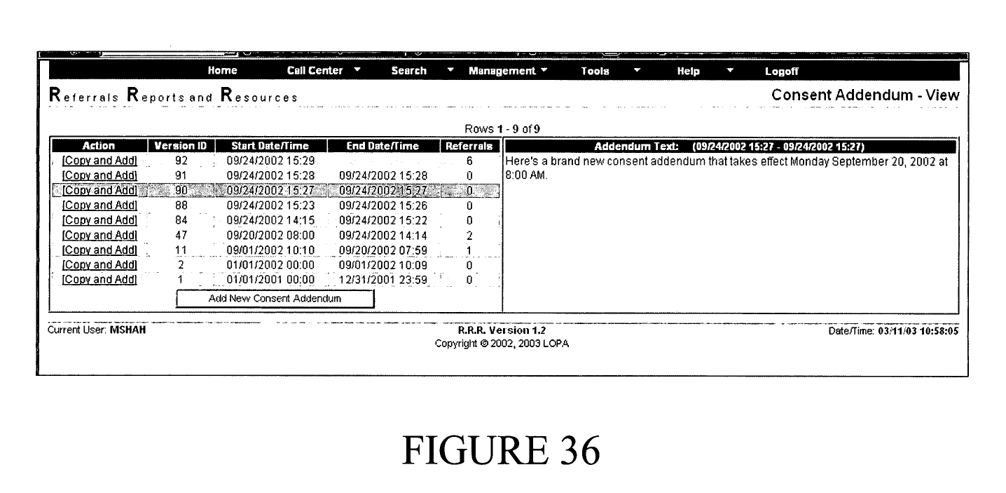

FIG. 37 depicts how the help system is user-modifiable and maintainable.

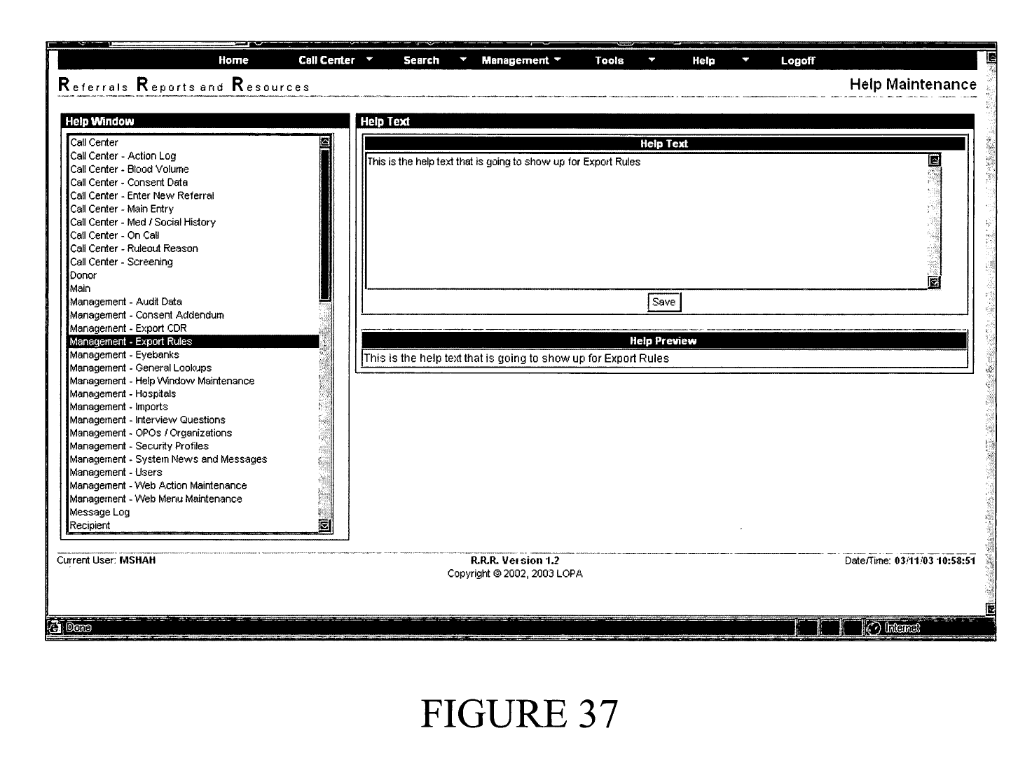

FIG. 38 illustrates how all user activity, including viewing referral data, is saved for audit trail purposes, and how such activity is searchable from the management menu.

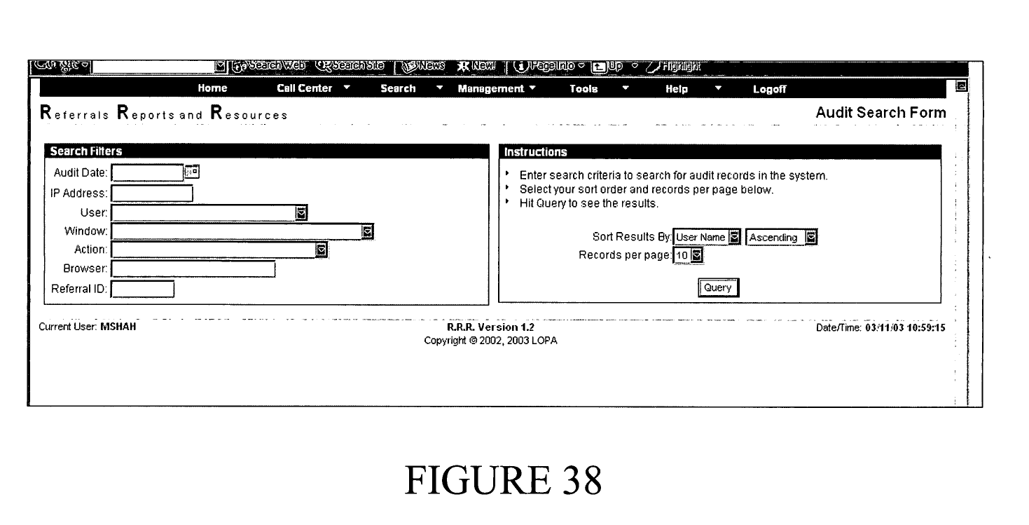

FIG. 39 shows how the management area allows for entry and maintenance of user schedules.

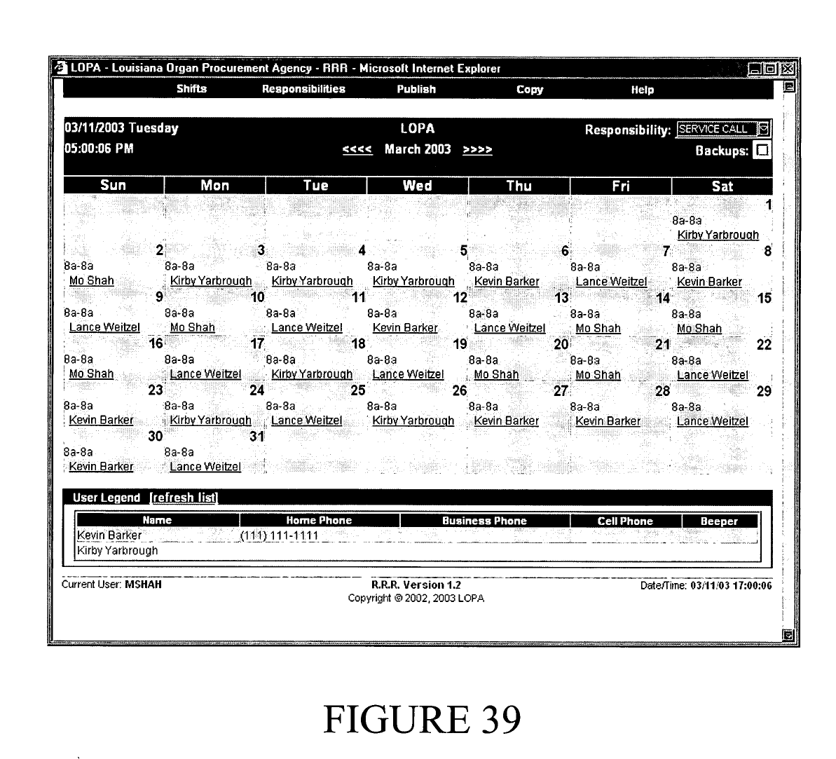

FIG. 40 shows how users can view referrals from the call center menu.

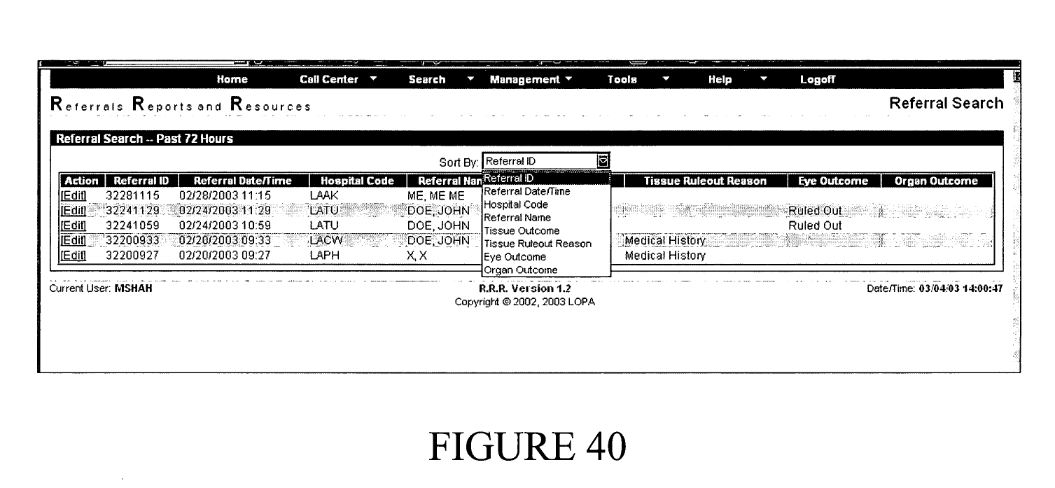

FIG. 41 depicts how call center personnel may also add/modify messages in the “message log.”

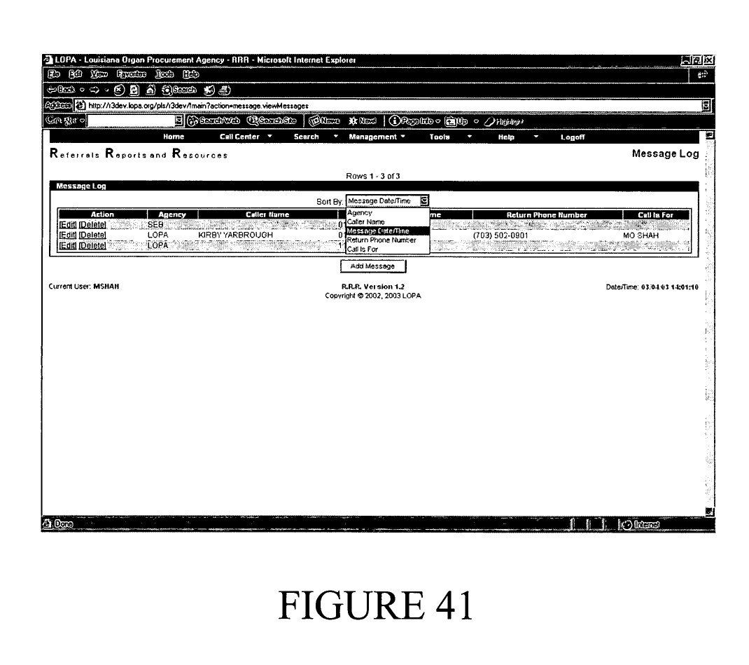

FIG. 42 shows how the message log contains information about the call, including time, date, and personnel information.

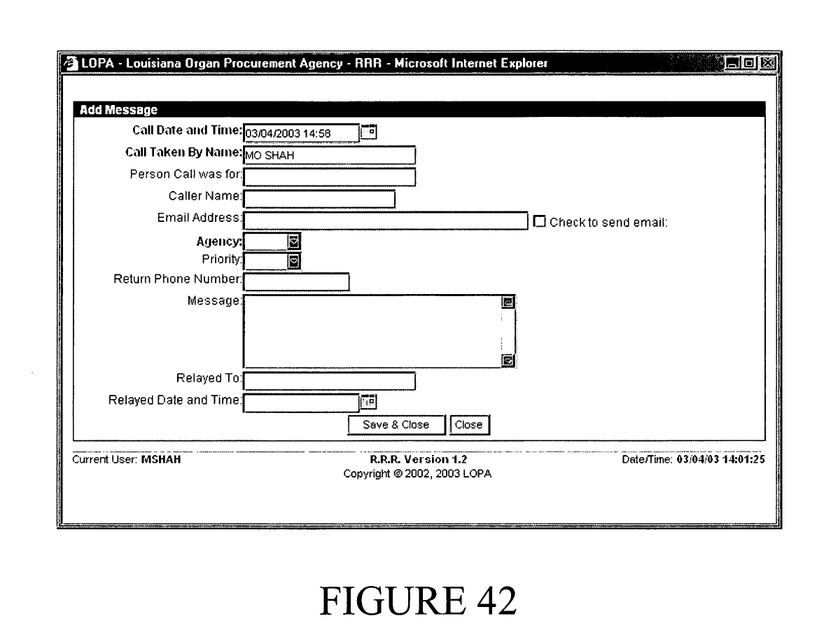

FIG. 43 illustrates how the first page of the referral data contains all of the basic information about a referral.

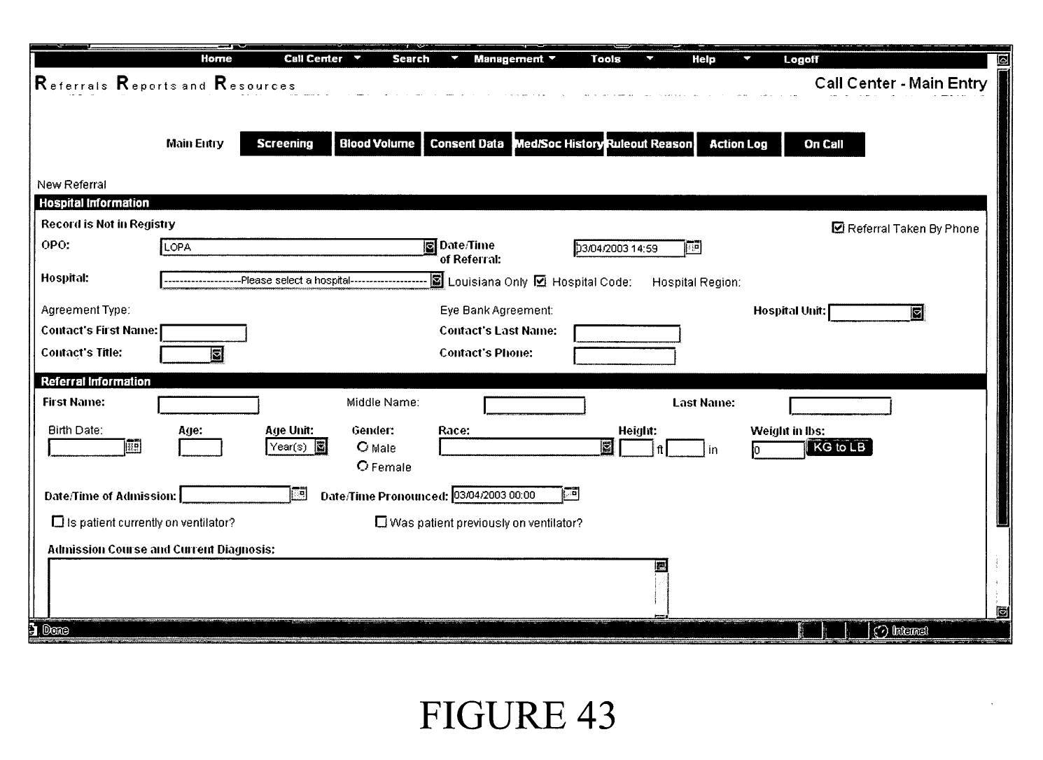

FIG. 44 depicts the manner in which the R3 system has multiple edits on the fields and on all of the screens of the system.

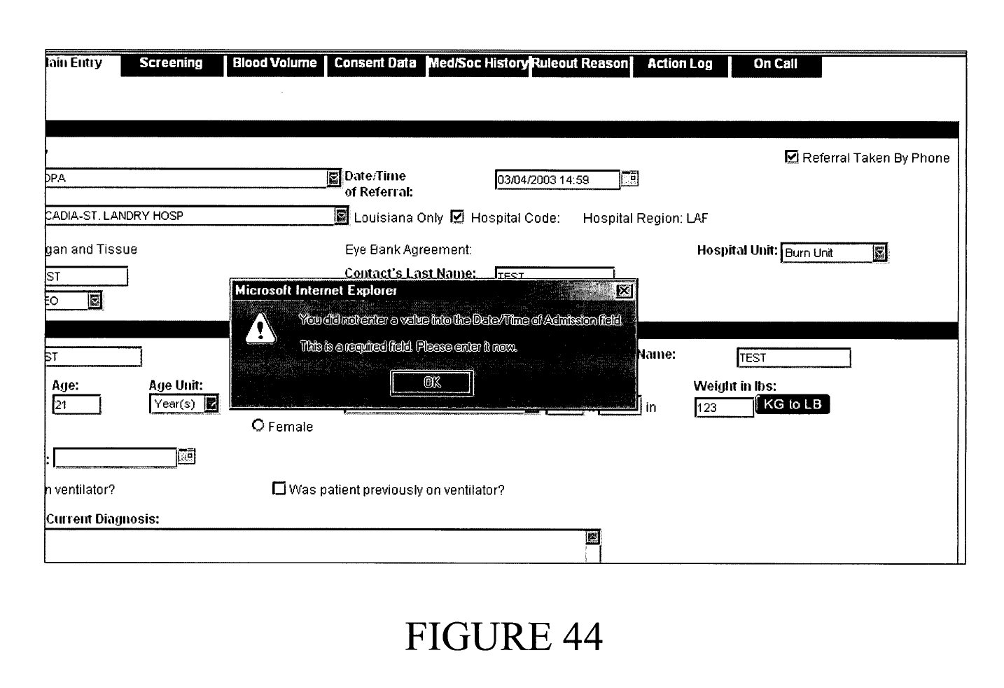

FIG. 45 shows how dates can be entered through the keyboard, or by clicking on calendar icons.

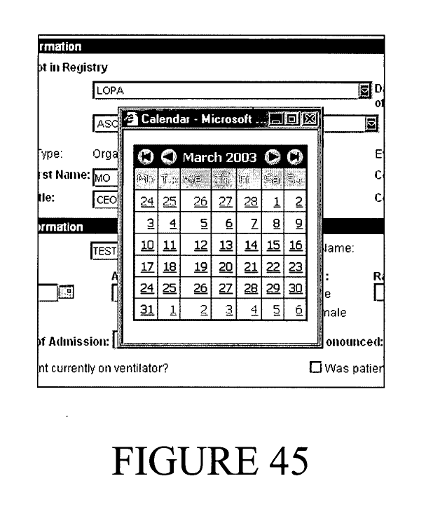

FIG. 46 shows that upon the save of the referral, the R3 system directs the user to a next page if the referral does not trigger “automatic” rule outs that can be set within the system.

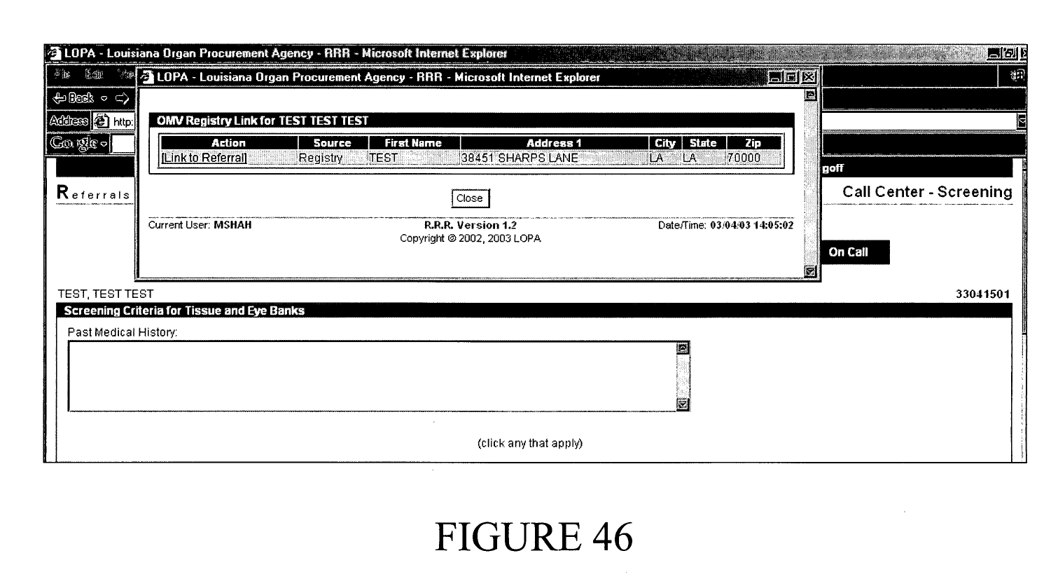

FIG. 47 indicates a screening page which allows a straightforward process in ruling out referrals for eye and tissue. A list of criteria are shown which are user maintainable.

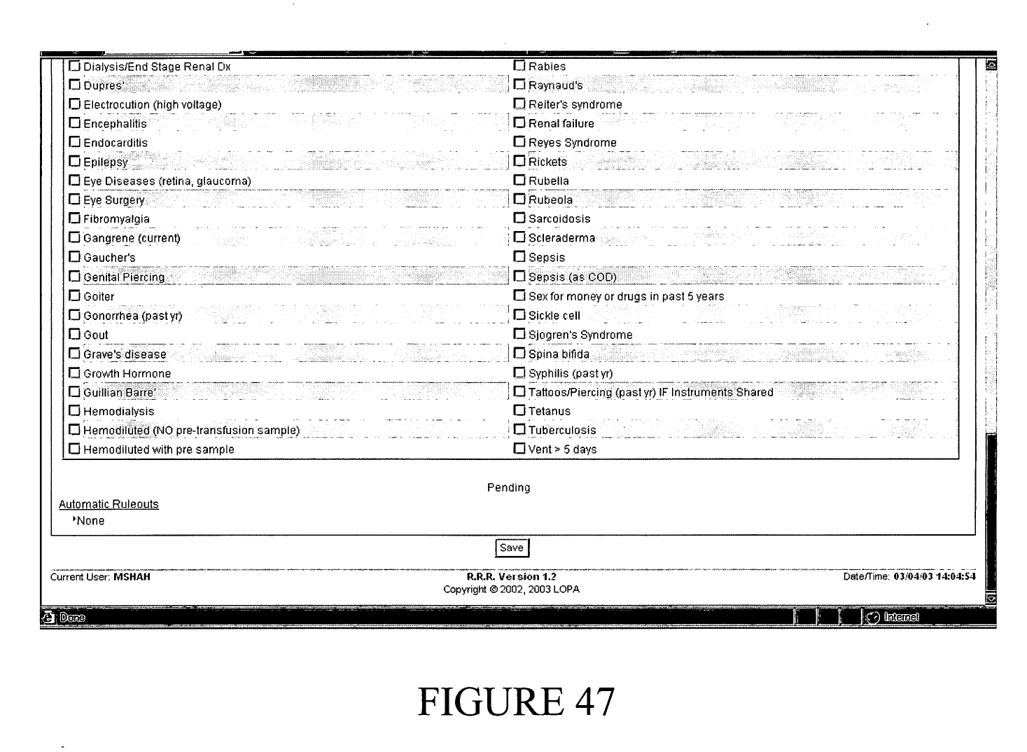

FIG. 48 provides a hemodilution screen which records the basic blood volumes for the particular referral.

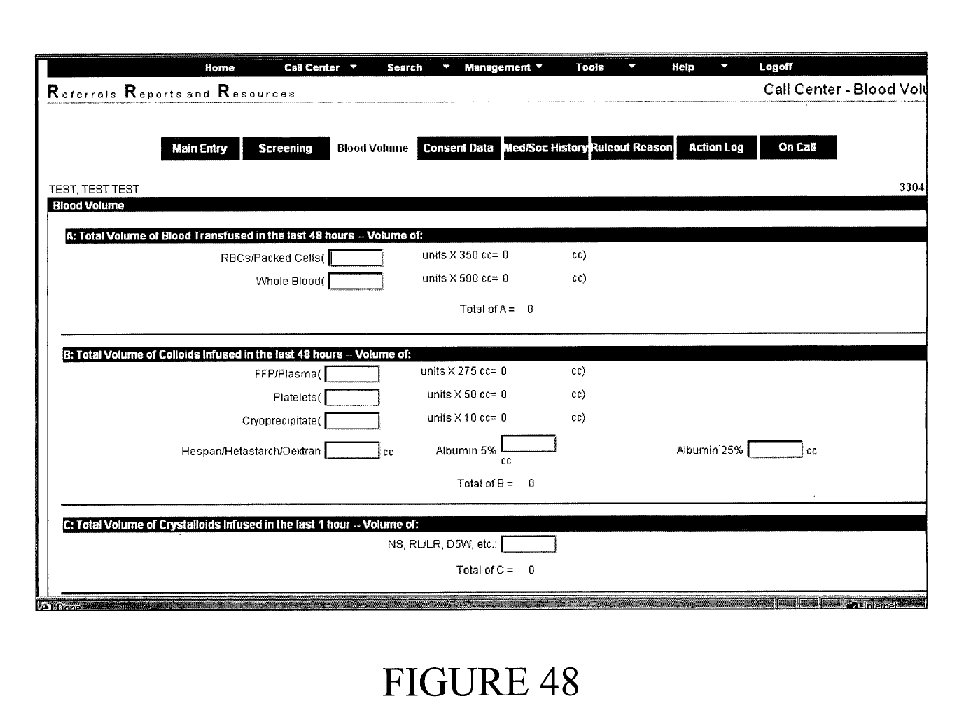

FIG. 49 depicts the consent area which allows the user to record consent information for a particular referral.

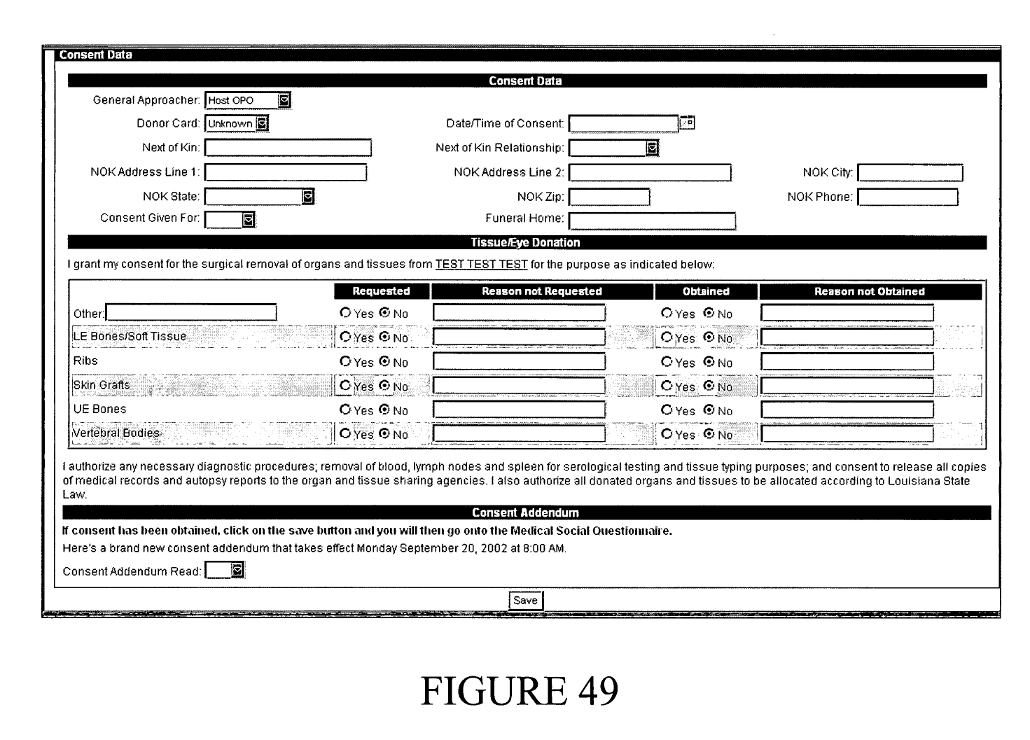

FIG. 50 depicts a consent addendum. The R3 system tracks who read the consent addendum as well as the time.

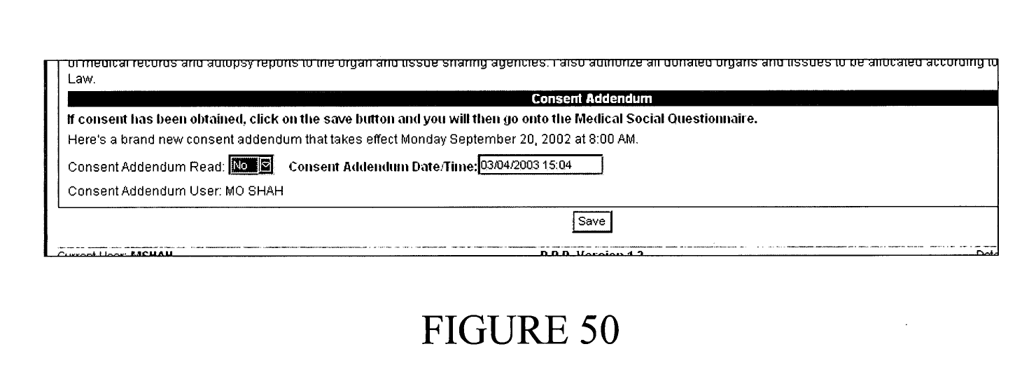

FIG. 51 shows how the call center also provides the user with the medical/social questionnaire to read to the interviewee.

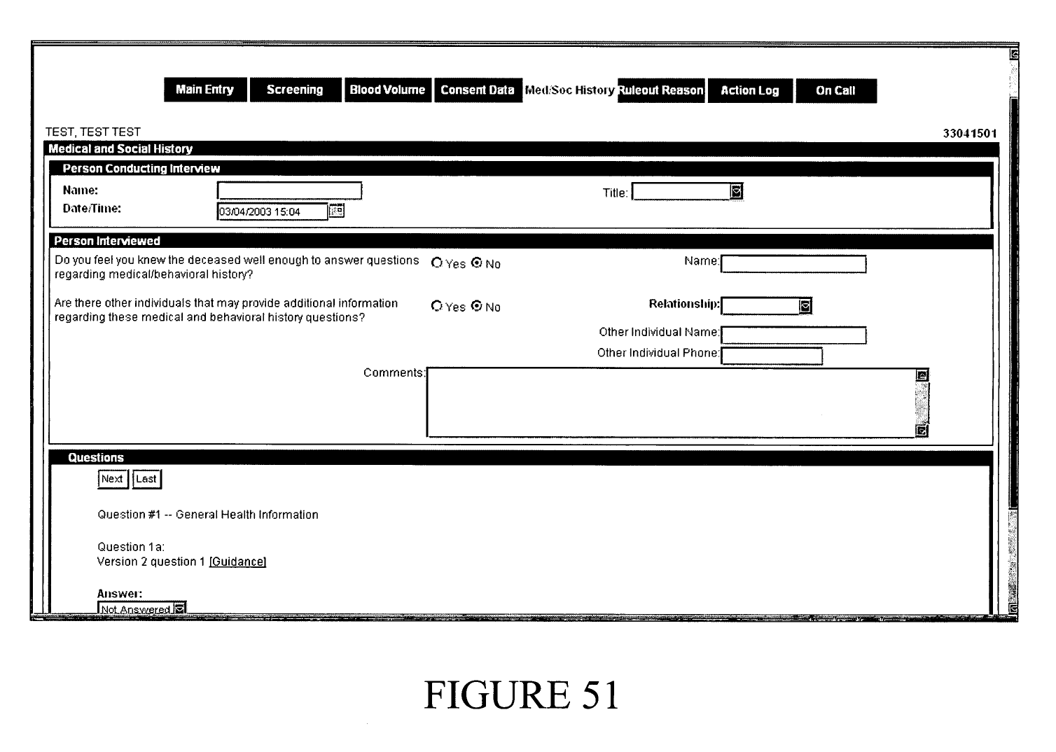

FIG. 52 illustrates how the system does not prompt for elaboration unless a question is marked in a predetermined manner.

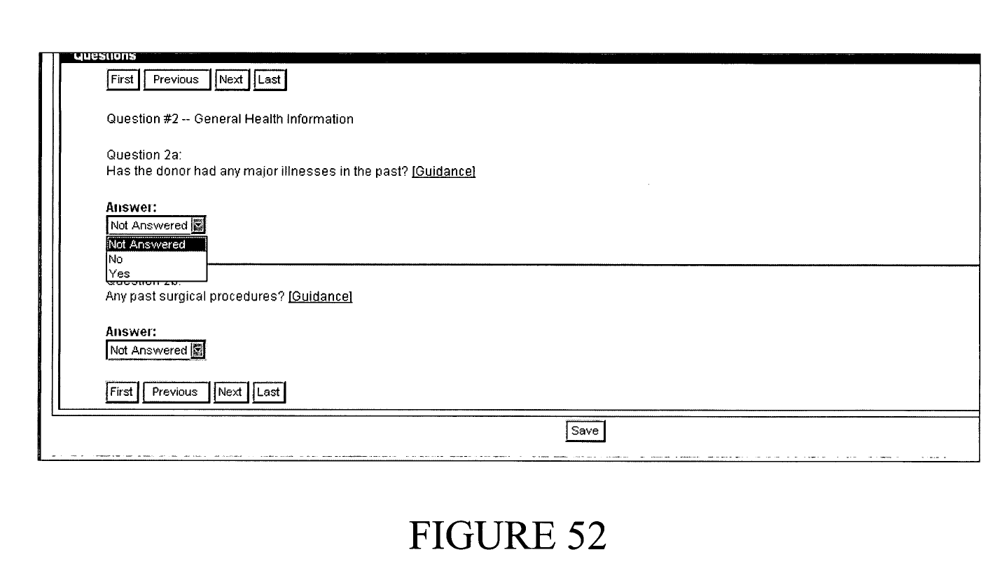

FIG. 53 shows how selection of a particular answer to a question allows the user to prompt an interviewee for additional information.

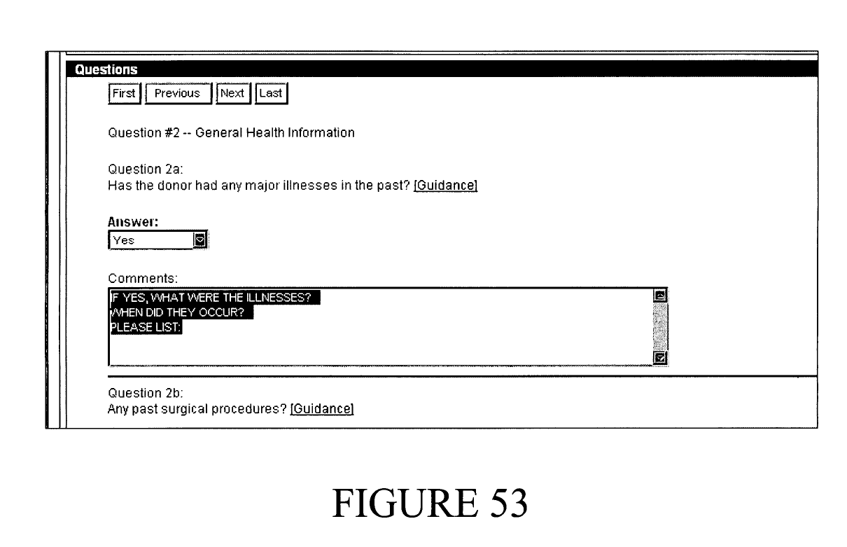

FIG. 54 depicts how the user can also click on a “Guidance” button which contains additional information that might be useful to the interviewee in answering questions.

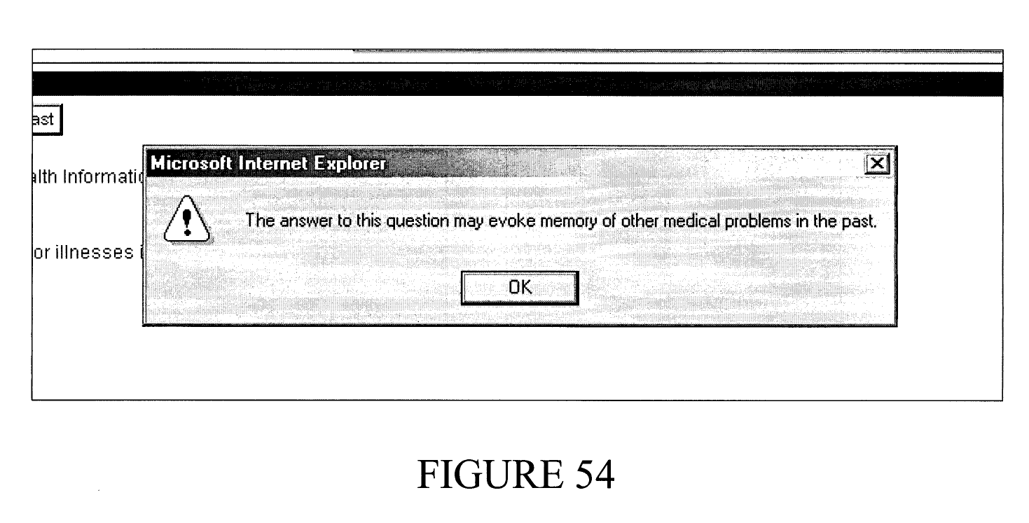

FIG. 55 shows how the system validates the Med/Soc questionnaire, checking for missing entries, blank fields, and unanswered questions.

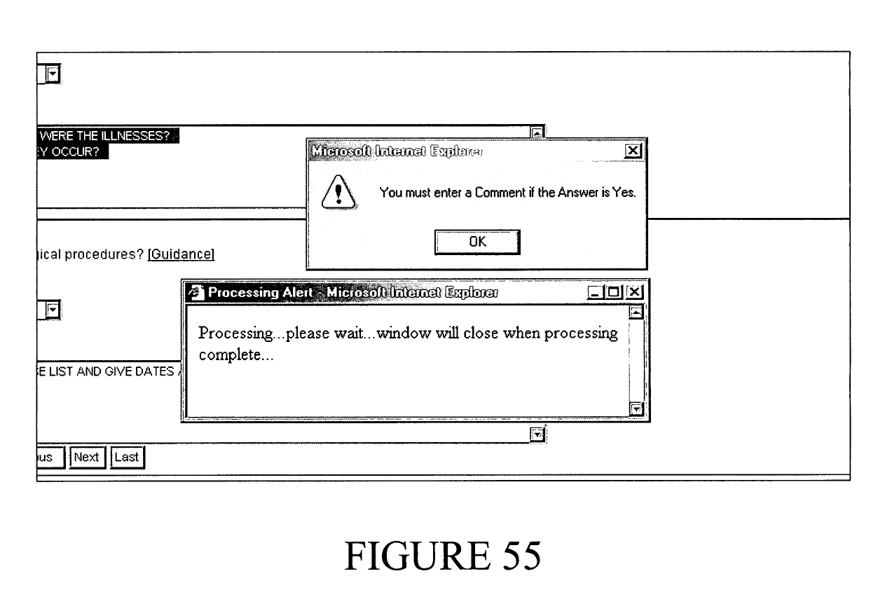

FIG. 56 depicts the outcome page which allows the user to view the outcome and ruleout reasons for a referral.

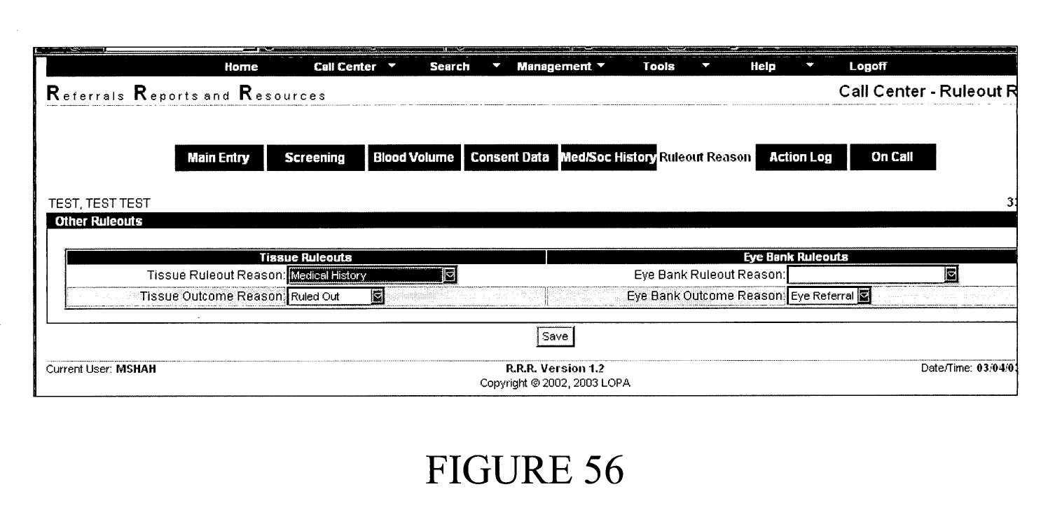

FIG. 57 shows that the action log contains a record of any activity on a referral.

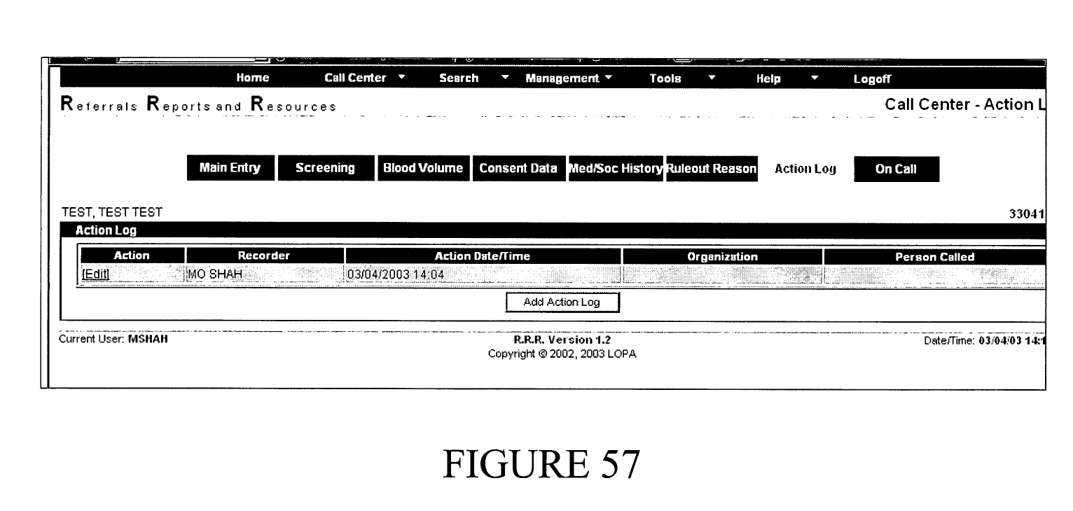

FIG. 58 illustrates the type of information contained in the action log on a referral.

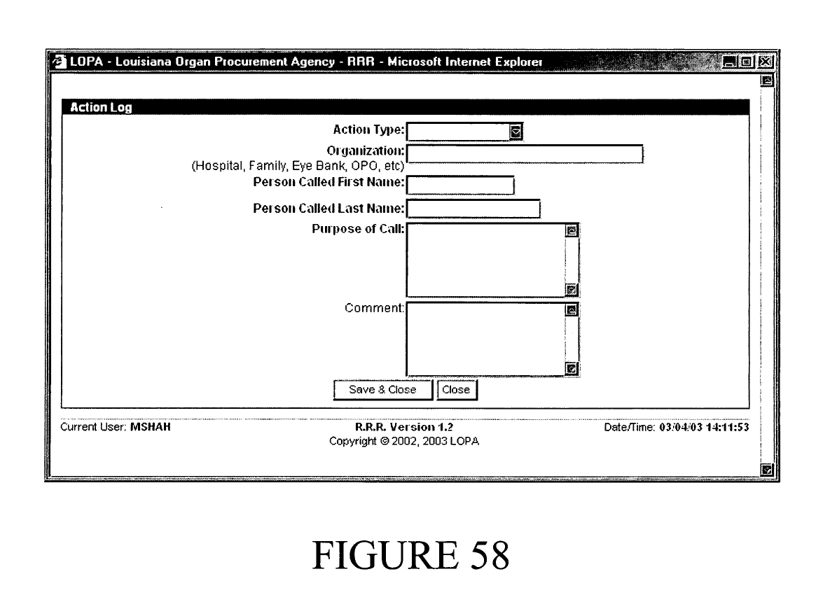

FIG. 59 depicts how the on-call information shows who is to be contacted for particular responsibilities in the system.

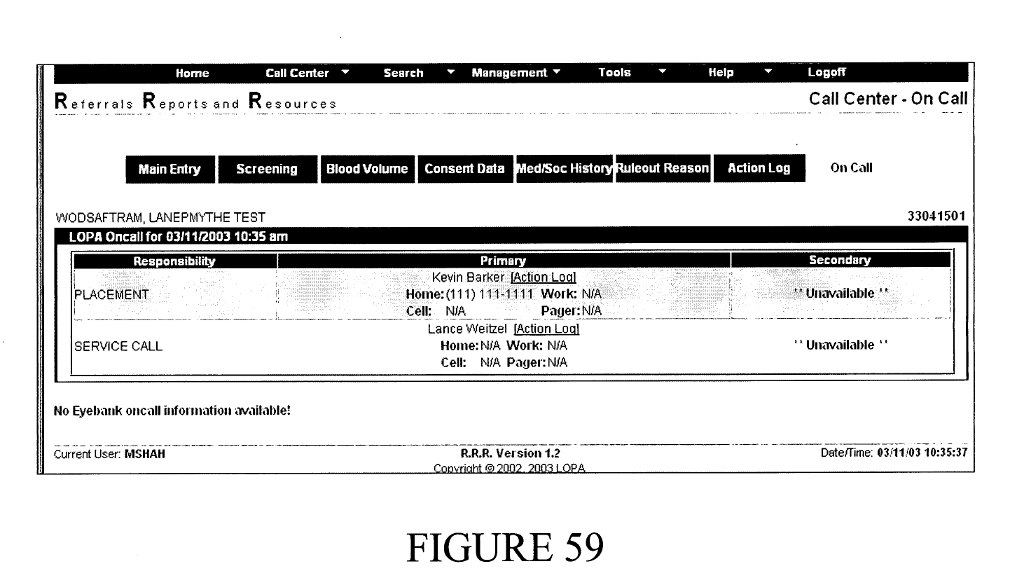

FIG. 60 depicts the variety of referral search parameters which may be used in conjunction with one another in a search query.

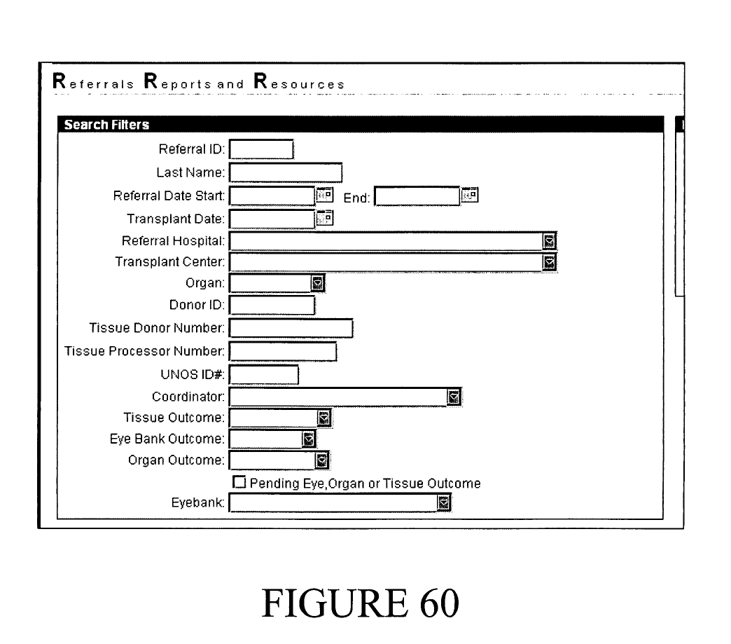

FIG. 61 shows additional sort criteria that can be specified in a referral search.

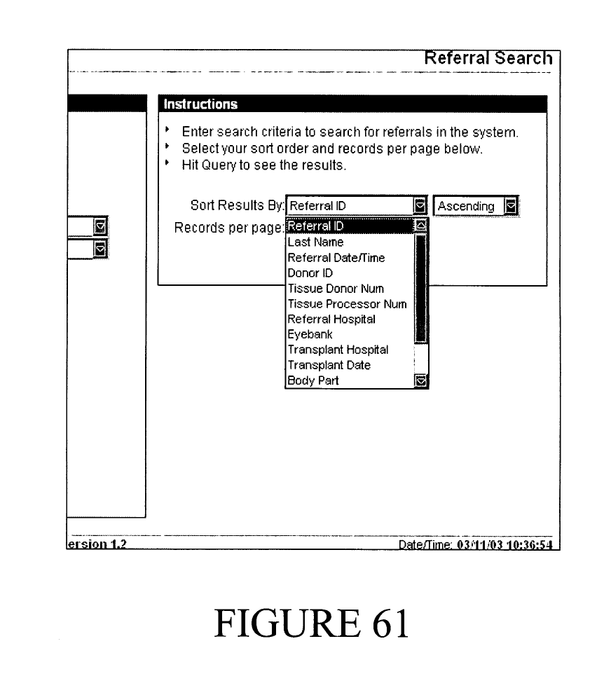

FIG. 62 shows a resulting list from a referral search.

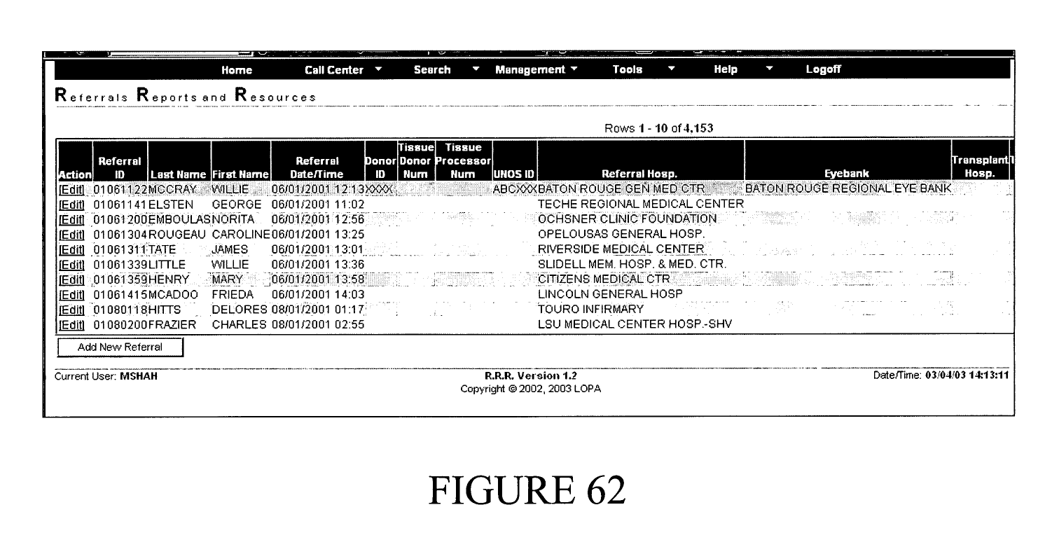

FIG. 63 illustrates an example of the detailed information for a particular referral chosen from the list after a search.

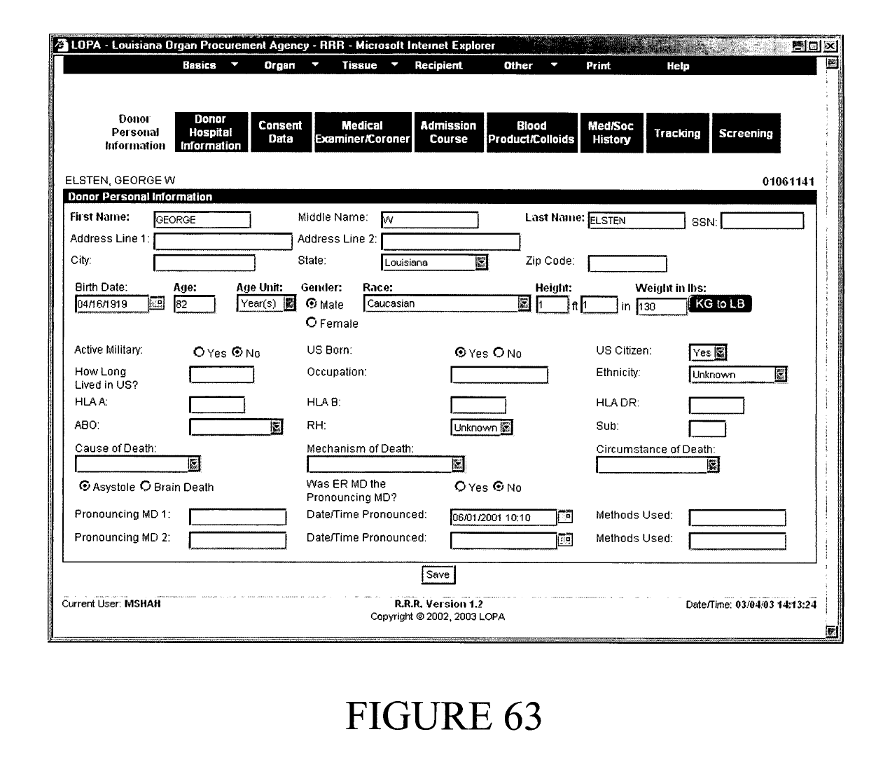

FIG. 64 depicts how a user can move from any point in the clinical area to any other point by using the top menu, such as the “Basics” menu shown.

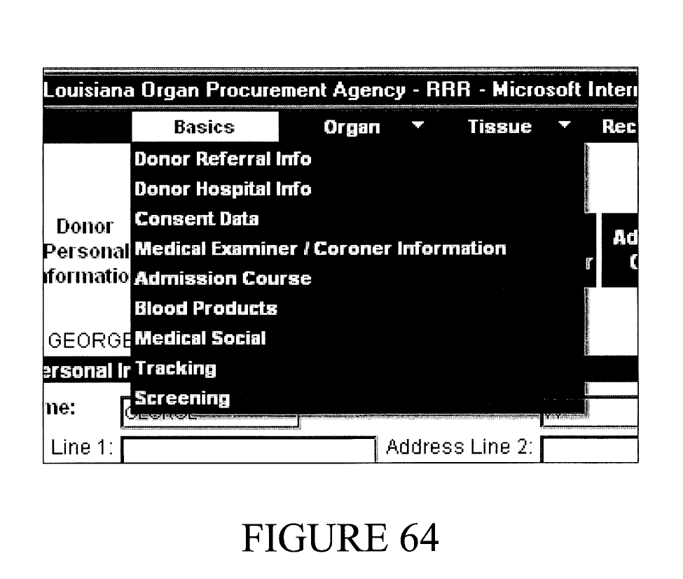

FIG. 65 shows that the organ menu contains all organ-related clinical data, including specific organ information, e.g. heart, liver, lung, kidney, intestine and pancreas.

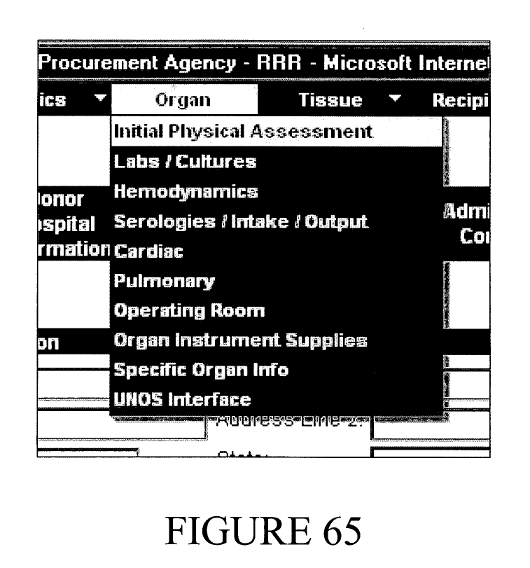

FIG. 66 shows that the tissue menu contains tissue-specific information, including cultures, serologies, tracking, personnel, and hemodilution.

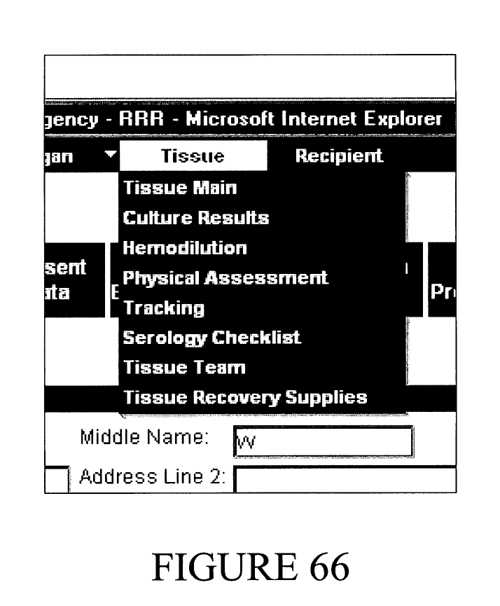

FIG. 67 shows that the “Other” menu contains additional tools for the user, such as tracking correspondence, generating data letters, attaching files, locking and deleting, as well as viewing the audit trail for a referral.

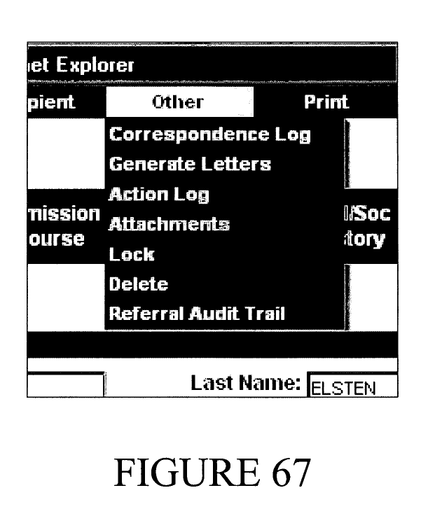

FIG. 68 depicts the hospital data page which contains all data related to the hospital and the caller.

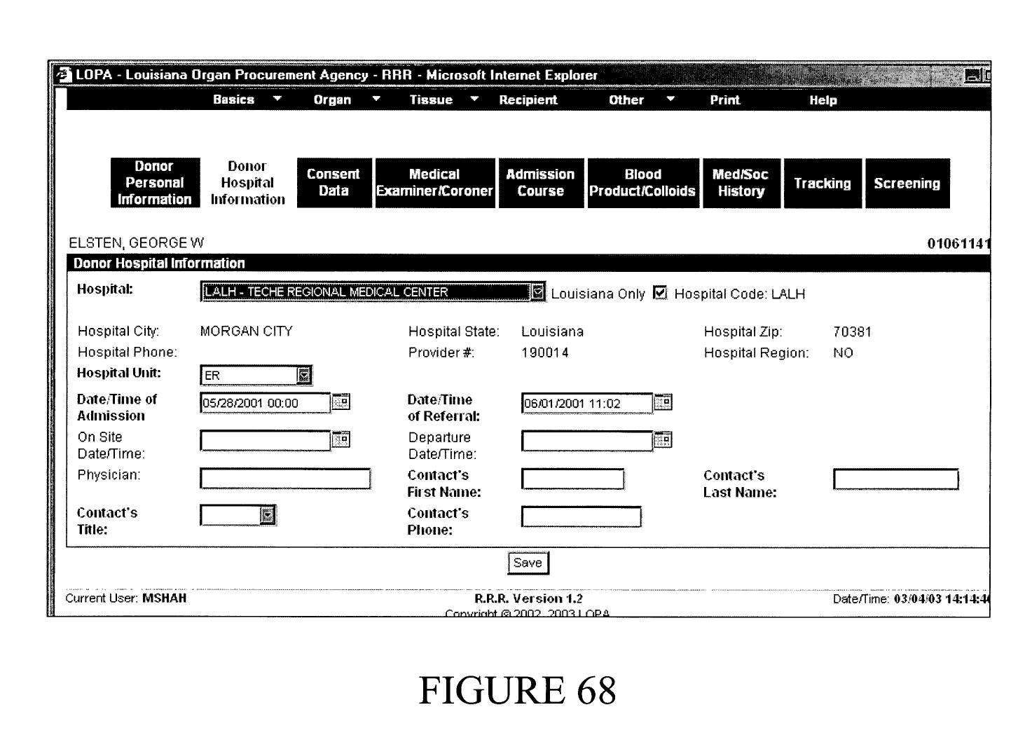

FIG. 69 depicts the consent data page which shows consent related information.

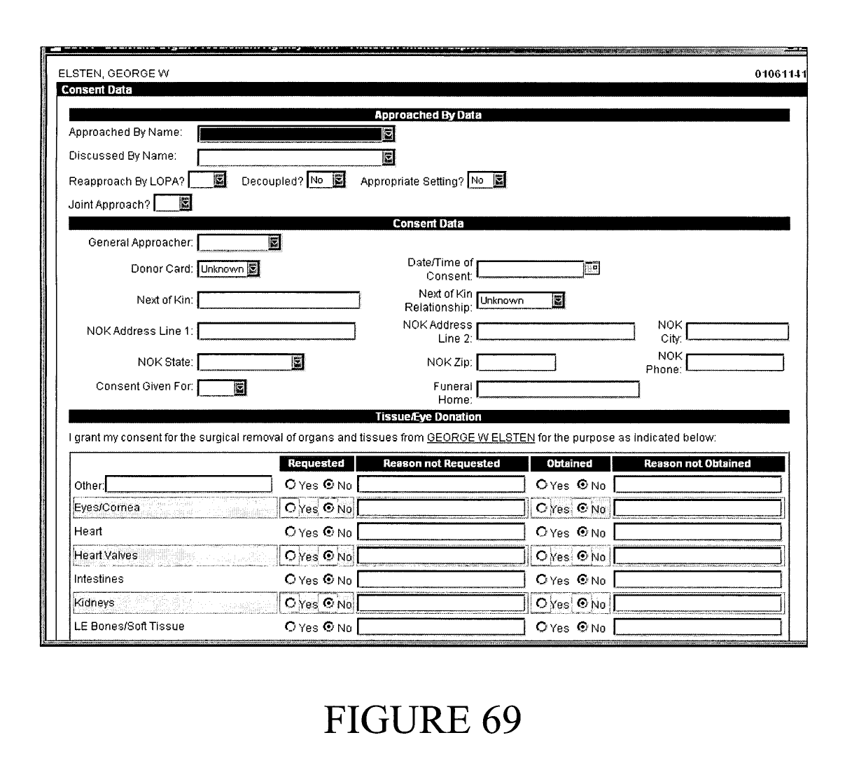

FIG. 70 depicts the medical examiner and coroner page which shows information related to these officials.

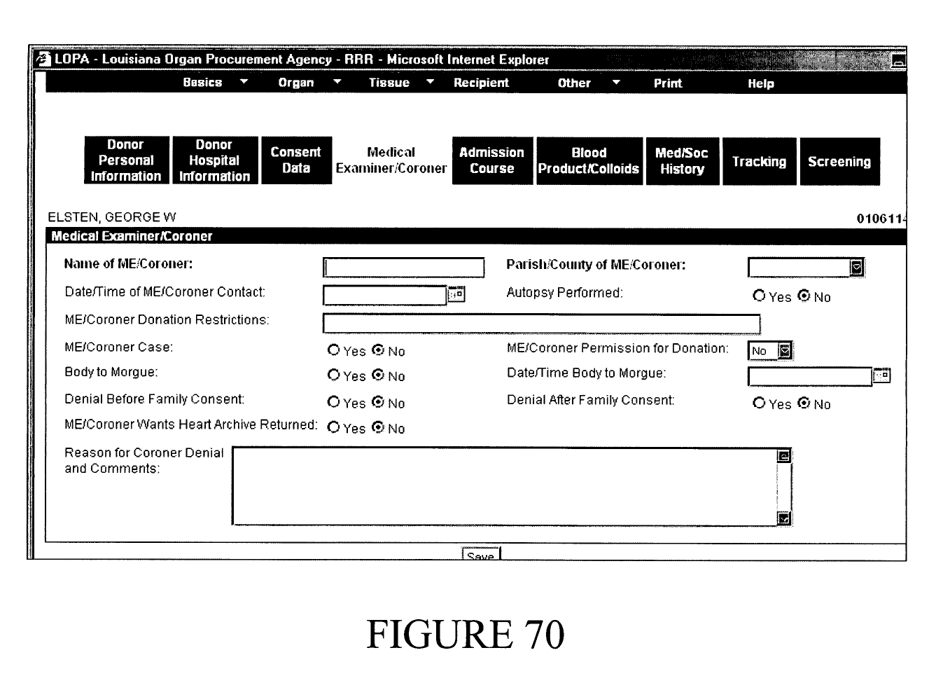

FIG. 71 depicts the admissions course page which contains text about the referral's stay in the hospital.

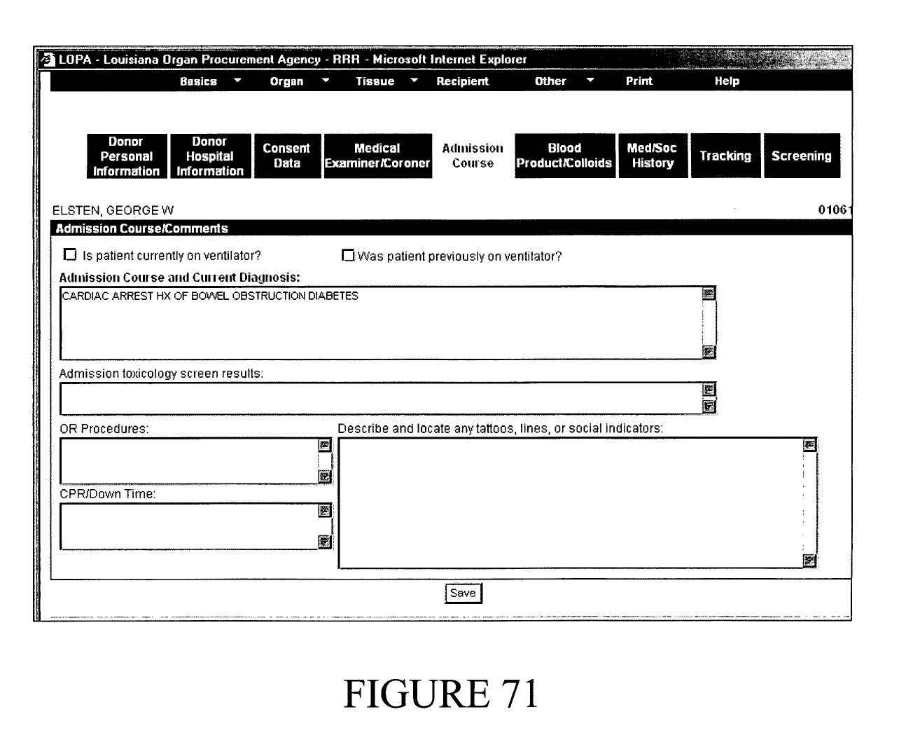

FIG. 72 shows the blood product/blood colloids page which allows the entry of all blood products information, including crystalloids administered, and crystalloids maintained and replaced.

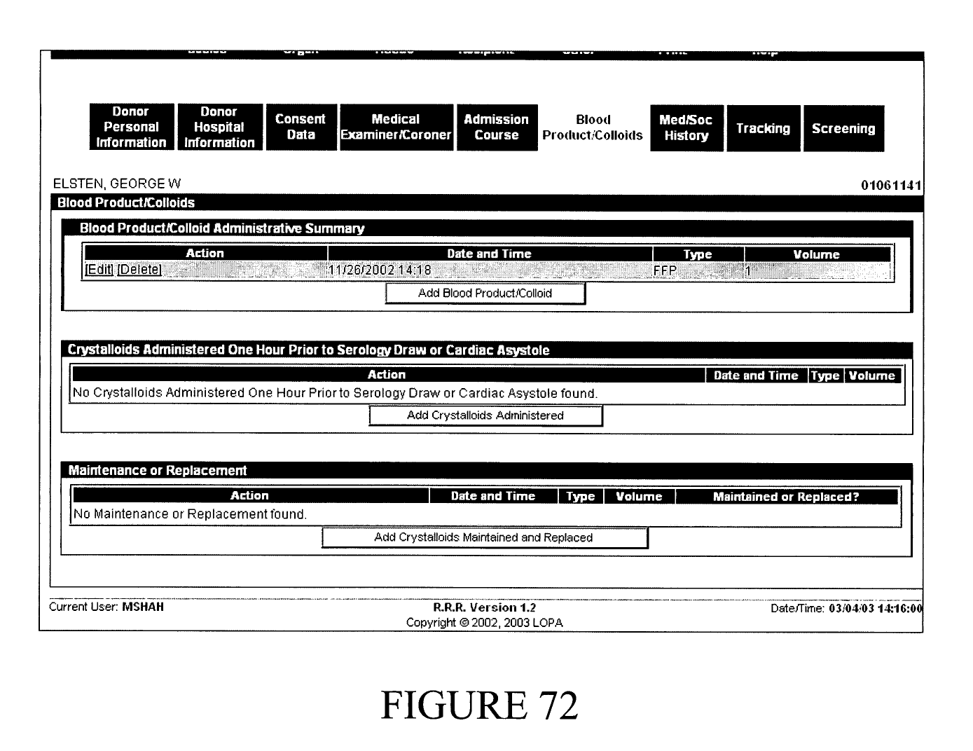

FIG. 73 shows how entering a record is ccomplished by entering all of the mandatory information from drop-down lists.

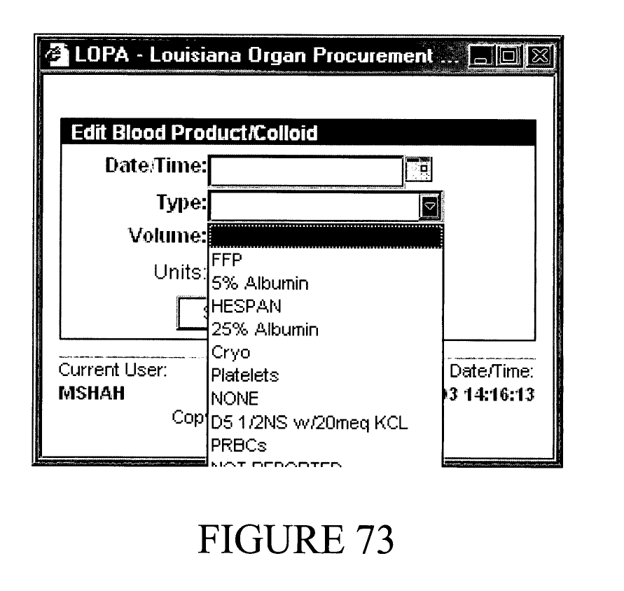

FIG. 74 shows the Med/Soc questionnaire page.

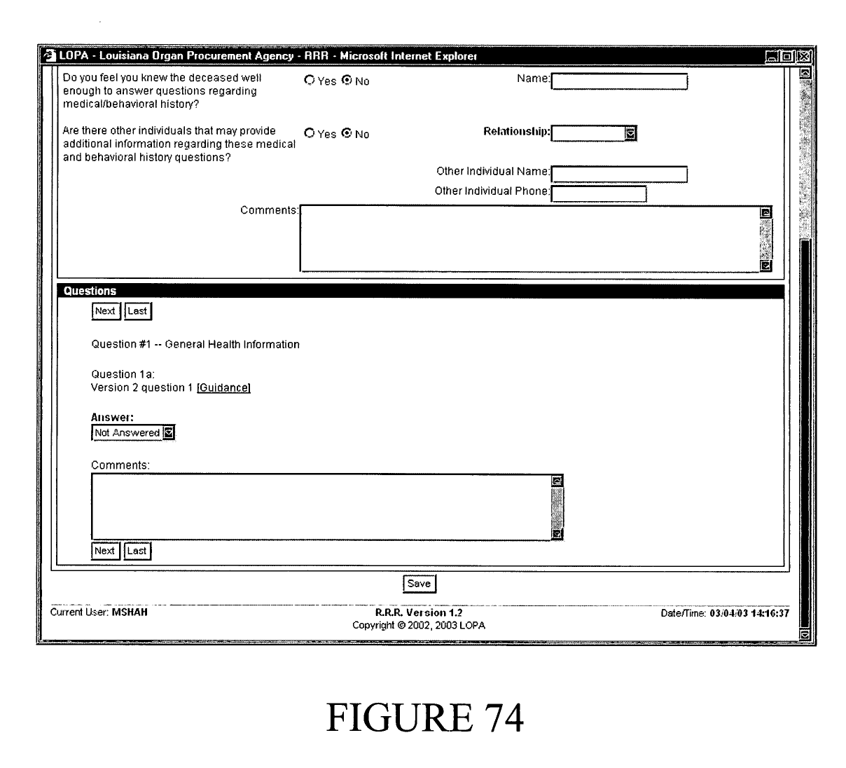

FIG. 75 shows that the tracking page contains all of the outcome, statues and tracking information for a referral.

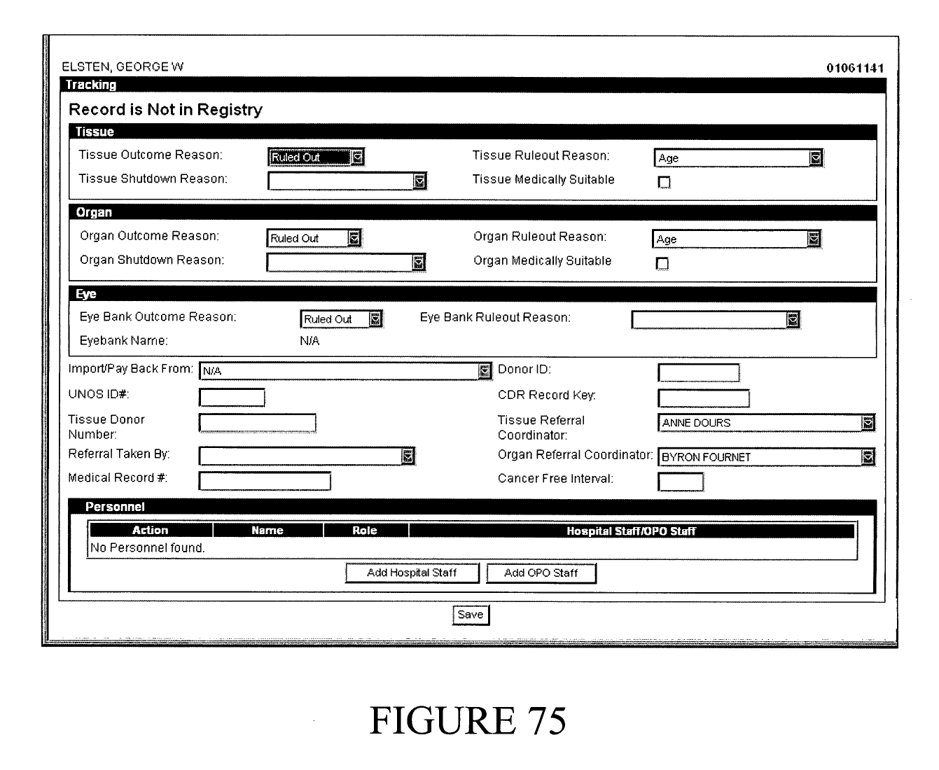

FIG. 76 illustrates how a user can track all staff (both OPO-based and non-OPO-based) from the tracking page.

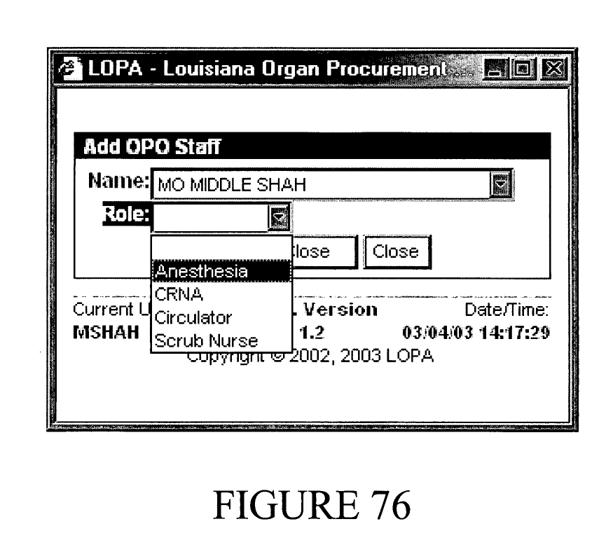

FIG. 77 shows the Initial Physical Assessment (IPA) screen which may contain organ-specific data.

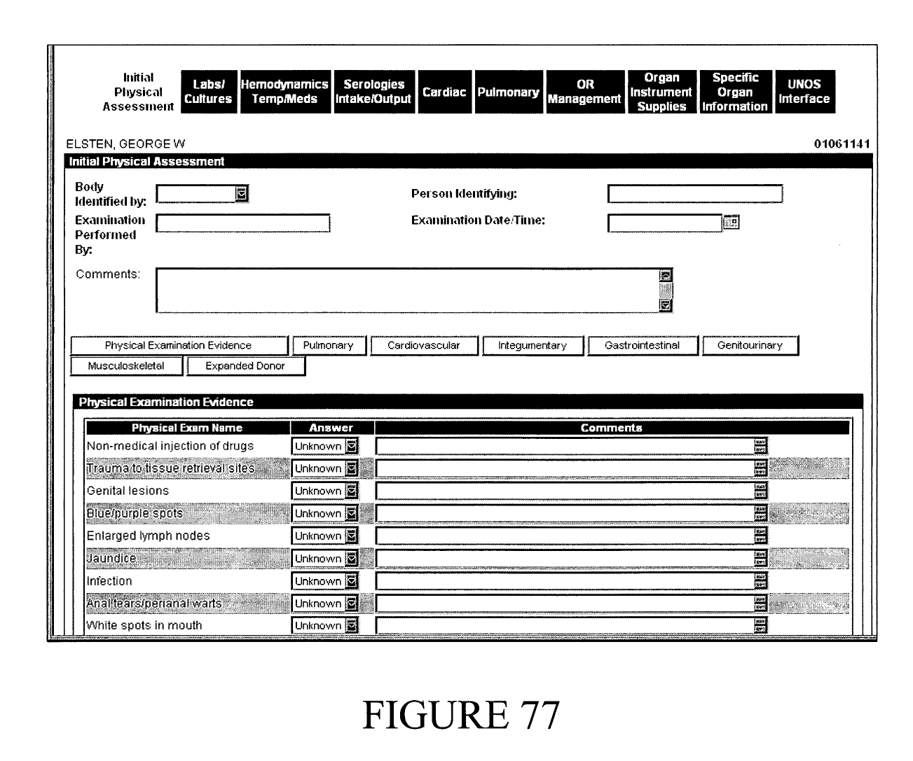

FIG. 78 depicts how the IPA screen may contain different sections, such as a pulmonary section containing information about the tubes, decompression, and breath sounds.

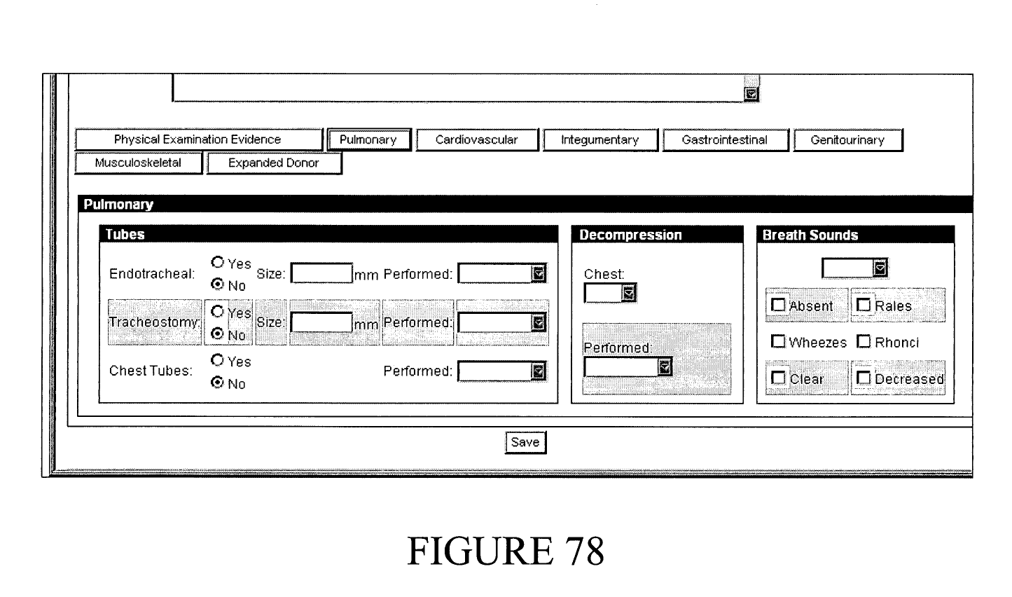

FIG. 79 depicts the cardiovascular section of the IPA screen which contains information about lines, heart rhythm, heart tones, peripheral pulses, edema, and thoracic evaluation.

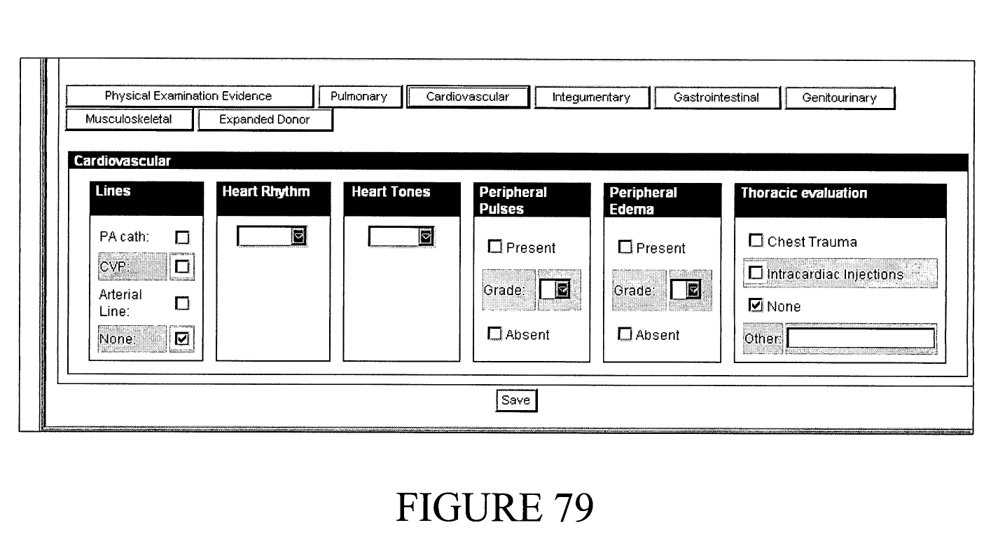

FIG. 80 depicts the integumentary section of the IPA screen which contains information such as color and temperature.

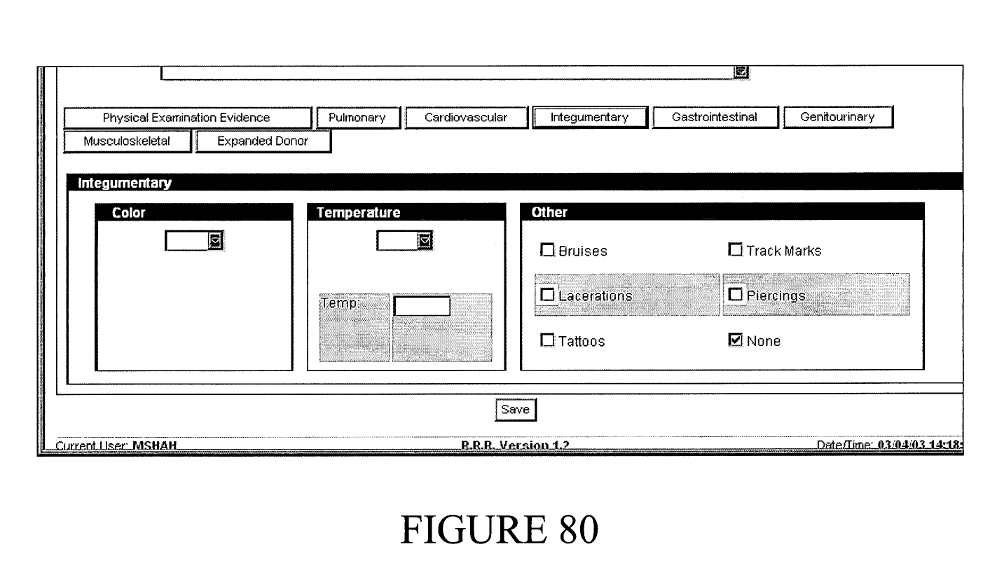

FIG. 81 depicts the gastrointestinal (GI) section of the IPA screen.

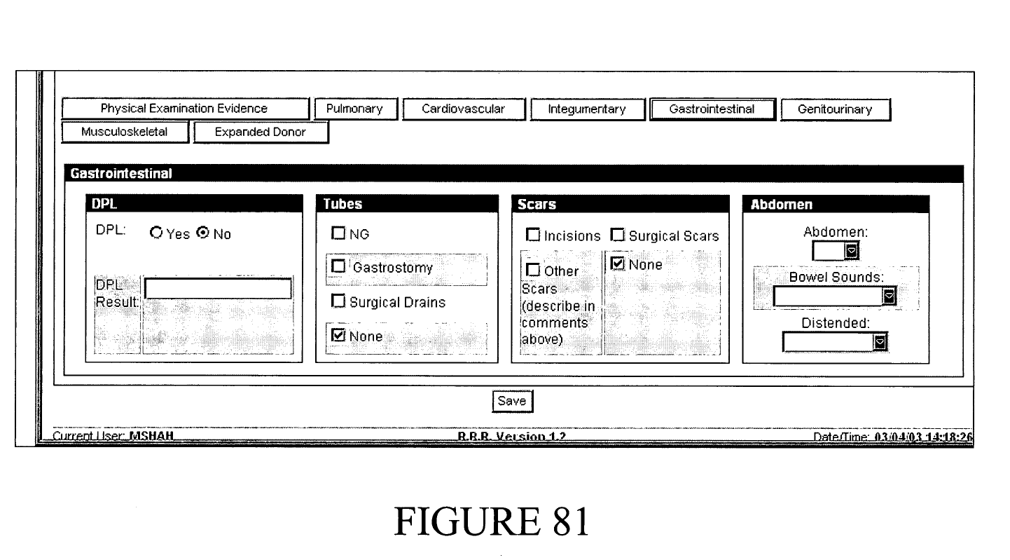

FIG. 82 depicts the genitourinary section of the IPA screen.

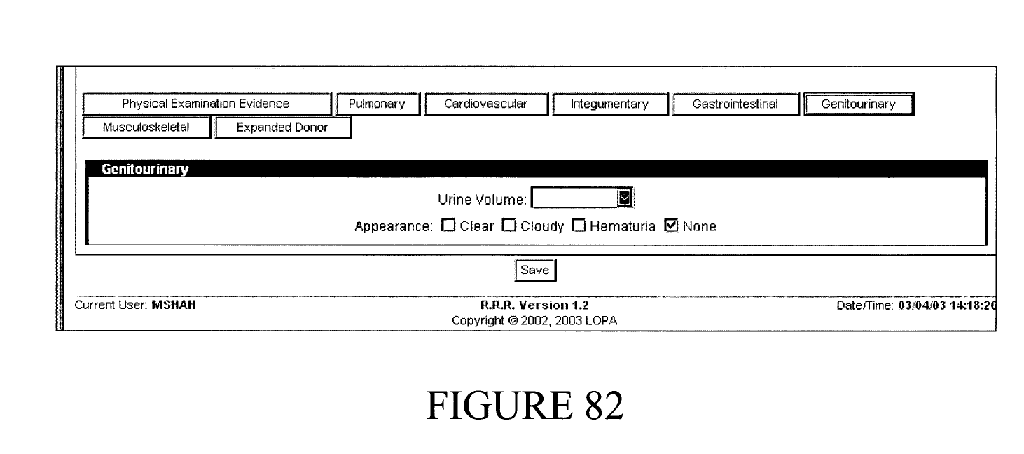

FIG. 83 depicts the muskuloskeletal section of the IPA screen.

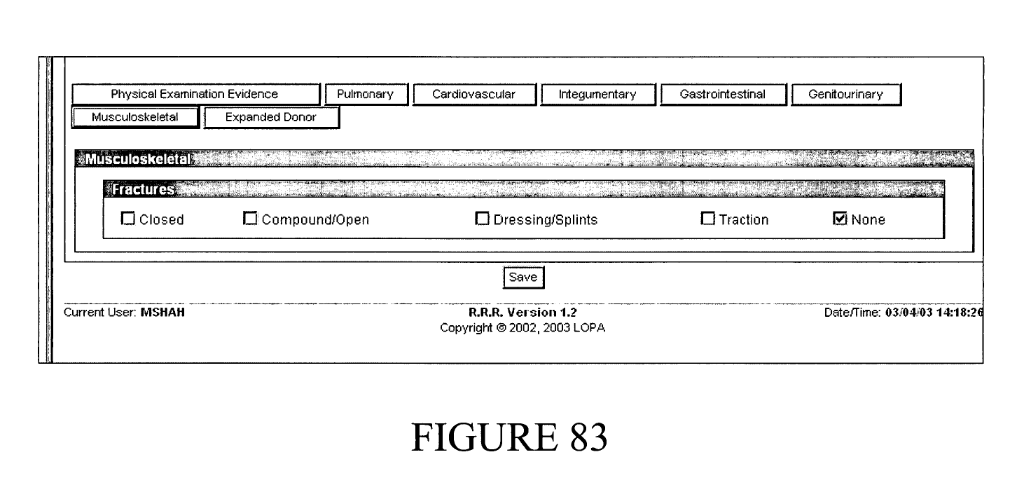

FIG. 84 shows that expanded donor panel which allows the recording of expanded donor criteria and history.

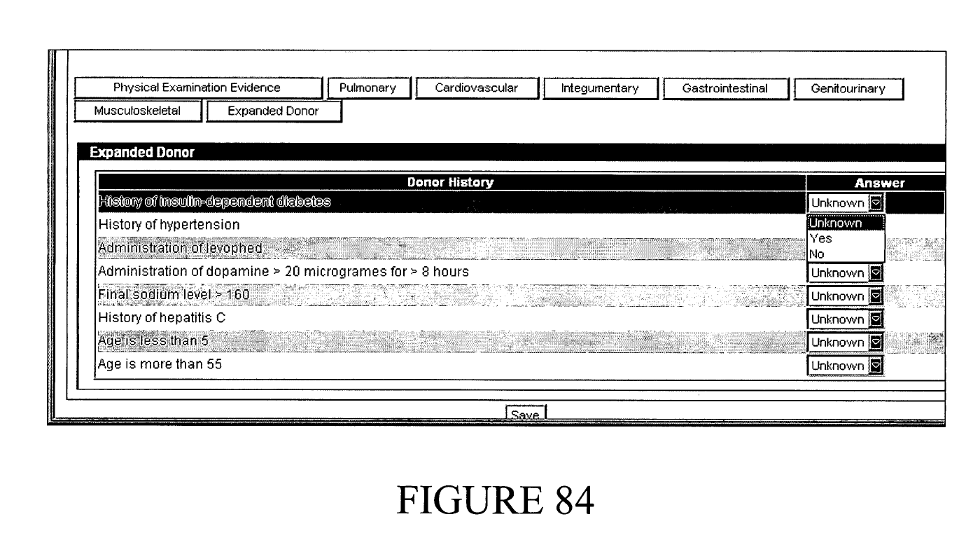

FIG. 85 shows how data is validated in all fields upon saving the information in an IPA screen.

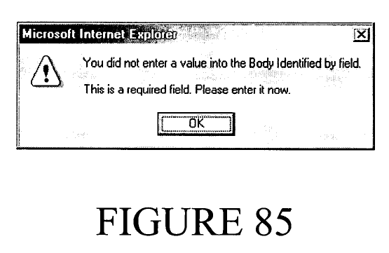

FIG. 86 shows the Labs/Cultures page which allows the entries of lab results, urinalysis and CBC/Differential observations.

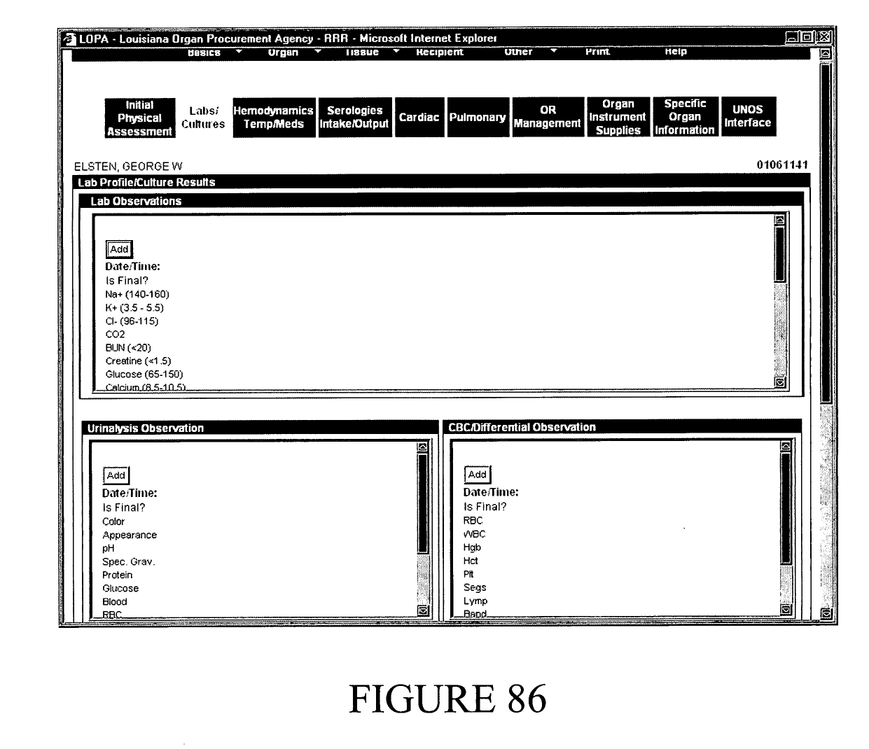

FIG. 87 shows how lab observations may be added in user-maintainable fields.

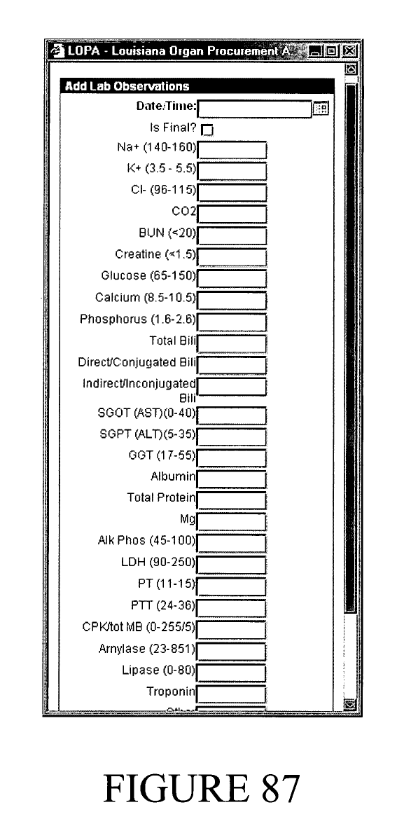

FIG. 88 shows how a culture results, recorded at 24-hour, 48-hour and final, may also be added.

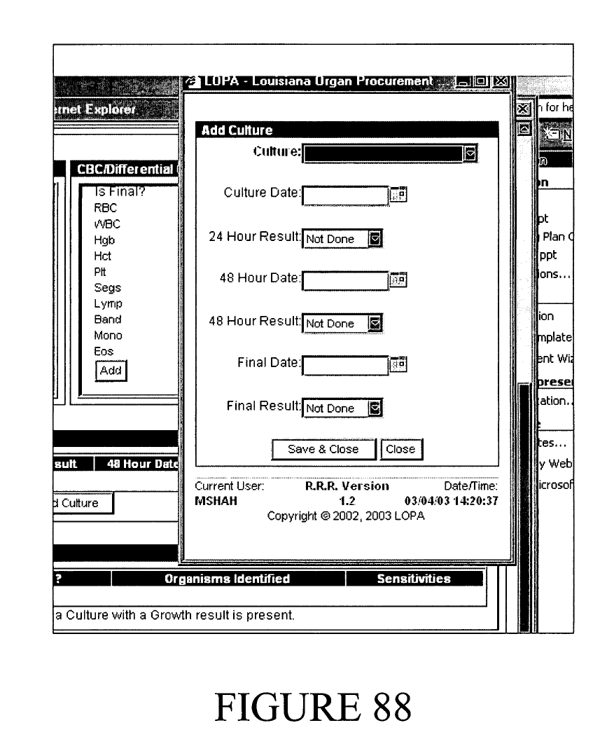

FIG. 89 shows how medications may also be added.

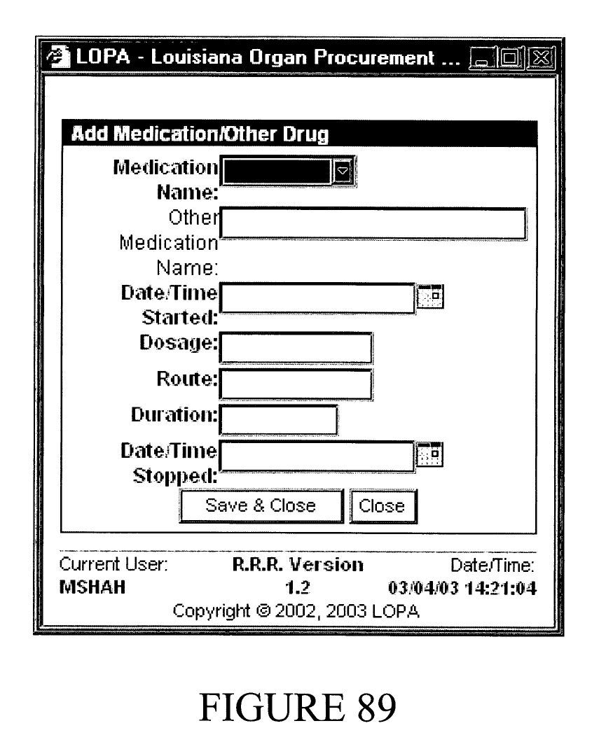

FIG. 90 shows how serologies and intake/output records are added.

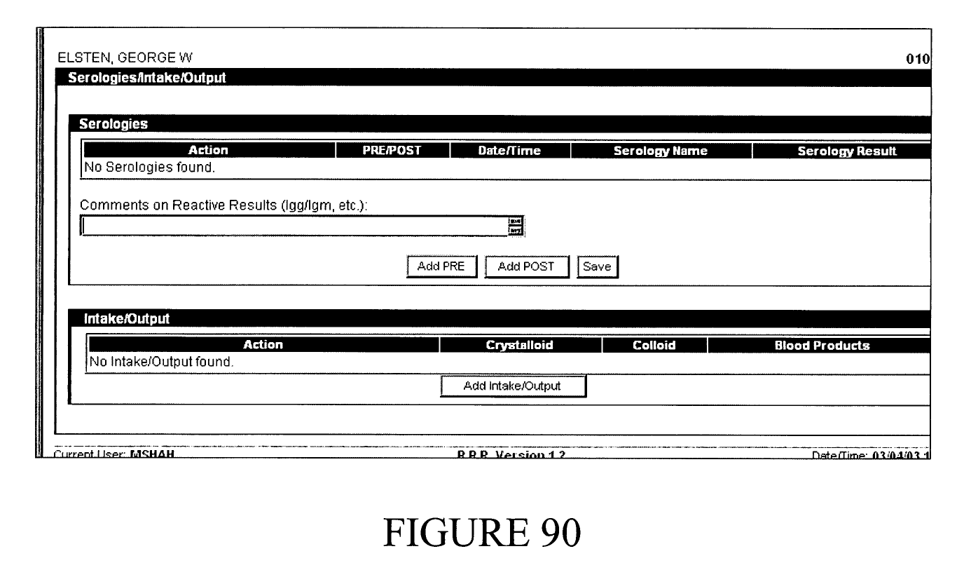

FIG. 91 shows that additional serology information may be entered.

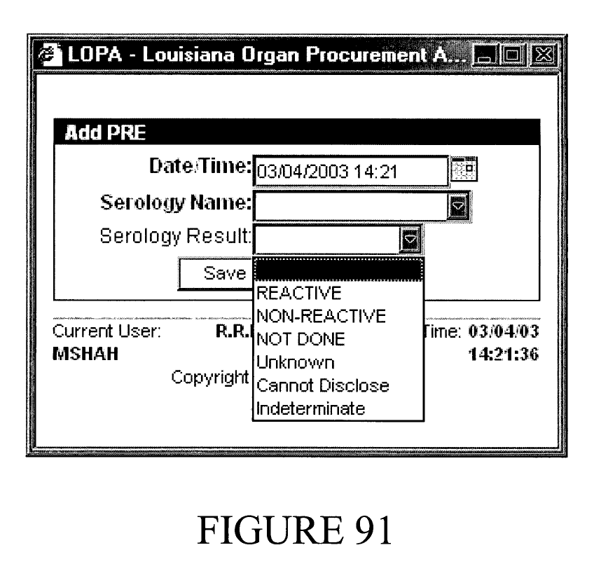

FIG. 92 depicts the page in which cardiac information is entered under the “Organs” menu tab.

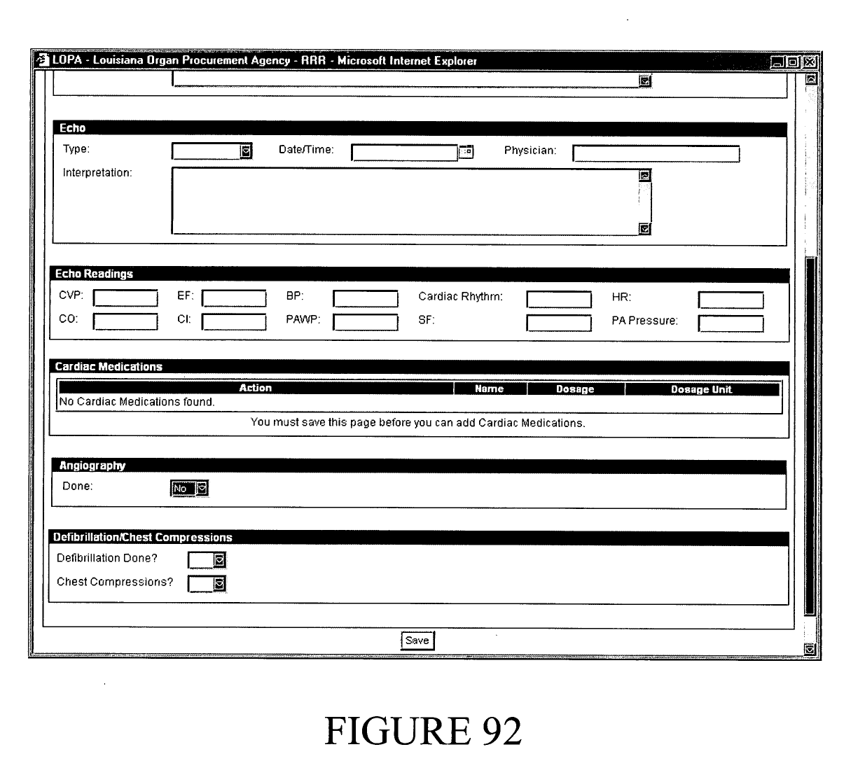

FIG. 93 depicts an example of how the necessary fields (date, physician, and interpretation) only appear when required, such as when the user confirms that an angiography was done.

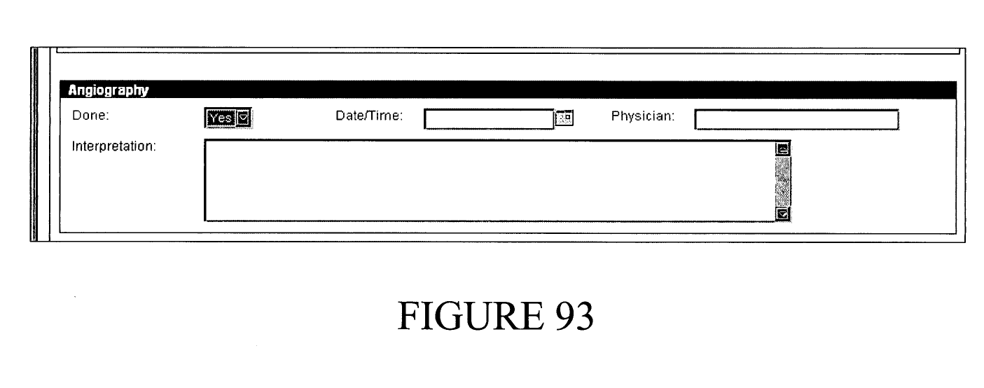

FIG. 94 provides for additional pulmonary information to be entered.

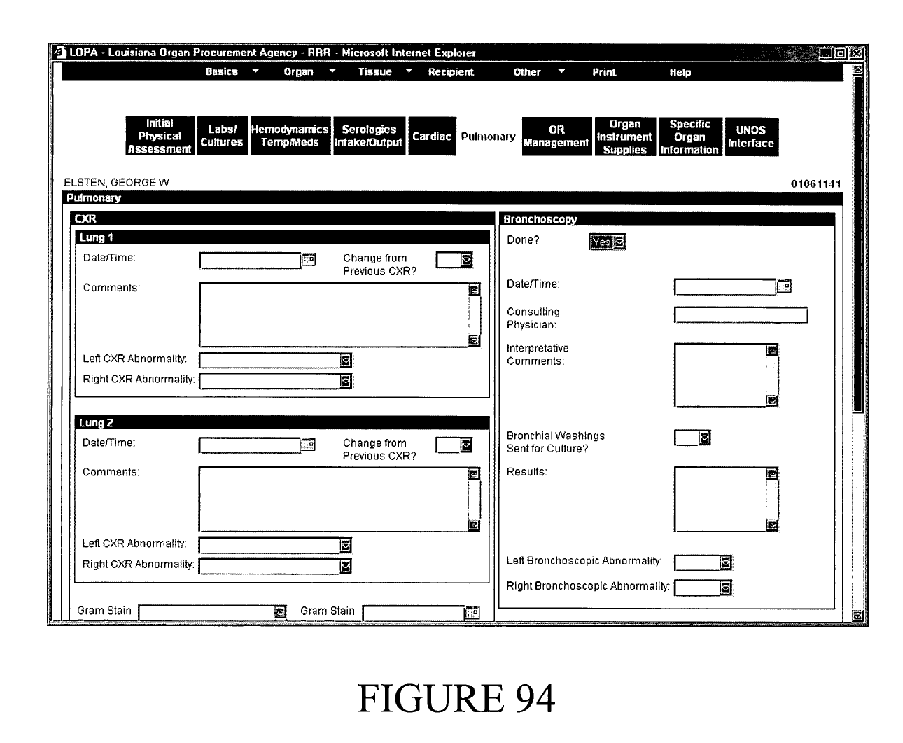

FIG. 95 shows how blood gases are also maintainable by the user

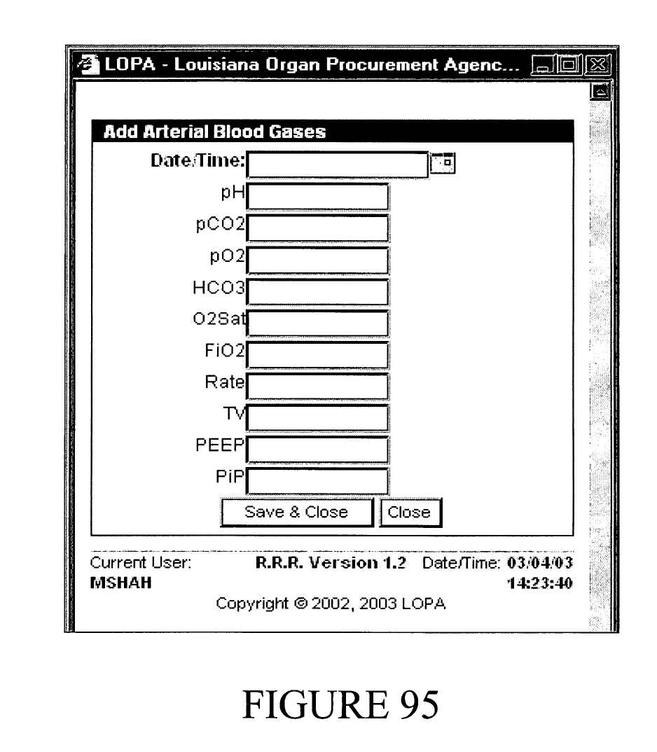

FIG. 96 depicts the operating room (OR) management page which allows entry of a wide range of information on the donor's time in the OR, including intraoperative medications, staff, times, and blood products.

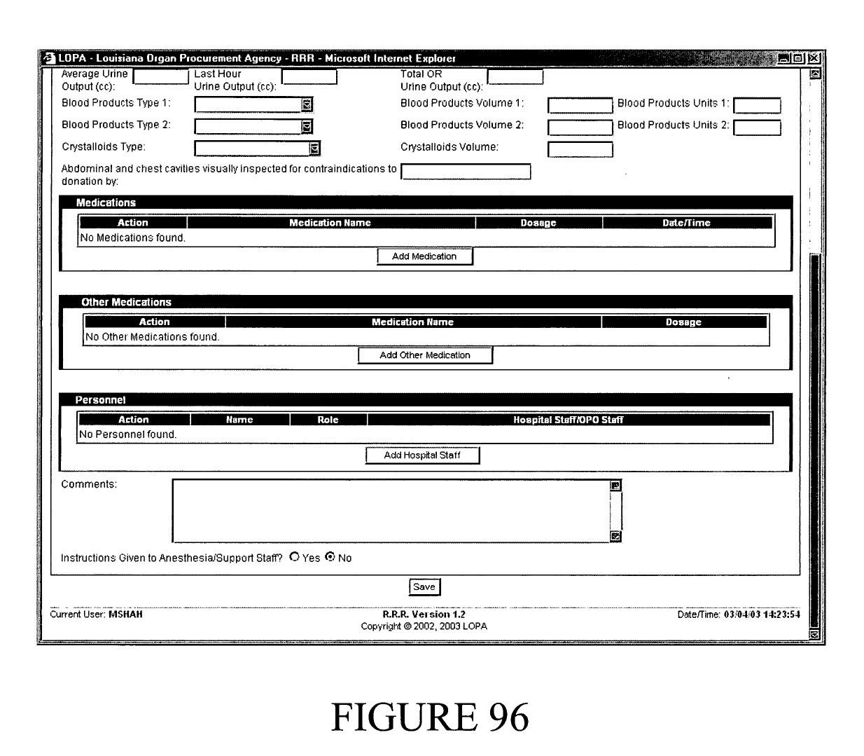

FIG. 97 provides another example of how the fields are cross-validated for quality assurance.

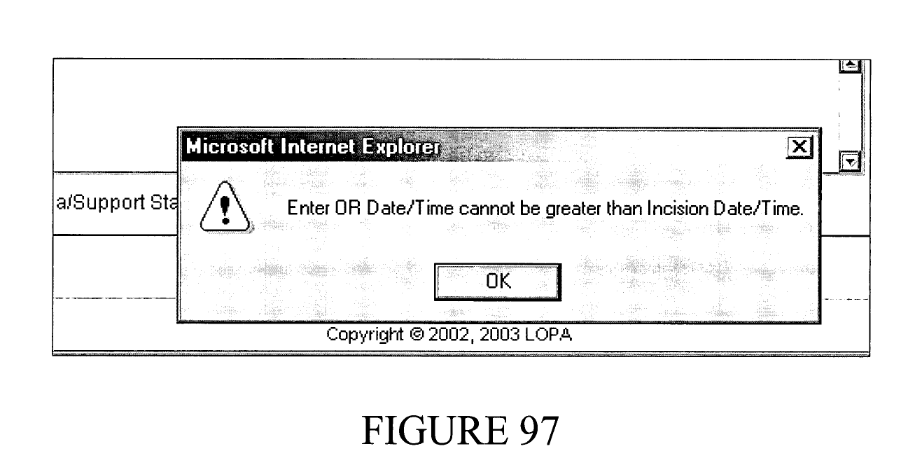

FIG. 98 shows an entry screen which allows the user to enter any medications used during the removal of the organs.

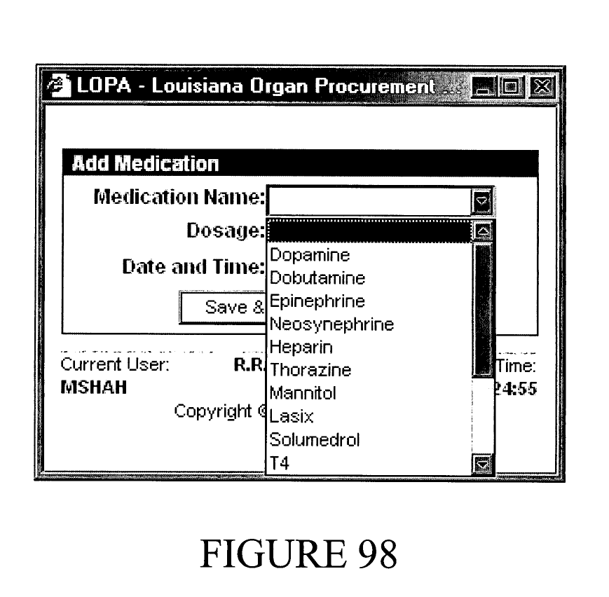

FIG. 99 shows an entry screen which allows the user to enter any instruments or other supplies used during the removal of the organs.

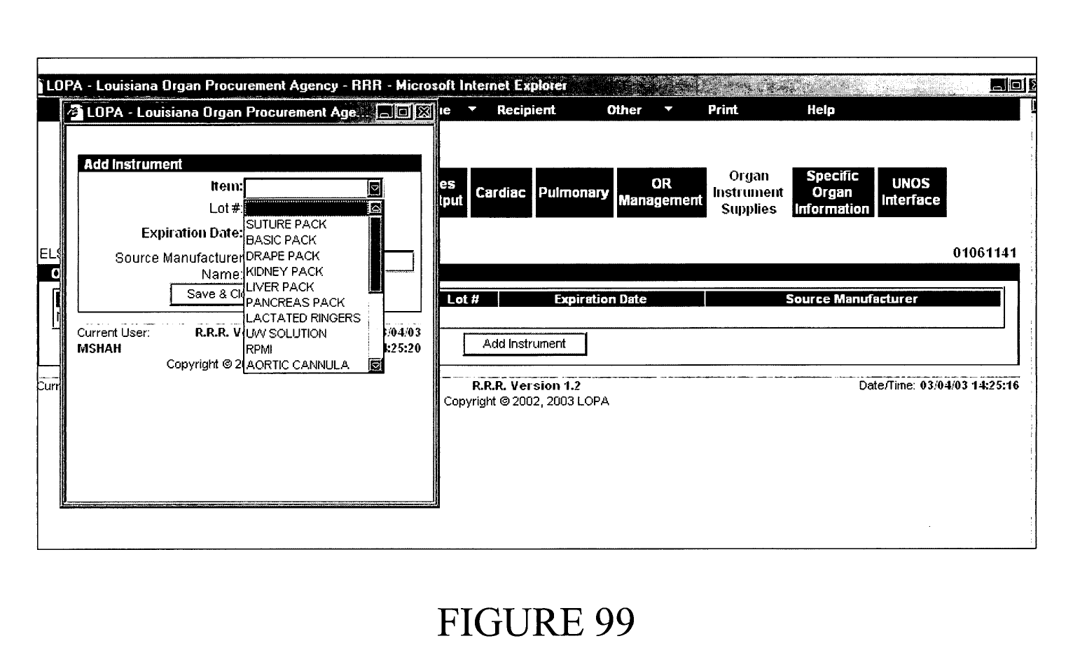

FIG. 100 illustrates an entry screen where information on other organs which have not been entered into the system is stored for a referral, thus avoiding the risk of duplications.

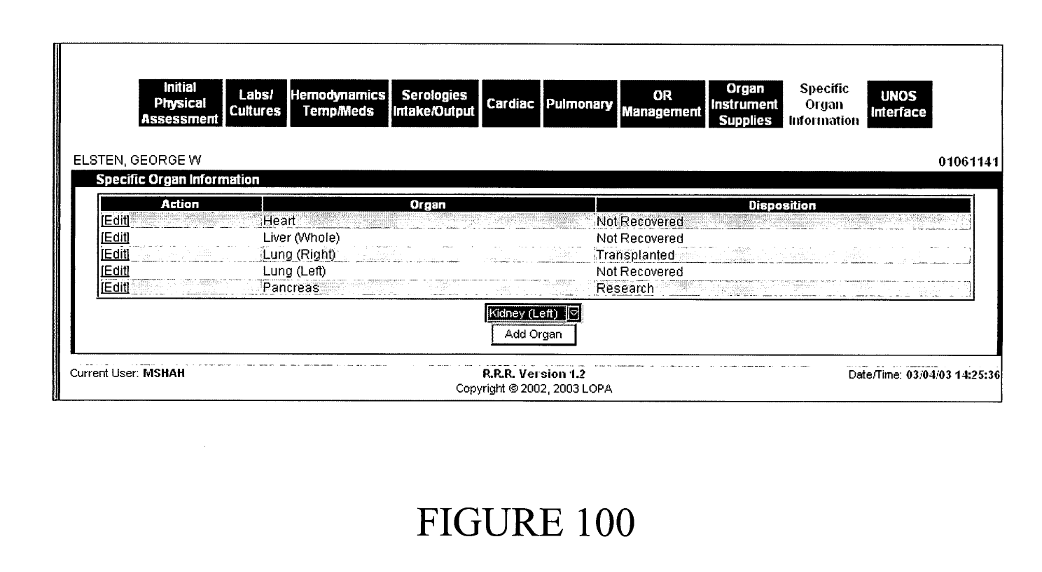

FIG. 101 provides an example of how information fields are displayed based upon organ disposition selected from a drop-down list, e.g. if organ is not recovered, detailed fields are not displayed.

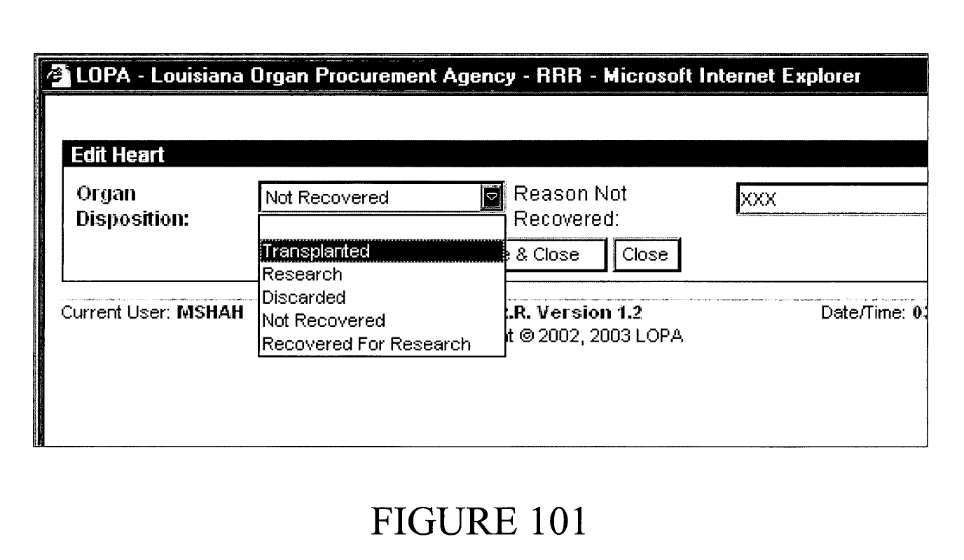

FIG. 102 provides a further example of how information is displayed based upon organ disposition, e.g. if organ is recovered, other fields are available for entry which are specific to its disposition.

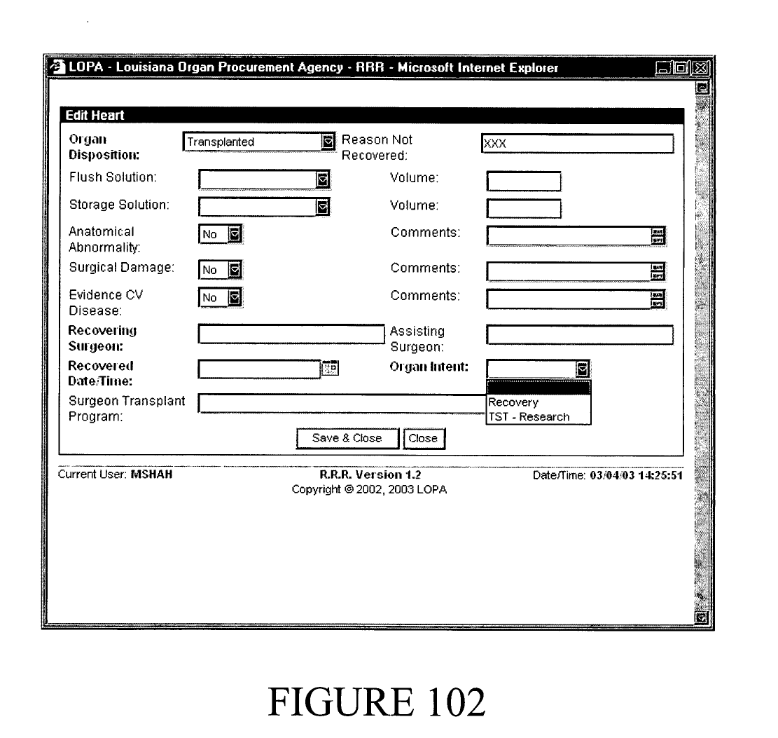

FIG. 103 is an example of the liver screen which supports split livers, as well as fields which are displayed or hidden based upon organ disposition.

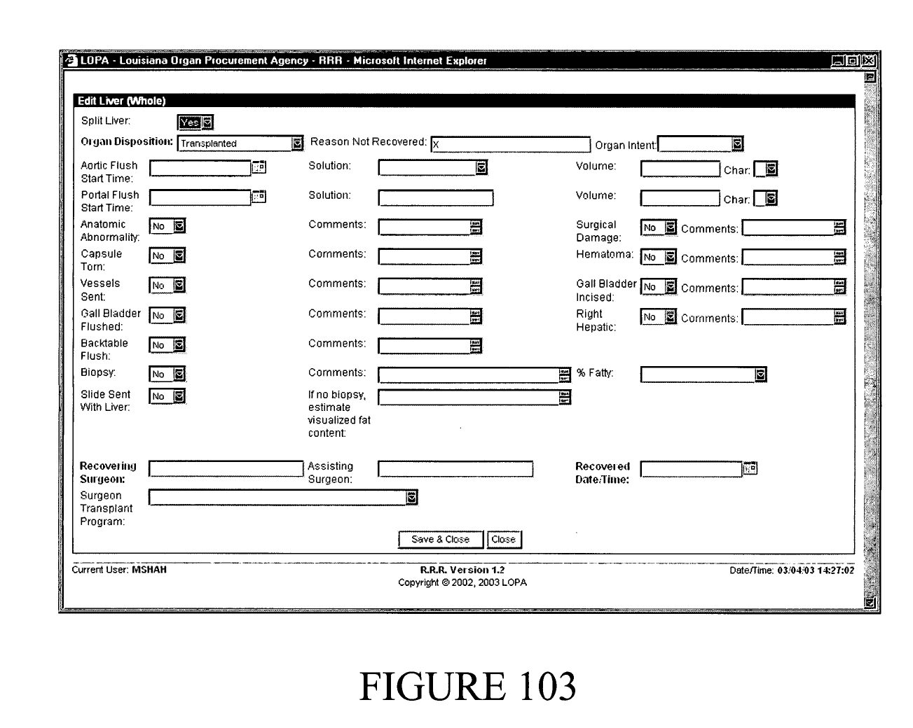

FIG. 104 illustrates an e-mail interface through which users can email text and links to a user for viewing controlled referral information remotely over the Internet.

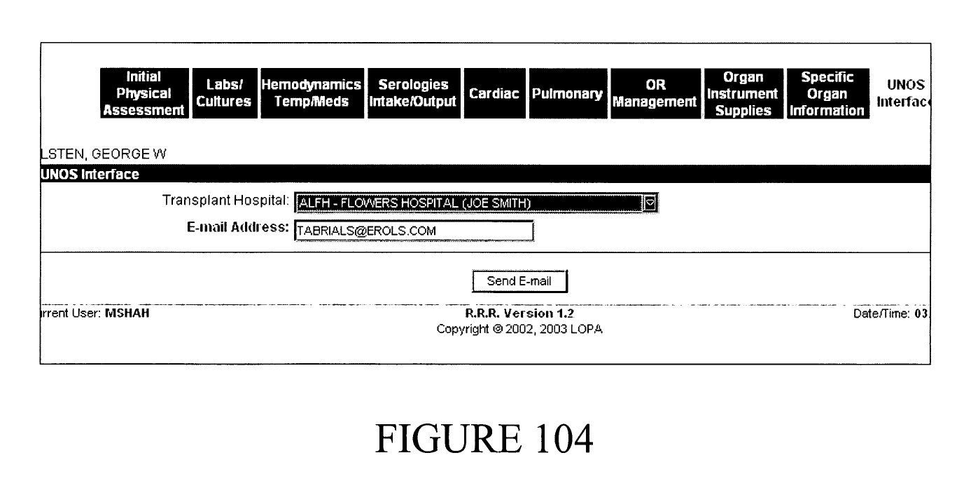

FIG. 105 depicts the main tissue page containing the basic tissue information.

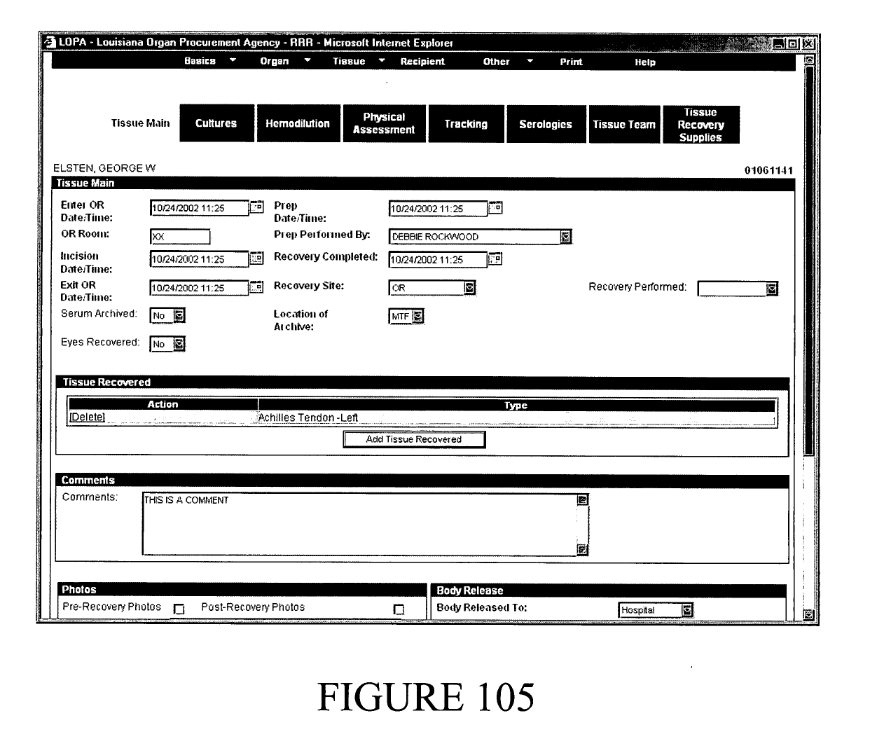

FIG. 106 shows a drop-down list of tissues which may have been recovered, which determines the fields displayed on subsequent screens.

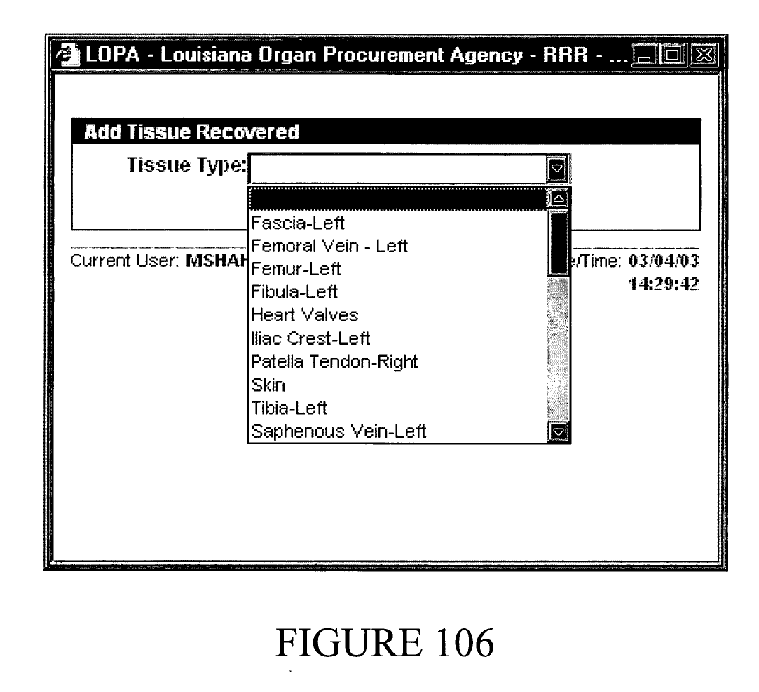

FIG. 107 shows a tissue screen which allows entry of any tissue cultures taken.

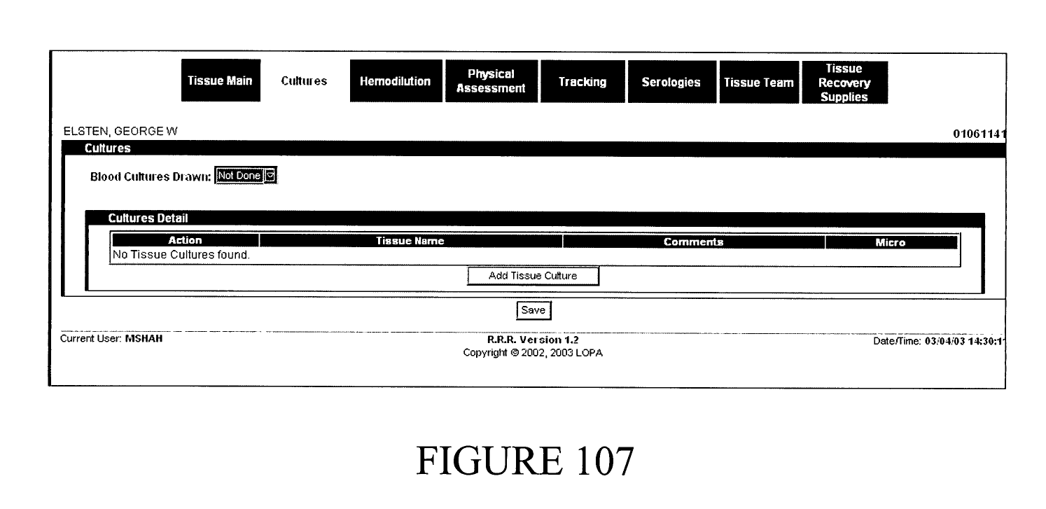

FIG. 108 shows an entry screen allowing tissue cultures to be added for a recovered tissue.

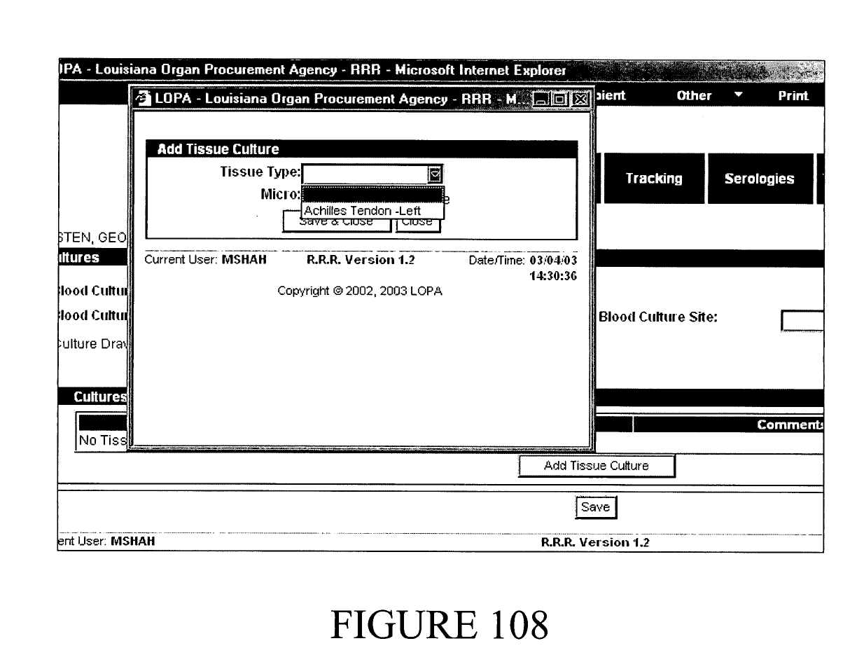

FIG. 109 depicts the tissue hemodilution page which allows the user to enter tissue processor-specific blood information.

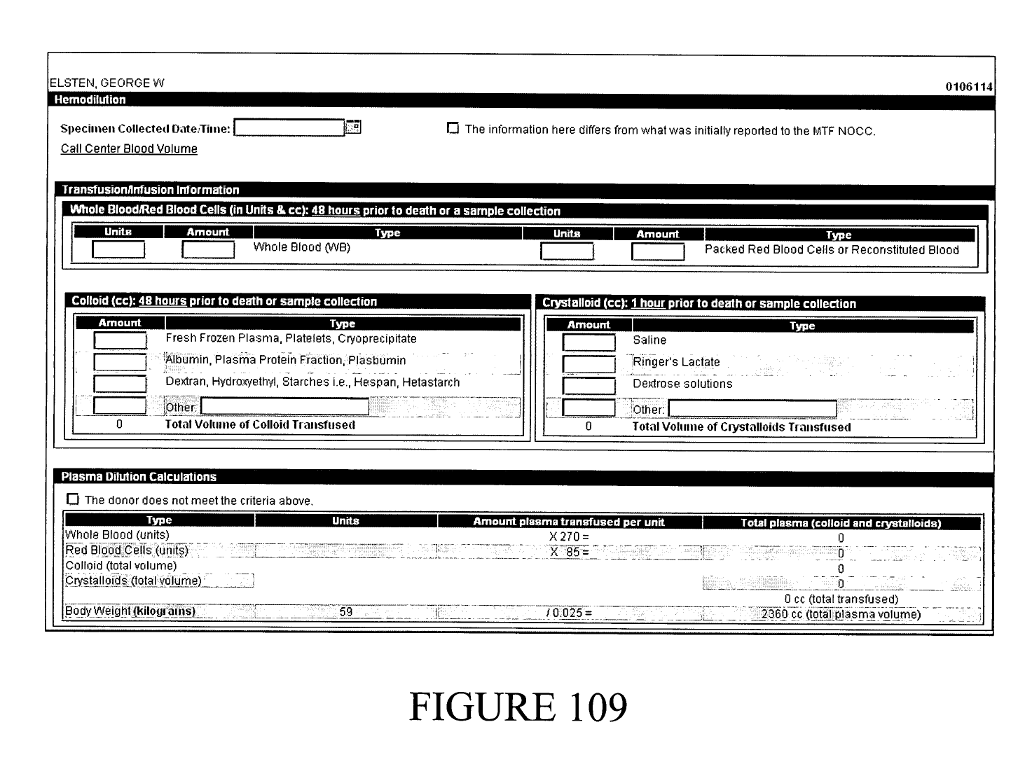

FIG. 110 depicts the ability of the system to accept detailed information about the physical assessment of the donor providing the recovered tissue.

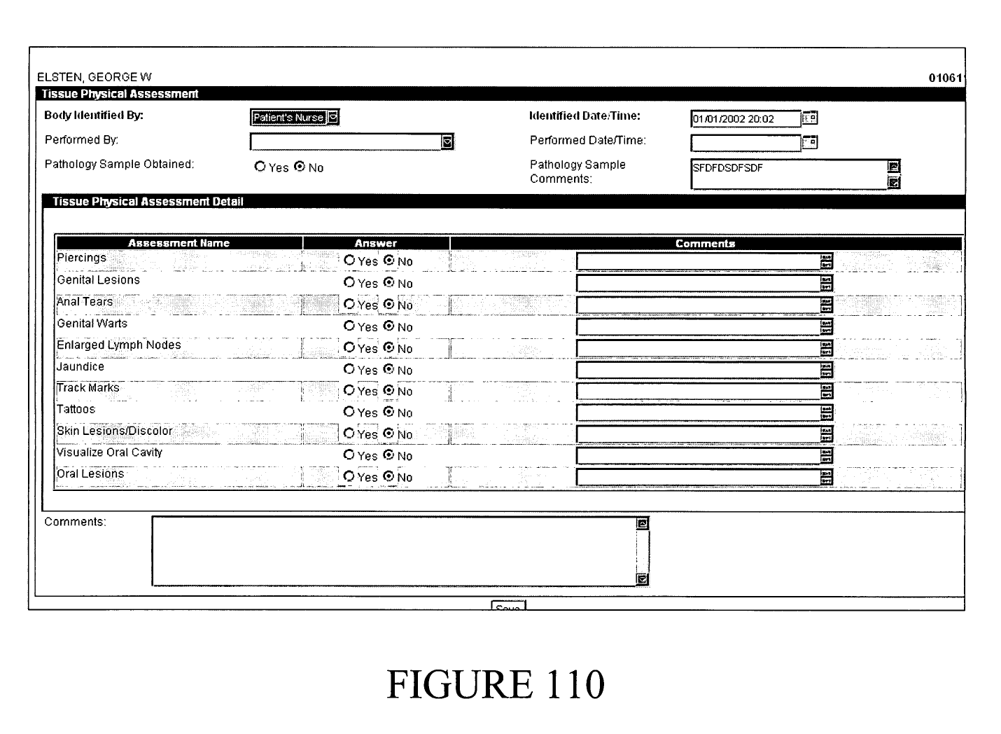

FIG. 111 shows the tissue tracking page which allows the user to enter shipment information, recovery information, and error information.

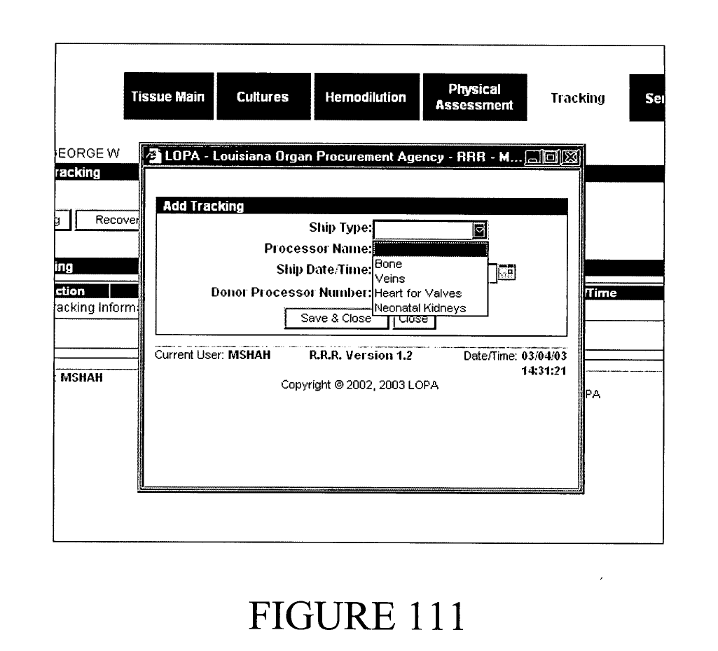

FIG. 112 illustrates the serologies screen for tracking blood draws.

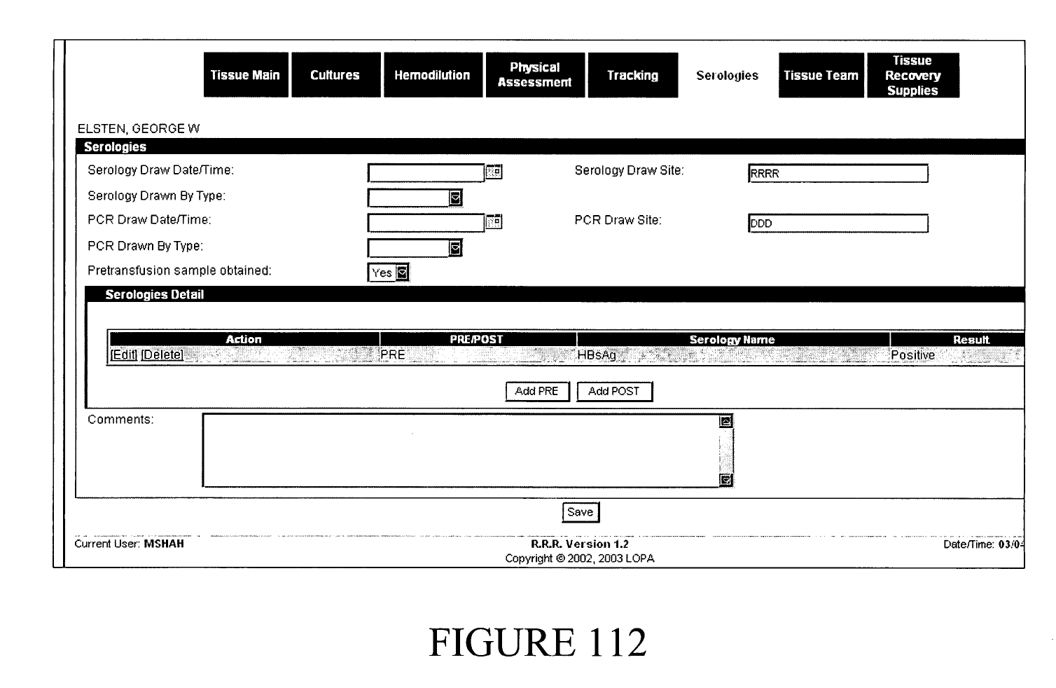

FIG. 113 shows the tissue team page which allows the user to record who was involved in the tissue recovery.

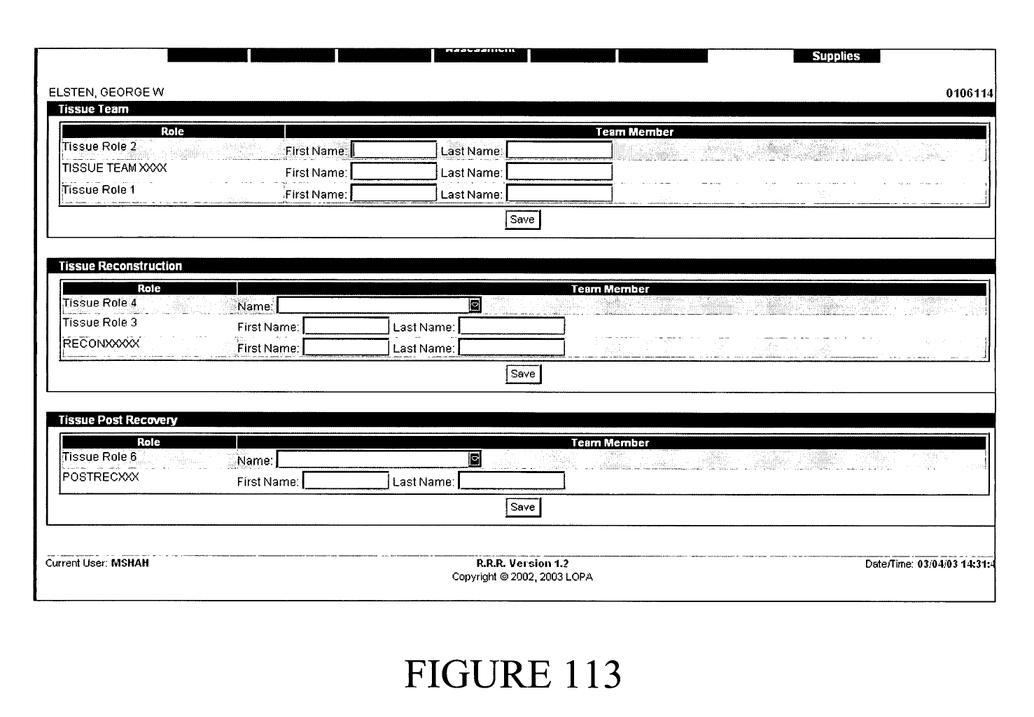

FIG. 114 shows a data entry screen for allowing input of various supplies used during the tissue recovery process.

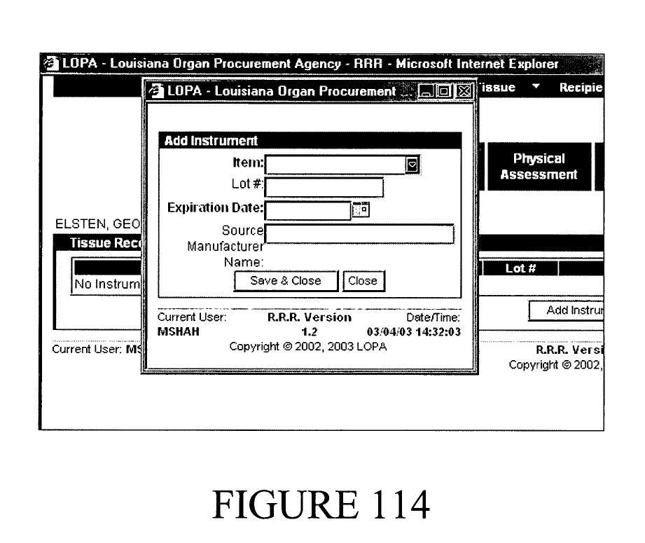

FIG. 115 depicts how the system includes a recipient area where recipients may be associated with a particular referral.

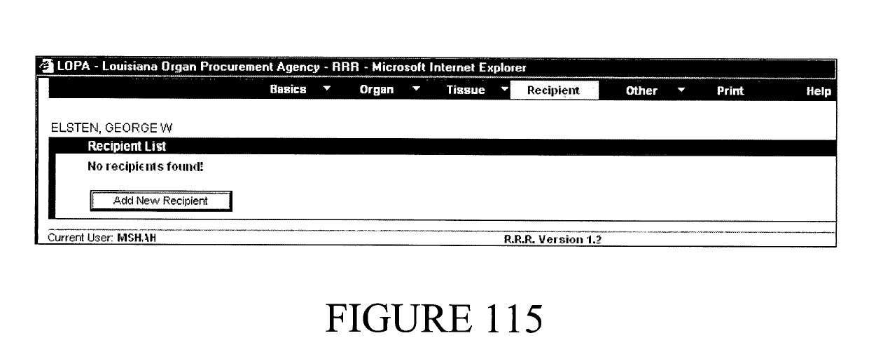

FIG. 116 shows how basic information may be entered about the recipient.

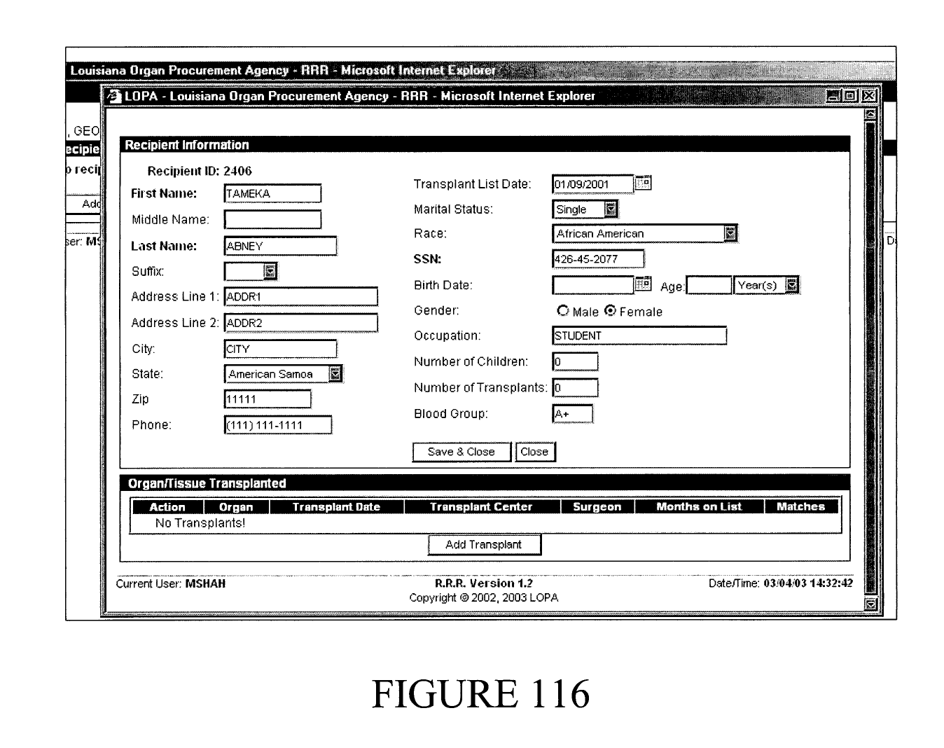

FIG. 117 illustrates how users can data about specific organs transplanted for a recipient.

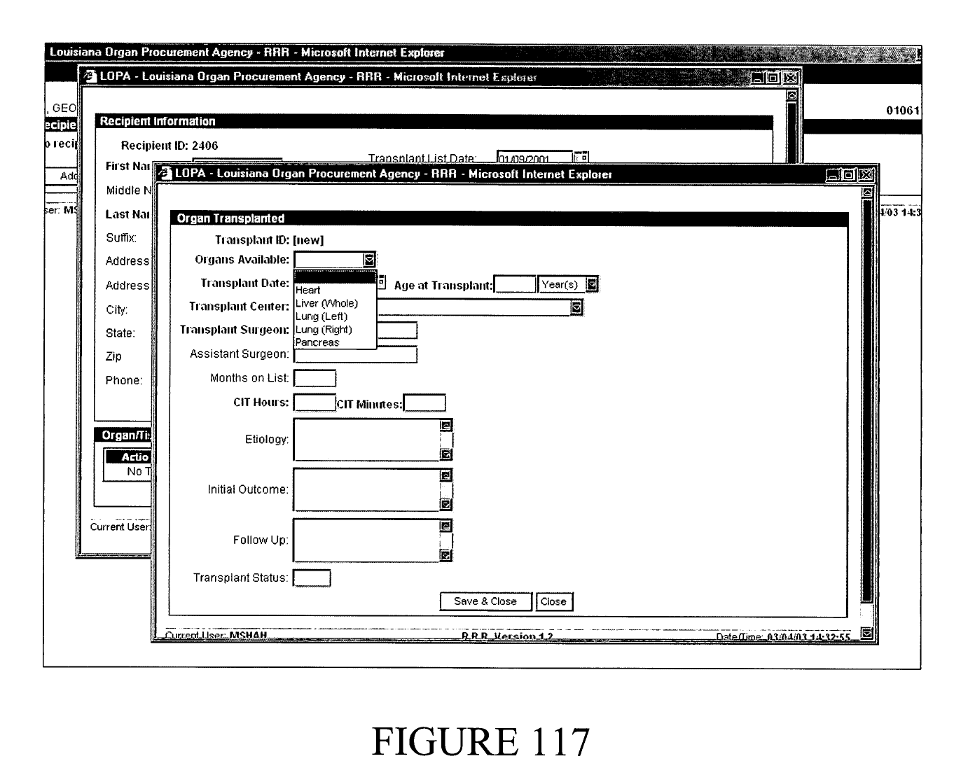

FIG. 118 shows a screen which allows family services personnel to track and enter correspondence sent to others regarding a referral.

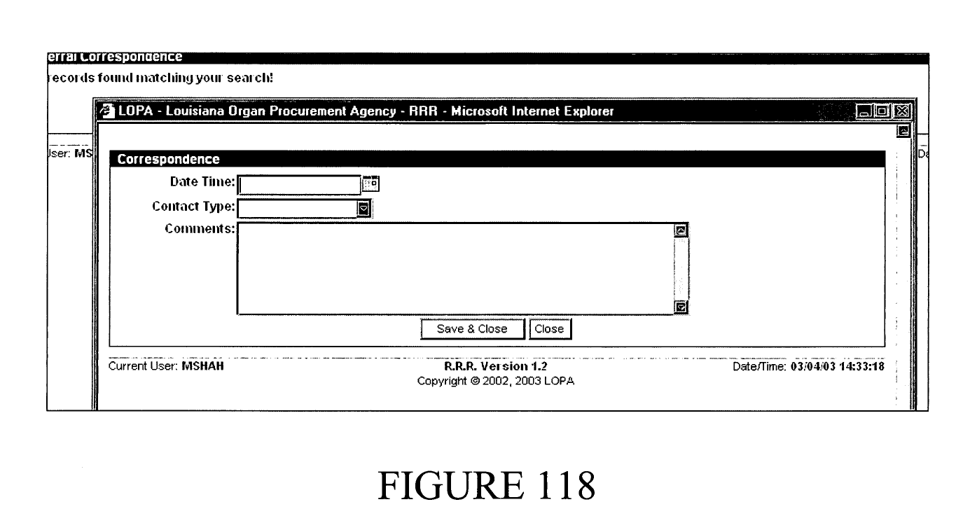

FIG. 119 depicts the manner in which binary attachments may be added to information about a referral, such as a digital photographs, a facsimile document, a word processing document, a spreadsheet, and the like.

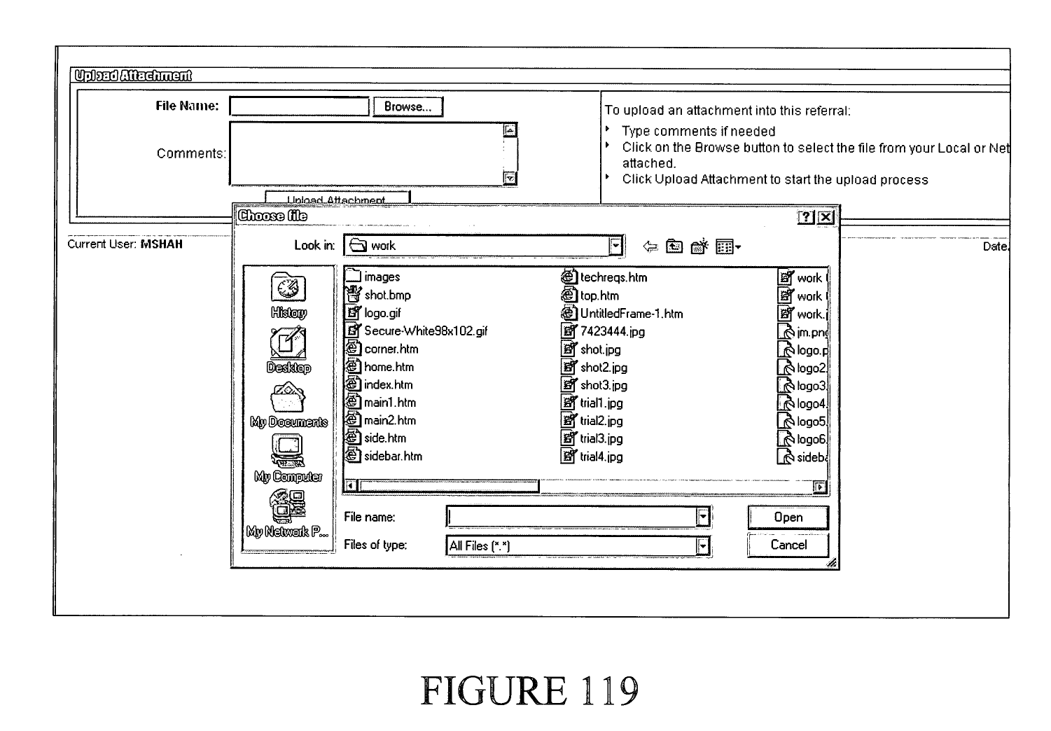

FIG. 120 shows the manner in which authorized users can lock a referral and render it read-only to others.

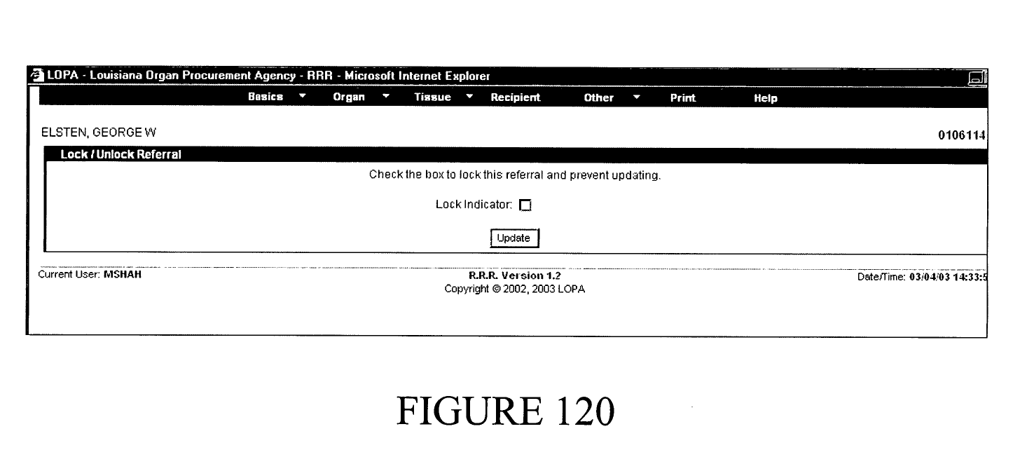

FIG. 121 shows how authorized users may delete a referral.

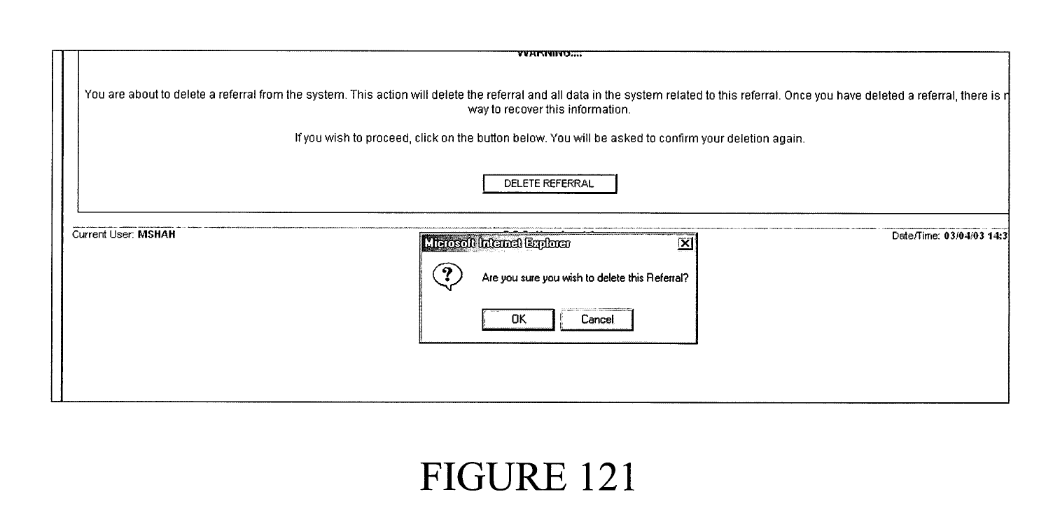

FIG. 122 depicts how audit data is stored in the system for a referral which allows authorized persons to see how information was added or changed.

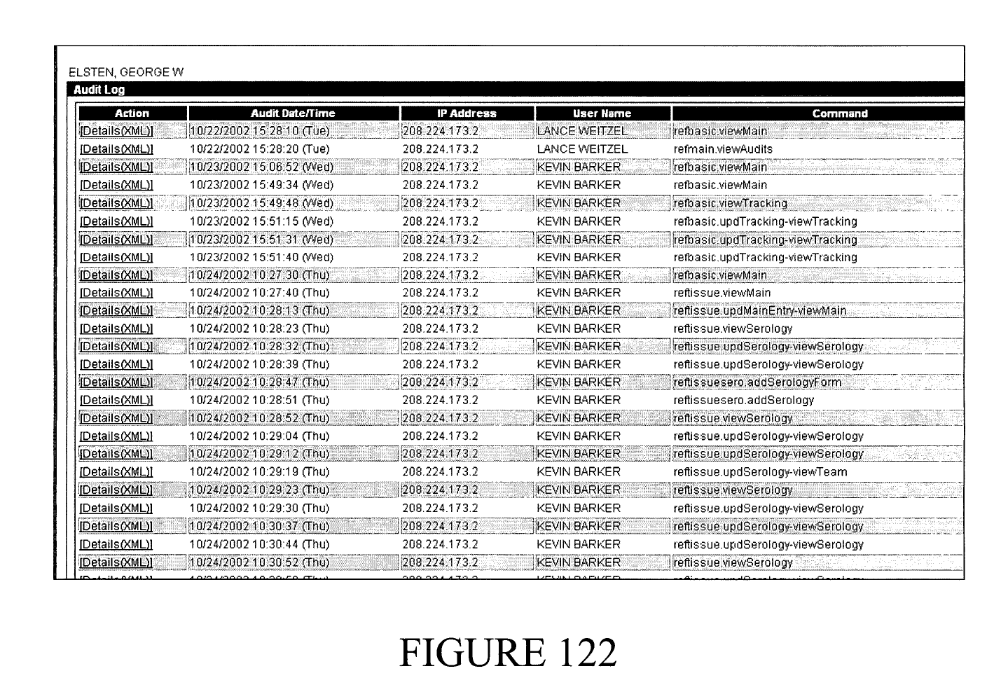

FIG. 123 shows that the audit trail data can be stored in a standard, flexible storage language, such as XML.

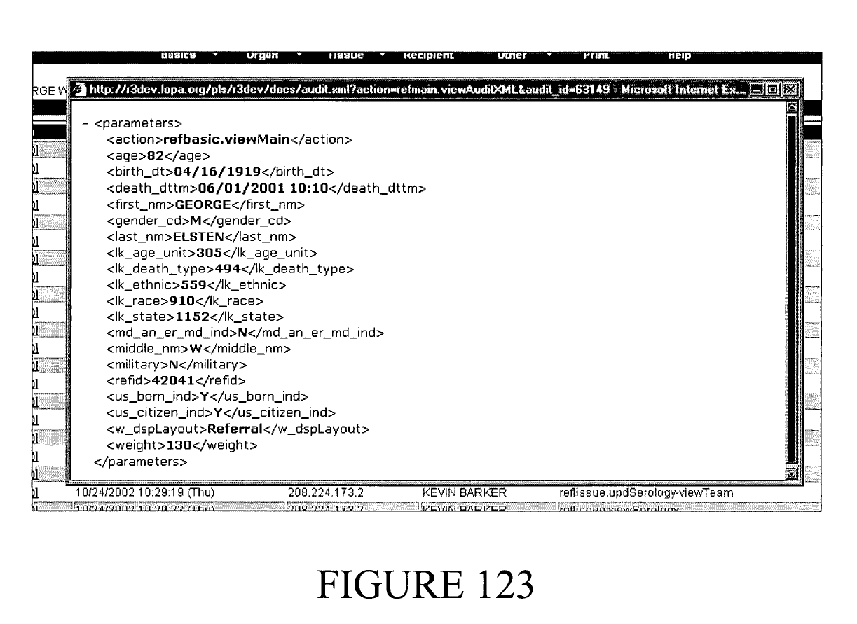

FIG. 124 shows how a number of standard letters may be generated by an OPO to persons related to the referral, including the ability to merge clinical data from the system.

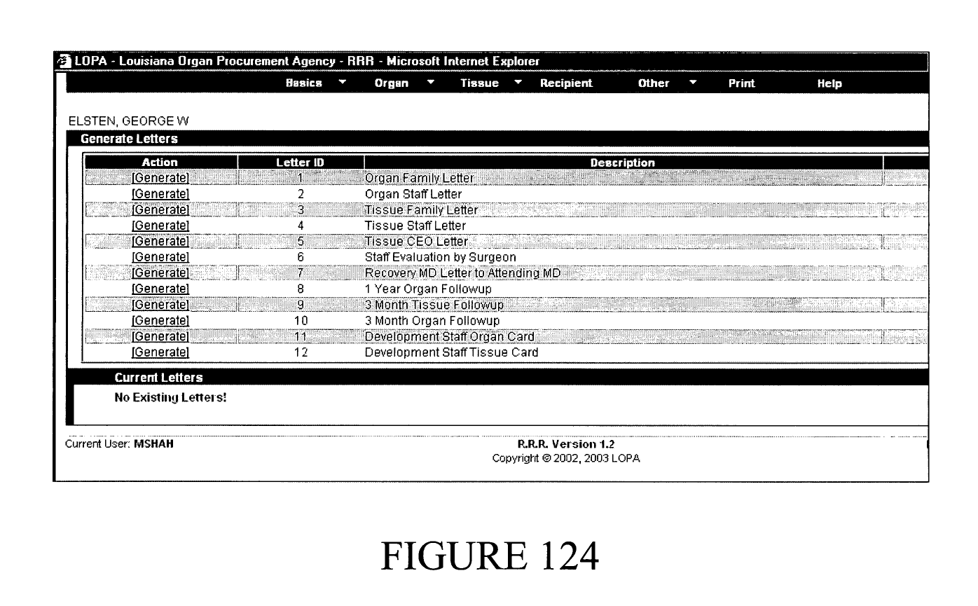

FIG. 125 provides an example of a standard letter to the family of a tissue donor, which can be edited and saved in common word processing formats.

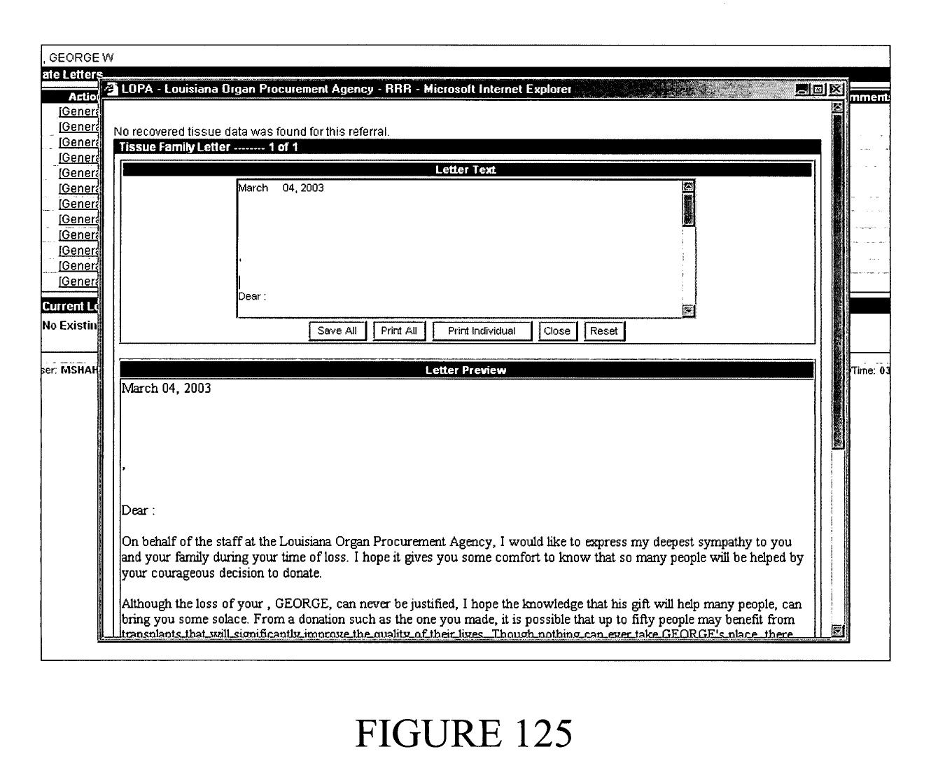

FIG. 126 shows how the system tracks letters generated and sent to various persons.

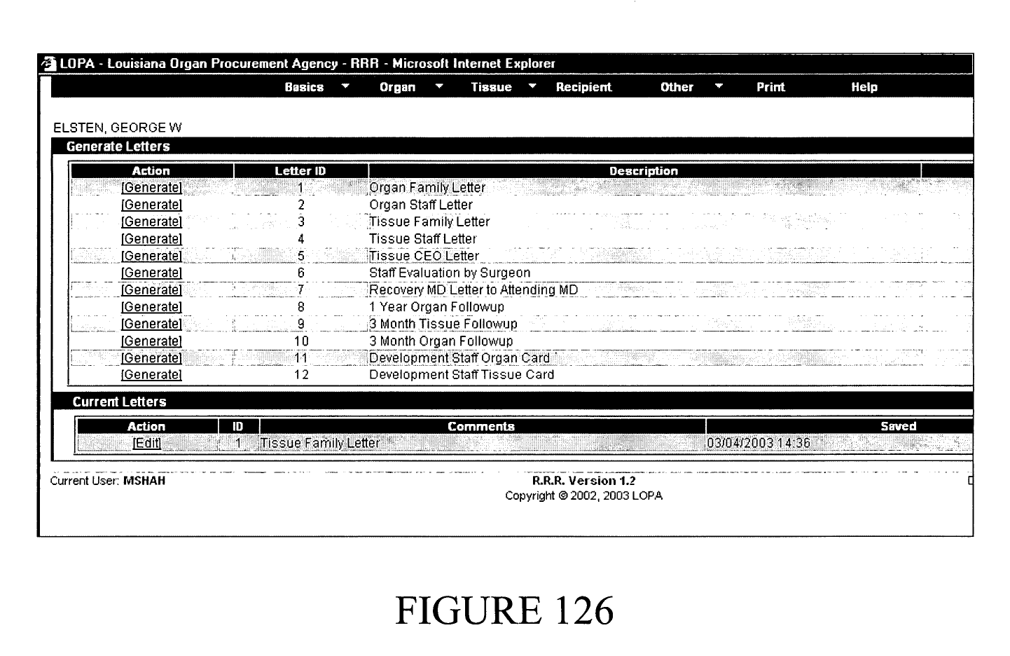

FIG. 127 depicts a screen used by the system to search potential donors from a database combining OMV records and records from the donor registry.

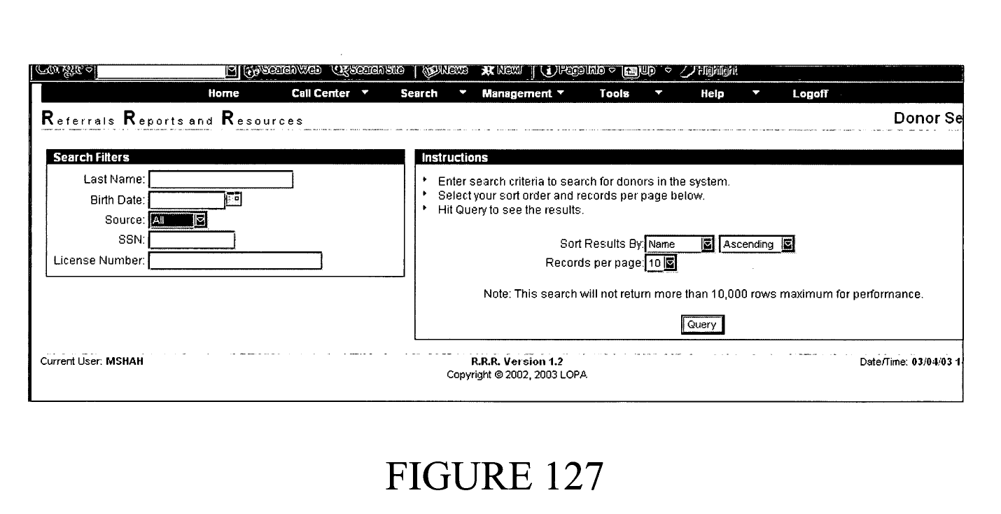

FIG. 128 shows a screen in which registry records can be updated.

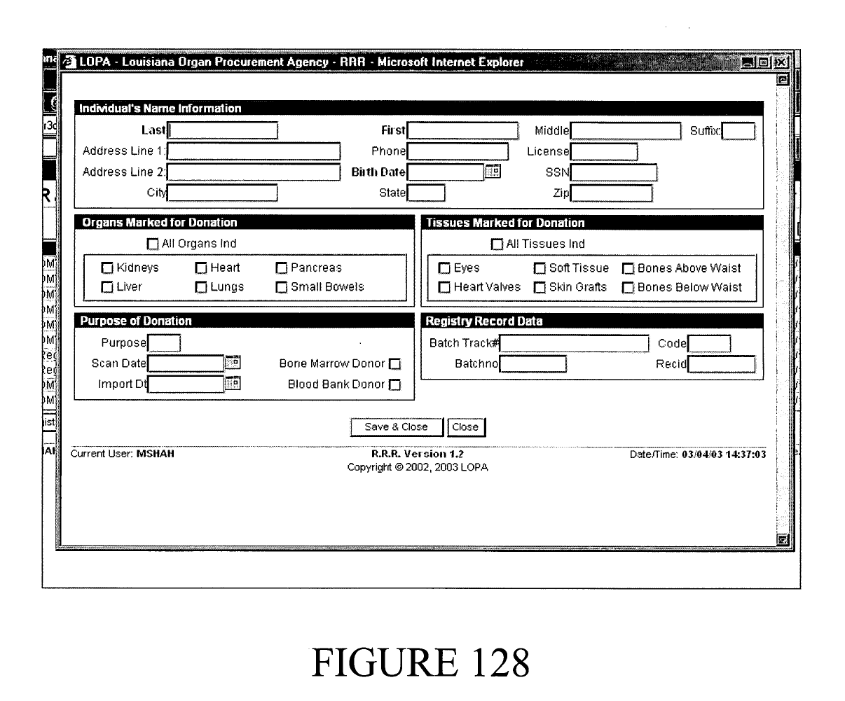

### DETAILED DESCRIPTION OF THE PREFERRED EMBODIMENTS

A preferred embodiment of the invention will be described in the form of an automated software- and hardware-based system for managing the operations of an organ procurement organization (OPO). As the OPO-management areas within the system may be broadly categorized as referrals, reports, and resources, the system may be referred in shorthand form herein as an “R3 system.” In the present invention, the R3 system generally comprises the following components and feature groups: (a) call center, (b) referral, recipient, and donor medical records management, (c) management modules for system security, staff, hospitals, accounting and development, (d) donor registry and OMV interface, (e) audit trails, (f) a UNOS interface, and (g) a reporting module.

The R3 system is designed to provide an OPO with data entry and data tracking features to track all referrals, potential donors, and actual donors within the area of responsibility of the particular OPO. In the R3 system described herein, the call center allows an operator to take basic referral information and enter any data needed to facilitate an organ or tissue donation. Call center also includes the entry of screening criteria, basic hemodilution information, consent data, and medical/social information. The referral feature set provides the means for entry of all of the clinical data for a referral or prospective donor, as well as all clinical information pertaining to an organ donor or a tissue donor. From the referral portion of the R3 system, recipient information can also be entered and maintained, as well as the tracking information related to those persons. The management portion of the R3 system allows only certain authorized users to maintain various system objects including security, users, organizations, hospitals, and lookups for a wide range of information fields.

The architecture, security, and features of the R3 system are designed to meet the individial requirements of most OPO's, including additional requirements of the Food and Drug Administration (FDA) concerning electronic records and signatures at 21 CFR Part 11. Likewise, the R3 system should permit OPO's and authorized users to remain compliant with statutes and regulations under the recent Health Insurance Privacy and Portability Act (HIPAA), Public Law 104-191, and 45 CFR 160, et seq.

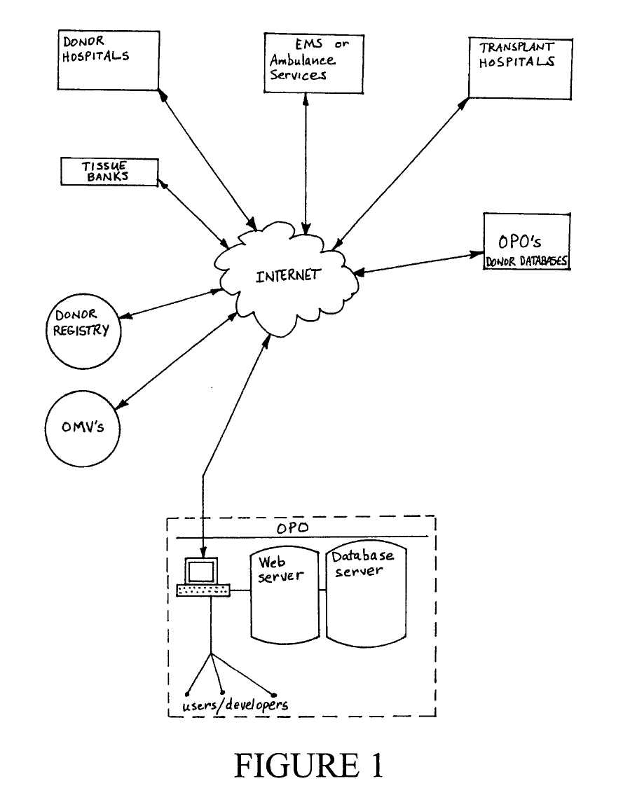

With respect to overall architecture, as illustrated generally in FIG. 1, the R3 system is an Oracle-based web application. There are two components that are central to operation of the R3 system: a web server, and a relational database management system (RDBMS or simply “database”) server. These servers reside within the control of the particular OPO, although such servers are not required to be physically present at the OPO offices.

The web server acts as a conduit between the outside world and the database. In addition to the web server software, all of the static data (e.g., graphics and reports) are stored on this server, as well as the software which manages all of the network connections. This server can also act as an application server if need be, for other applications.

The database server is generally run from a separate and more powerful computer than the web server, as most of the R3 system operations occur within the database server. The Oracle database engine and management software, as well as all of the R3 system data, are stored on this server. An optional backup database server can also used with the R3 system which may function as a standby database and web server, in the event that the primary database server fails. If the primary web or database server is no longer available, R3 system operations would not be affected, because switching to the standby database could be made automatic. If the backup server approach is used, Oracle utilities may be used to make sure the backup database is constantly updated with the same transactions being posted to the primary database (known as a “hot standby” backup). For small OPOs, a single combined web server and database server can be used, although the size of the database and required processing power may result in less desirable results.

Using current technology and based on Oracle hardware requirements, and by way of example only, the web server should be at least a Pentium III, 1.0 GHz machine, with 512 MB of memory, and at least 5 gigabytes of hard disk space, spread over two separate hard drives. RAID 0 technology is recommended to mirror the drives in order to provide redundancy and protection against a single disk drive failure. The database server should be powered at least by a Pentium III, 1.5 GHz machine, with a minimum of 512 MB of memory (1 gigabyte of memory is recommended). Adding additional processors to the system is also recommended for larger OPOs (more than 50 simultaneous office and field users). The database server should have at least 50 gigabytes of hard disk space, spread over three drives, utilizing RAID 5 technology for performance and protection from data loss. The optional backup server should be of a similar configuration as the database server.

In a preferred embodiment, the R3 system may comprise an Oracle database platform which is entirely Web-based, and written in PL/SQL, HTML, Crystal, and Java, thus permitting a wide variety of developers to maintain and upgrade the system through any JavaScript-enabled browser on commonly available Intel-based (or similarly compatible) computers. The JavaScript features are advantageously employed to enable at least two key types of features, namely real-time input validation on forms within the system and the top menu navigation dynamics.

Through the computers controlled by the OPO, the R3 system is able to communicate with other remote computers which are similarly compatible over a wide-area global communication network such as the Internet. Such computers may be similar to or identical to the types described for the web and database servers, although the processing power of those servers is not strictly required. As such, any computer capable of accessing the Internet may communicate with the R3 system, if authorized by acceptable user identification and password. No client software or other local software is required to communicate with the R3 system other than a suitably configured Internet web browser.

Access to the R3 system, including the ability to manage records, change configurations, and perform other OPO-related tasks is controlled by the permission schemes and security protocols determined entirely by the particular OPO. With regard to security, the R3 system requires communication over Secure Socket Layer (SSL) encryption technology over each client browser. User ID's and passwords are stored at the database level and are encrpyted using the RDBMS' internal encryption scheme. Application-level security is maintained in tables and are accessible to the administrator of the R3 system through the management module of the system.

Turning now to the figures, FIG. 1 depicts an overall schematic view of the primary participants within the organ/tissue recovery and transplant process and which interact with the present invention.

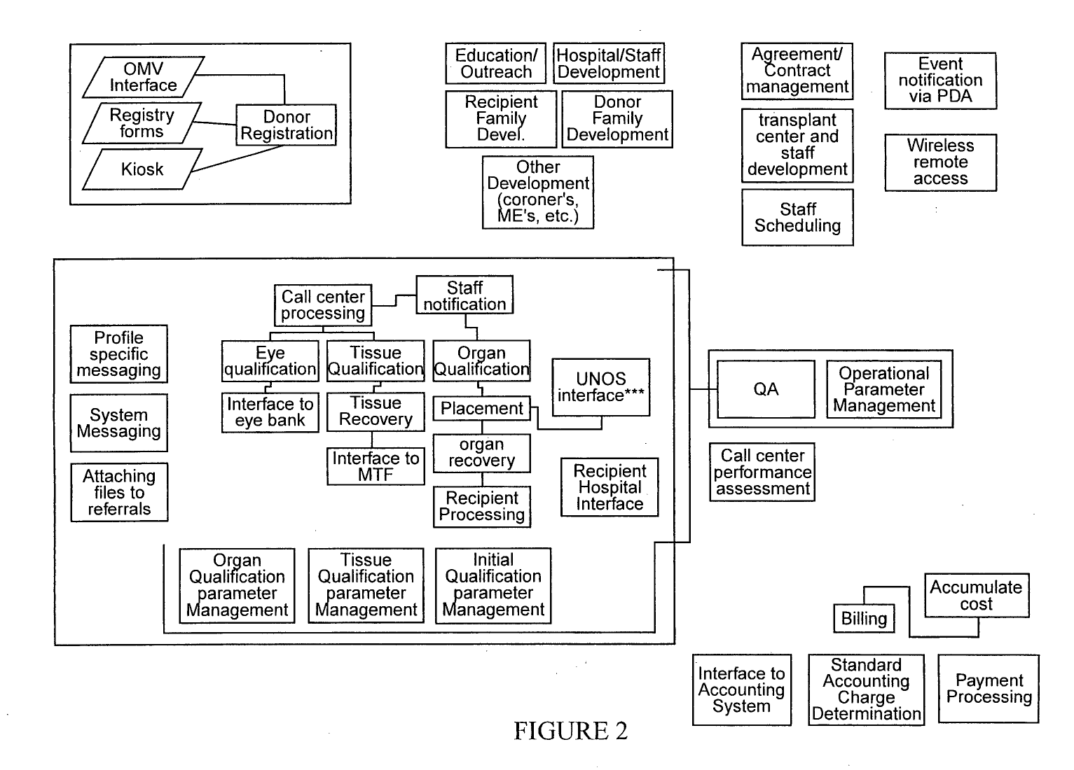

FIG. 2 illustrates the multiple pathways for collecting donor registration, as well as a summary layout of the primary components of a preferred embodiment of the present invention.

Import of OMV and Registry Data

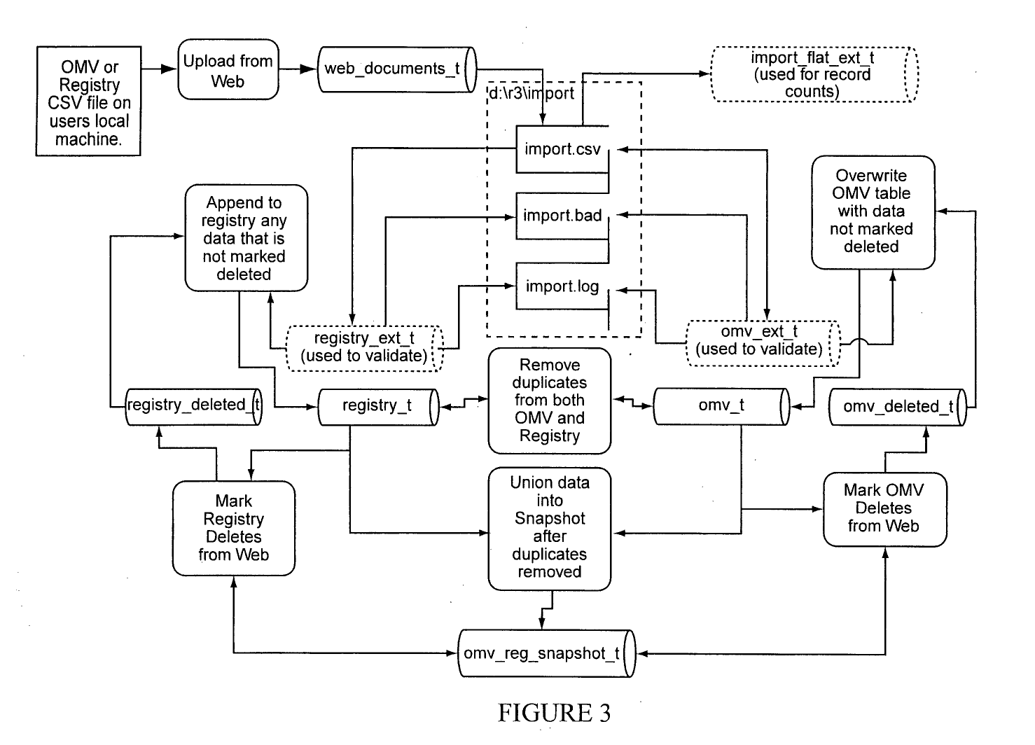

FIG. 3 depicts an exemplary import process for importing external data into the R3 system, particularly the OMV records and the donor registry. Preferably, the R3 system includes two tables which are populated from external sources: Office of Motor Vehicles (OMV) and the donor registry (the “Registry”). The import functionality should allow a user to load such data automatically or manually on an as needed basis. The data files from OMV and the donor registry are in CSV (Comma Separated Value) format and contain a specific field format for each corresponding feed. Using the R3 web-based interface, authorized users can upload these CSV files using the management console.

In the preferred embodiment, the Oracle document gateway is used to allow the uploading of the CSV import files through the OMV and Registry web pages. File uploads are automatically stored in a table web_documents_t by the PL/SQL web gateway. This data is stored in BLOB format to be later handled by the R3 system. To allow the reading of the CSV files after they have been uploaded to the database and written to the file system, Oracle 9i external tables are used, which allows SQL operations to be performed on the CSV files which are linked to tables.

As shown in FIG. 3, several database tables are utilized to support the import process from start to finish. Below is a list of the tables involved and their use in the preferred embodiment:

| Table | Description |
|---|---|
| web_documents_t | This table is used by the Oracle Web Gateway to store file |
| | uploads. The CSV file uploaded by the user is stored here in |
| | BLOB format. |
| import_flat_ext_t | External table with one large varchar2 column. Used to do a |
| | record count on the import.csv file in the system. |
| Import_export_t | This table actually stores the CSV files uploaded, the current |
| | status of the existing import, and all related log files and record |
| | counts from the import process. |
| Registry_ext_t | External table attached to the import.csv file. The columns are |
| | matched to the registry CSV layout. |
| Registry_deleted_t | A record of all deleted registry records. Data is moved here from |
| | the registry tables when a user deletes a registry record from the |
| | Web. |
| Registry_t | The actual registry table after import. |
| omv_ext_t | External table attached to the import.csv file. The columns are |
| | matched to the OMV CSV layout. |
| omv_deleted_t | A record of all deleted OMV records. Data is moved here from |
| | the OMV tables when a user deletes an OMV record from the |
| | Web. |
| omv_t | The actual OMV table after import. |
| omv_reg_snapshot_t | A union of the registry and OMV data after it has been imported. |
| | This table is rebuilt after an import is performed. |

The process of importing CSV data from the web site and converting into Oracle tables contains several steps outlined below. Although there are several steps described below, these are processes which occur mostly in the background. The user sees only two major steps from the Web interface of the R3 system: (a) the upload process which includes Upload, Count, and Validate (as described below), and (b) the import process which includes Import, Duplicate Processing and Snapshot Update (as described below). The process is presented this way to the user so that the user may decide after Count and Validation if they want to proceed with the import. If the user decides not to proceed, he can delete the file just uploaded before the import process, thus leaving the current OMV and Registry data in the R3 system unchanged.

In the Upload process, the user is uploading the CSV file to the Oracle database. Using standard HTML file upload, the user selects the CSV file and type from his local machine and sends the data to the database server. The Oracle gateway automatically places this uploaded file into the web_documents_t table in a BLOB format. From there, this data is moved to the import_export_t table and an import process is started. The uploaded file is then copied to the database file system with a particular path and name consistent with the database directory structure, such as “r3\import\import.csv.” This is the directory and filename which is used by all the external tables defined for the import process. The external tables link to this file for use in the next steps.

In the Count process, a simple select count(*) from import_flat_ext_t table is performed. This table contains one large varchar2(4000) so it can count the number of records in the import.csv file.

In the Validate process, depending on the type of file that was uploaded and saved to the import.csv file, either the omv_ext_t (OMV) or registry_ext_t (Registry) table is selected. Although a select count(*) is performed, a basic format validation is also performed, because the format of the external table has all the matching columns in the import.csv file which it is reading. The process of doing a “select” from these external tables also will cause an import.log and import.bad file to be generated. These two files are then attached to the import_Export_t record currently being used. This will allow the user to view these files from the management console to see what records have failed the validation and decide if they wish to proceed with the import process.

The Import process is slightly different depending on the type of file (OMV or Registry) being imported. Each one is described below:

Registry (KEY FIELD=recid)

The registry data is imported to the registry_t table and always appended. Data from the registry_ext_t external table is inserted into the existing registry_t table. Since data is received incrementally, the existing data should never be overwritten. To ensure that updates in the R3 system take precedence, the insert will exclude both items marked as deleted in R3 and items that already exist in the registry_t table so that they will not be overwritten. Thus, once a registry record (key=recid) is brought into the R3 system, it cannot be updated through the Import process, and it must be changed via the web interface as described later.

OMV (KEY FIELD=license)

The OMV data is imported into the omv_t table and overwritten. Since OMV files are always full extracts, the omv_t table is deleted and replaced by the data from the import. Because users can mark OMV records deleted in the R3 system, the Import process will skip records that exist in the omv_deleted_t table when performing this process.

In the Duplicate Processing step, duplicates are removed from both the Registry and OMV tables after an import has been done. This must be done before the merging of data in the last steps. Since these edits cross both tables, it is performed regardless of which file was imported. The Registry data takes precedence over OMV data in most cases which is evidenced by the processes below. The duplicate processes performed are: (1) remove OMV Social Security Numbers (SSN's) that are in the Registry; (2) remove OMV License numbers that are in the Registry; (3) remove Last Name, First Name, Date of Birth OMV records that are in the Registry; (4) delete duplicate license numbers in the OMV and keep the most recent updated license number; and (5) delete duplicate SSN numbers in the OMV and keep the most recent updated SSN.

In the Update Snapshot process, a UNION ALL is performed which combines the omv_t and registry_t into a table called omv_reg_snapshot_t. This is the table which is used for processing in the R3 system for queries and updates. The SQL for the creation of this table also performs some validating and reformatting using SQL functions to ensure that the data combined from these two tables results in the same format for common columns such as name, phone, city, state, etc.

Drop-Down Selections

Through the R3 system, Lookup Tables are used primarily to populate drop-down selection lists as are shown in many of the figures. The tables define the option values and descriptions for a select list. The following description of the manner in which the R3 system uses Lookup Tables is not exhaustive, but rather an example which can be employed by persons of ordinary skill as the particular application requires.

Lookup Tables are defined by two database tables: LOOKUP_TABLES_T and LOOKUP_VALUES_T. Multiple logical Lookup Tables are defined in LOOKUP_TABLES_T. LOOKUP_TABLES_T defines the name of the Lookup Table and its description. LOOKUP_VALUES_T will have one-to-many entries for each table defined by LOOKUP_TABLES_T. Each entry contains the option value (LK_VAL_ID) and description (LK_VAL1_DESCRIPTION). In LOOKUP_VALUES_T, all occurrences of LK_VAL_ID are unique. LK_VAL_ID is typically used to populate database columns that correspond to the Lookup Table.

Lookup Tables are used by WEB_FIELD_EDITS_T to create database-driven select lists. To create a database-driven select list, WEB_FIELD_EDITS_T should be populated as follows:

| Column | Value |
|---|---|
| LK_TABLE | LOOKUP_VALUES_T |
| LK_VALUE | LK_VAL_ID |
| LK_DESCRIPTION | LK_VAL1_DESCRIPTION |
| LK_FILTER | LK_FILTER will be used to populate the |
| | WHERE clause that the application builds to |
| | select records from LOOKUP_VALUES_T. |
| | Typically, LK_FILTER should specify only |
| | active records from a given logical Lookup |
| | Table, as shown in the example for Suffix |
| | taken from WEB_FIELD_EDITS_T below: |
| | lk_name = ‘LK_SUFFIX’ and lk_status = ‘A’ |
| | Also, in R3, there is a requirement to display in |
| | select lists inactive Lookup Table entries that |
| | have been previously selected and stored in the |
| | database. The example below modifies the |
| | first example to satisfy this requirement: |
| | lk_name = ‘LK_SUFFIX' and (lk_status = ‘A’ |
| | or lk_val_id = #lk_suffix#) |
| LK_SORT | LK_SORT |

In some cases, R3 pages must perform processing based on specific select list items. When this is so, the pages look for items matching a given description. It is therefore critically important that the lookup descriptions entered by the user match what is expected by the R3 application for these specific select items. Below is a list of Lookup Tables for which certain R3 pages look for specific descriptions:

| Lookup Table Name | Lookup Description Value |
|---|---|
| Age Unit | Year |
| Agency (LOPA) | LOPA |
| Agency (MORA) | MORA |
| Body Part | Heart |
| Body Part | Intestine |
| Body Part | Kidney Left (or Left Kidney) |
| Body Part | Kidney Right (or Right Kidney) |
| Body Part | Liver Split 1 (or Split 1 Liver) |
| Body Part | Liver Split 2 (or Split 2 Liver) |
| Body Part | Liver Whole (or Whole Liver) |
| Body Part | Lung Left (or Left Lung) |
| Body Part | Lung Right (or Right Lung) |
| Body Part | Pancreas |
| Culture Result | Growth |
| Death Type | Asystole |
| Eye Outcome | Eye Referral |
| Eye Ruleout | Ruled Out |
| Eye Ruleout | Medical History |
| Observation Type | CBC |
| Observation Type | Lab |
| Observation Type | Urinalysis |
| OPO Type | Entry |
| Organ Disposition | Not Recovered |
| Organ Disposition | Transplanted |
| Organ Outcome | Organ Referral |
| Role | Hospital Staff |
| Role | Organ Referral Coordinator |
| Role | Referral Contact |
| Role | Tissue Referral Coordinator |
| State (LOPA) | Louisiana |
| State (MORA) | Mississippi |
| Tissue Age Ruleout | Female |
| Tissue Age Ruleout | Male |
| Tissue Outcome | Ruled Out |
| Tissue Outcome | Tissue Referral |
| Tissue Ruleout | Age |
| Tissue Ruleout | Medical History |
| Title | CEO |
| Title | President |

Other attributes may be optionally defined for each LOOKUP_VALUES_T entry. These attributes will not appear in the select list, but may be used as additional filtering criteria. To define additional attributes for a Lookup Table, a value must be entered for LK_VAL2_NAME and/or LK_VAL3_NAME in LOOKUP_TABLES_T. Then, WEB_FIELD_EDITS_T entries must be created that correspond to LK_VAL2_NAME and LK_VAL3_NAME, where TABLE_NAME equals the name of the Lookup Table as defined in LK_NAME of LOOKUP_TABLES_T, and FIELD_NAME equals the value defined in LK_VAL2_NAME or LK_VAL3_NAME of LOOKUP_TABLES_T. These WEB_FIELD_EDITS_T entries will usually define preloaded drop-down select lists (see below) that the user will be prompted to choose from when maintaining Lookup Tables using the management console.

Lookup Tables may be defined as preloaded tables, in which case they are not defined in either LOOKUP_TABLES_T or LOOKUP_VALUES_T. They are completely defined by their WEB_FIELD_EDITS_T entry. As such, they are not modifiable by a management console user. Typically, preloaded tables should be used only when they meet all of the following criteria: (a) the number of entries is small (for example, 5 or fewer), (b) values and descriptions are not subject to change, and (c) management console users do not require access for maintenance purposes.

Preloaded tables are defined by the PRELOAD_VAL and PRELOAD_DESC columns in WEB_FIELD_EDITS_T. PRELOAD_VAL should contain a comma-delimited list of items that will be used for the option values in the drop-down select list. PRELOAD_DESC should contain a comma-delimited list of descriptions that will correspond to each PRELOAD_VAL item. The LK* columns and PRELOAD* columns on WEB_FIELD_EDITS_T are mutually exclusive. If values for PRELOAD* columns are specified, then the Lookup Table will be treated as a preloaded table and any values specified for the LK* columns will be ignored.

Application Security

Access to the R3 system in the development, testing, and production environments is handled through the application itself. With respect to user management, an R3 system administrator establishes and maintains information about individual users. A user must be defined to the R3 system, and assigned a specific security profile, before the R3 system will allow access. Once established, users are permitted and required to change their passwords periodically. A system administrator may reset a user's password if required (and then the user must change it).

A system administrator also defines named security profiles, each of which defines two key application access characteristics: (1) the individual screens (web pages) that users assigned that security profile are allowed to see; and (2) what function (read-only; read and add only; read, add, and update; and read, add, update and delete) users can perform to the content of that individual screen. These security profiles are then assigned to individual users.

The individual user ID assigned determines the security profile, which is checked before entry into every screen of the R3 system. Users not permitted access to certain parts of the application simply see a screen with an “Access Denied” message. Users with restricted functionality (e.g., read-only) see the same screen, but the contents may be display-only without any add, update or delete buttons displayed. Users allowed to add or update, but not delete, see the same screens but without the delete functions.

Another important aspect of the R3 system security is in the means used to grant individuals at other institutions, e.g. eyebanks, hospitals, and transplant centers, access to basic and clinical donor and organ information for eye and organ suitability and organ matching for transplants as further described below.

For example, in the case of eyebanks, the R3 system is designed to limit certain users to show referrals related only to a particular eyebank. This is accomplished by a correlation with the organization with whom the user is affiliated. Thus, if the user is tied to an organization that has a specific eyebank affiliated with it (as defined under the Organization details panel in the management console), then when that user logs in, the R3 system will only show those referrals for their eyebank.

In the case of hospital and transplant center access, R3 permits read-only outside access to basic and clinical donor information to hospitals and transplant centers. An R3 system administrator, as part of setting up the hospital information, records the UNOS contact's name and email address. When an organ donor is in process, an OPO recovery coordinator uses a specific R3 screen to log into the Unet system to notify UNOS of the potential organ(s) availability and begin the placement process. The same screen also allows selection of a hospital or transplant center to whom the organ(s) will be offered. If a UNOS contact has been defined, that person's name and email address will be displayed and used, or a different email address can be entered. The R3 system generates an email to that recipient, which contains an R3 system login user ID and a password, and a link pointing to the R3 web site, but using a security key pointing to a single referral. The link, and its embedded security key, may be set to expire after a predetermined amount of time, e.g., 24 hours from the transmission of the email.

Auditing Functions

In support of HIPAA privacy and security requirements and FDA regulations regarding similar concerns, all of the actions that a user performs in the R3 system are logged. Storing activity-related information enables OPO management to track who is changing and viewing the data, and it permits the effective auditing of how data changed over the course of time. The WEB_AUDIT_TRAIL_T table contains all of the audit data in the system. Any web request made to the system is logged into this table.

By way of example, and not as a limitation, the WEB_AUDIT_TRAIL_T table within the has the following data elements

| | | |
|---|---|---|
| AUDIT_ID | NOT NULL | NUMBER |
| AUDIT_DATE_TIME | NOT NULL | DATE |
| IP_ADDRESS | NOT NULL | CHAR(15) |
| AUDIT_DATA | | OBJECT |
| USER_NM | | VARCHAR2 (15) |
| ACTION | | VARCHAR2 (50) |
| BROWSER | | VARCHAR2 (255) |
| CREATE_USER_ID | | VARCHAR2 (8) |
| CREATE_DTTM | | DATE |
| UPDATE_USER_ID | | VARCHAR2 (8) |
| UPDATE_DTTM | | DATE |

The following is an explanation of each field. AUDIT_ID is a sequential number that serves as the primary identified for the audit record. AUDIT_DATE_TIME is the date/time for the audit action being recorded. IP_ADDRESS is the IP address where the client request came from. AUDIT_DATA is an XML document which lists all the fields being sent to the server to record. USER_NM is the user name that has sent the request for the audit auction. ACTION is the “web action” that relates to the request. All the windows in the R3 system are related to a “web action” which describes what is being done on that screen. BROWSER is the type of browser reported by the browser that the user is using, which often includes operating system and version details as well. CREATE_USER_ID/CREATE_DTTM are the user ID that created the audit record and the date and time of creation, which will almost always be the same as the USER_NM and the AUDIT_DATE_TIME. UPDATE_USER_ID/UPDATE_DTTM is the user ID doing the updating as well as the date and time the update occurred.

All of the data submitted to the web is saved in an XML document. By storing it in XML, an auditor can compare and contrast similar fields, and provide indexing capabilities on certain data elements. Less preferably, if the audit data is stored as text, extracting data for audit reporting purposes is more difficult. Preferably, the database server software (such as that provided by Oracle) includes features to add database indexes to XML data types. The R3 system uses these “context indexes” to index the XML by referral ID, which is the most common view of the data within the R3 system.

A second method by which data within the R3 system is audited is through “triggers” provided through the Oracle environment. These triggers are placed on every table, in both a “create” trigger and “update” trigger. The “create” trigger automatically populates the CREATE_USER_ID and CREATE_DTTM data for each row, and the user inserting the data cannot override this without administrator access. Similarly, the UPDATE_USER_ID and UPDATE_DTTM data for each row is populated by the “update” trigger.

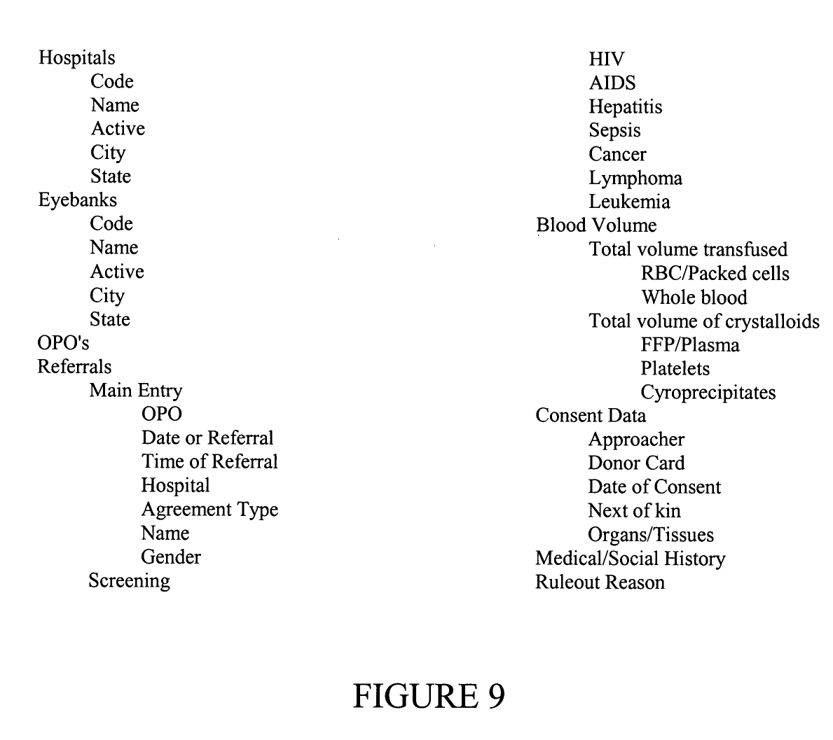

One example of a partial logical structure of the systems database is demonstrated in FIG. 9 which illustrates that each particular record of the database may have a number of fields, each of which fields may have a number of subfields. Preferably the database can be searched on at least any of the fields and any of the subfields of those fields. The single database structure in FIG. 9 is merely provided as a logical description of the database. In preferred embodiments the various subrelationships can be maintained as separate databases and access to some of those databases for privacy reasons may be limited to some users. Therefore, some users might be allowed to search based on a particular type of information field, as discussed elsewhere herein.

Considering that hospitals maintain diverse information retrieval methods and data structures the system for connecting the various sources must provide compatibility. The present invention does so. The present invention also enables the procurement agent to compile and run reports that would relate to the various fields on the disparate and distinct databases.

It can be seen that the present invention accomplishes the central management of data through a powerful database management system through a series of complex links. Also, personnel management is improved through the use of the client software distributed to the hospital or referral contact in that decisions about eligibility in many cases can be made before field personnel are deployed. As the questions are answered in connection with each referral the answers automatically reside in the database. Thus without the time, expense and potential for error associated with manual entry the database is expanded with every referral call. In pyramid fashion, ineligible prospects are then deselected, and those not ruled out become the subject of additional questioning. In this way the apex of the pyramid represents the best candidates for donation.

Using the system of the present invention, the OPO can take the process from the very beginning and collect data from that point, through the death of the donor, and delivery to the recipient

The present invention illustrates how a plurality of sources of referral of organs or tissue can be networked to a central manager to expedite and improve the screening, deliberation and selection process necessary to deliver organs or tissue to a recipient. The system uses a specially designed software program that will connect to a relational database management system which in turn addresses a database. Information from the databases is exchanged between the request or referral source and the recipient, and the raw data is continuously updated as the referral source provides information, and which raw data is then used to match organ or tissue with the particular recipient, support the delivery of the organ or tissue to the selected recipient, and catalog and store medical and social histories of the recipient for immediate use by the procurement agent.

In addition the said system will be available to provide information currently and on a full time basis, so that the referral source who desires to contact the procurement agent can do so without being dependent on the presence and availability of employees in the agency's office during office hours.

The system also teaches the inclusion of a trained communicator who can be contacted, and whose telephone number or other telecommunication address can be provided to the referral source, such communicator preferably being at the OPO call center or some other designated call center, or a trained employee of a service such as a security service or an ambulance service that operates on a 24-hour basis and is a trained paramedic and health services specialist.

An example of this type of system is in the case of organ transplantation. A hospital can access the web site from an existing Internet-connected computer located in an emergency room or other triage location through a browser for use on the Internet.

By using the CPU or terminal hospital personnel send a message to a remote CPU maintained by the OPO requesting data for referral of organ or tissue information. The OPO's CPU then sends back the information necessary to display on the hospital computer screen a question and answer form designed to obtain basic information about the eligibility of the prospective donation, such as: (1) Whether the patient is brain dead, (2) whether the patient is on a ventilator, and (3) cause of death. The hospital then terminates its input by clicking on a transmittal link or using a keystroke that sends the information to the OPO's computer. The OPO then evaluates the information received and rules out ineligible donations. If the donor is ruled out, information is sent to the hospital computer displaying on the screen the fact that the donor is ineligible. If the donation is not ruled out, then information is sent to the hospital computer advising whether or not the patient is a registered donor. If the patient is not a registered donor, the hospital screen displays a message to that effect supplied by information transmitted from the OPO computer. If the patient is a registered donor, then automatically a page-out call is made to a field agent for the OPO residing or located in the vicinity of the hospital, who then proceeds to the hospital to obtain other information and otherwise facilitate the process of obtaining the consents and authorizations required for the procurement of the tissue or organ.

The client software also supports the function of updating the OPO database including logging every call from a referral source and including among the raw data maintained on the database all information derived from the answers supplied by the referral source and information supplied to the referral source during the eligibility question and answer process. The system also provides a powerful relational database management system software component capable of accessing numerous fields in the database and associated tables and lists. In this way the referral information can be checked automatically against the information residing in the various registries, the Department of Motor Vehicles database, and any databases maintained at the OPO locale whether on server or CPU.

The advantages of the present invention can be readily appreciated. It provides immediate response as well as immediately current and contemporaneous updating information, and does so with minimal reliance on manual input. It also provides the further advantage of being able to manage information residing in a database so that much can be learned about donors, organs, tissues and recipient through simple navigation with a computer. It also provides the necessary information to allow the OPO field or office employee to identify and contact the person necessary for authorization and consent to collect or harvest organ or tissue such as the next of kin in the event the patient is incapable of being communicated with and/or of rendering consent.

The key software platform, in addition to providing the screening questions that are dynamically updated, would also send the answer information to the back end database maintained at the procurement agent. Indeed, this key software component allows all of the necessary steps for securing the organ or tissue or other time-sensitive material to be managed in or out of one area. For example, the answer software can be brought into triage in hospital emergency units or trauma facilities.

Although exemplary embodiments of the present invention have been shown and described, many changes, modifications, and substitutions may be made by one having ordinary skill in the art without necessarily departing from the spirit and scope of the invention.

1. An organ and tissue procurement system, comprising:
interface server means for storing and delivering user interface information accessible to authorized users over a wide area network;
database server means, in communication with said interface server means, for storing and delivering data related to donors and recipients of human organs and tissue; and
software means, in communication with said interface server means and said database server means, for enabling access to said data and said user interface information by said authorized users, wherein said software means includes:
(a) security means for determining whether one or more of said authorized users may modify said data; and
(b) import means for receiving donor information from at least one external database and adding said donor information to said data.

2. The system of claim 1, wherein said external database is managed by an office of motor vehicles.

3. The system of claim 1, wherein said external database is managed by an organ donation organization.

4. The system of claim 1, wherein said data further includes information relating to transplant hospitals.

5. The system of claim 1, wherein said data further includes information relating to eyebanks.

6. The system of claim 1, wherein said data further includes information relating to tissue banks.

7. An organ and tissue procurement system comprising:
software means for communicating with a database management system corresponding to and operating upon a database and configured to create links between select fields of said database;
wherein said database is configured to store medical and social history information about a plurality of prospective donors under conditions that would allow salvage of tissue or organs from said prospective donors (“donor data”), and medical and social history information about a plurality of prospective recipients (“recipient data”);
wherein said RDBMS is configured to access one or more of said database and to determine whether said donor data is stored in one of said database; and
wherein said RDBMS is further configured to access one or more of said database to determine whether any of said donor data corresponds to any of said recipent data sufficient to establish a preliminary match between said donor data and said recipient data.

8. The procurement system according to claim 7, wherein said software means includes means for prompting a user of said system to ask predetermined threshold questions about said prospective donor to establish whether said prospective donor may donate said tissue or organ.

9. The procurement system according to claim 7, wherein said software means includes means for allowing a user of said system to determine whether said prospective donor has indicated an express intent to donate said tissue or organ.

10. The procurement system according to claim 7, wherein each said database is maintained by an organization with which said prospective donor or said prospective recipient have a prior relationship; and wherein said RDBMS communicates with said database over an electronic communication network.

11. The procurement system of claim 10, wherein said electronic communication network is the Internet; and wherein said software means is enabled for use entirely over the World Wide Web.

12. The procurement system of claim 7, wherein said databases include data sets which are precategorized into a plurality of predetermined organ histories.

13. A method for managing a procurement system for tissue or organs, comprising the steps of:
providing software means for communicating with a relational database management system (RDBMS) corresponding to and operating upon a database and configured to create links between select fields of said database;
storing medical and social history information about a plurality of prospective donors under conditions that would allow salvage of tissue or organs from said prospective donors (“donor data”);
storing medical and social history information about a plurality of prospective recipients (“recipient data”);
accessing said RDBMS to determine whether said donor data is stored said database, and if so, determining whether any of said donor data corresponds to any of said recipent data sufficient to establish a preliminary match between said donor data and said recipient data.
